(19) United States
(12) Patent Application Publication
(10) Pub. No.: US 2016/0179814 A1
(43) Pub. Date: Jun. 23, 2016

(54) A SYSTEM AND A METHOD FOR CALCULATING PARAMETERS FOR THE DETERMINATION OF THE REPUTATIONAL RATING OF NATURAL AND LEGAL PERSONS

(71) Applicant: MEVALUATE HOLDING LTD., Dublin 2 (IE)

(72) Inventors: Jacopo Marotti, Rome (IT); Maria Vittoria Marotti, Rome (IT); Eduardo Marotti, Rome (IT)

(21) Appl. No.: 14/910,522

(22) PCT Filed: Aug. 6, 2014
(86) PCT No.: PCT/IB2014/063730

§ 371 Date: Feb. 5, 2016

Related U.S. Application Data
(63) Continuation-in-part of application No. 13/960,638, filed on Aug. 6, 2013.

(51) Int. Cl. G06F 17/30

(52) U.S. Cl. CPC G06F 17/3053; G06F 17/30528; G06F 17/30867; G06Q 50/265

(57) ABSTRACT

A system configured for calculating at least a parameter relating to the determination of the reputational rating of a natural or legal person includes a number of electronic modules capable of populating a database with data derived from pieces of information relating to the natural or legal person, the data being adapted to prove evidence or facts object of the evaluation of the parameter of reputational rating, assigning a positive or negative weighted value to each of the data, proportional to a suitability factor of the evidence or facts to contribute to the determination; determining the parameter of reputational rating of the natural or legal person on the basis of a sum of all the contributions derived from the weighted values relating to the natural or legal person.

### BACKGROUND OF THE INVENTION

1. Field of the Invention

The present invention relates to a system and method for calculating parameters for the determination of the reputational rating of natural and legal persons.

2. Description of the Prior Art

The Reputation is an essential asset for the purpose of human activities in terms of ensuring the security of social and economic transactions that take place between individuals and legal entities, on the basis of which feelings as well as opinions of reciprocal trust are created and fuelled.

In the light of ever faster and more uncontrollable ways in which true as well as false information is distributed about anyone or anything all over the world, there is a clear need to develop systems adapted to assess, measure and classify the value to the of reputation, transforming it from a “key capital social asset” to a “key economic asset”, and from “subjective perception” to “objective element”, with the result of generating an asset that is new, exclusive, totally widespread, measurable in its value.

The core of the technical problem preventing the reputation of persons from being objective, gradual, measurable and comparable, is that—to date—the reputation has just been a matter of quality and not quantity, left to manual activities under human discretion and not objectively determined.

There is no evidence in the prior art of tentative solutions to that problem.

For example WO-2013/003603-A discloses a method for deriving a hit visibility score for one or more hits from an information source, wherein the one or more hits are directed to a target entity, and wherein the hit visibility score indicates a likelihood that a corresponding hit is found by a searcher after searching for the target entity in the information source. A sentiment module derives a hit sentiment score for the hits; the hit sentiment score indicates a sentiment about the target entity conveyed by the hits; a reputation module derives a reputation for the target entity based on the hit visibility score and the hit sentiment score.

US-2011/153551-A1 discloses a method for analyzing information about a user obtaining search results based on search terms describing the user; it presents the search results to the user and receives an indication from the user of the desirability of a search result. The method also determines a reputation score representing the reputation of the user, including collecting search results from data source, determining an effect on the reputation of the user of the search results from the data source, and calculating a reputation score for the user based on the determined effect on the reputation of the user from the search results from the data source.

The known methods are not suitable for overcoming the above wider problems addressed by this invention, as they cannot give a certain value to all the elements that constitute the reputation. They are not able to define logical processes that bring together all the evaluation elements and extrapolate from them objective data adapted to measure a reputational rating that is understood as creating value from them, and as such being technically comparable and reliable.

Therefore these known methods still need a number of manual activities left to human discretion and not objectively determined.

### SUMMARY OF THE INVENTION

The aim of the present invention is to provide a system and method for calculating parameters for the determination of the reputational rating of natural and legal persons, able to address and solve the above described problems.

In the framework of the present invention, the term natural person means human individuals of any type and age; the term “ private legal person” comprises, but is not limited to, any private legal entity such as any profit or non-profit private entity, company, corporation, foundation, association; the term “public legal person” comprises, but is not limited to, any public entity or authority or government, such as a State, territorial or regional or local authority and/or municipality and administration, as well as publicly appointed and/or recognized organizations, foundations and associations.

The basic idea of the invention is to determine a technically measured parameter, identified in the following as “reputational rating”, of a subject in reference to data extracted from defined documents that prove the facts being object of the reputational analysis, made on the basis of metadata (obtained from Evidence, as defined below). Numeric values are assigned to a set of metadata by using a software algorithm and procedure processes up to determine the reputational rating value attributed to each person being analyzed.

Preferably metadata are composed by the specific types of the instances and the values of the enumerated attributes of each evidence, as defined below.

The solution proposed by the invention, through processing of the metadata derived from suitable documents (evidences), produces objective reputational rating parameters.

The system object of the invention provides for the creation of a center for evaluation of data of reputational risk through the development of metadata (analysis of evidence) derived from documents which, thanks to the technical solution and the originality of the adopted parameters, render the reputation objective and measurable, producing a reputational rating value which is universally recognized, capable of being the technical comparison element among all possible subjects under evaluation, under objectivity, transparency and widespread public control.

The system object of the invention provides values for an immediate certification and quantification of the reputations of the involved entities. In addition it allows to immediately estimate the risk of the interrelation, which is even more important in the web context where the customs and traditions have accelerated the confidential interrelations without any effective protection network.

According to an aspect of the present invention it is provided a system configured for calculating at least a parameters relating to the determination of the reputational rating of a natural or legal person, the system comprising a number of electronic modules comprising means for::
populating a database with data derived from pieces of information relating to said natural or legal person, said data being adapted to prove evidence or facts object of the evaluation of said parameter of reputational rating,
assigning a positive or negative weighted value to each of said data, proportional to a suitability factor of said evidence or facts to contribute to said determination;
determining said parameter of reputational rating of said natural or legal person by summing up all the contributions derived from the weighted values relating to said natural or legal persons.

Preferably said means for assigning a positive or negative weighted value to each of said data comprises means for:
building up a tree structure in said database comprising data relating to one or more of: type of person, namely natural, or private legal person or public legal person; categories of evidence or facts for each type of person, subcategory of evidence or facts for each category, classes of evidence or facts for each subcategory;
assigning each type of said data to a given position in the tree structure;
assigning said positive or negative weighted value to each of said data on the basis of said position in the tree structure.

Preferably said means for determining said parameter of reputational rating of said natural or legal person comprises means for calculating polynomial formulae with coefficients taken from configuration tables, said coefficients being said weighting values of the evidence or facts, and variables given by number of occurrences of the evidence or facts and time factor.

According to another aspect of the present invention it is provided a system configured for calculating at least a parameter relating to the determination of the reputational rating of a natural or legal person, the system comprising a number of electronic modules comprising means for::
populating a database with data derived from pieces of information relating to said natural or legal person, said data being adapted to prove evidence or facts object of the evaluation of said parameter of reputational rating,
assigning a positive or negative weighted value to each of said data, proportional to a suitability factor of said evidence or facts to contribute to said determination, on the basis of respective positions of said data in a tree structure in said database;
determining said parameter of reputational rating of said natural or legal person by summing up all the contributions derived from the weighted values relating to said natural or legal persons.

According to a further aspect of the present invention it is provided a system configured for calculating at least a parameter relating to the determination of the reputational rating of a natural or legal person, the system comprising a number of electronic modules comprising means for:
populating a database with data derived from pieces of information relating to said natural or legal person, said data being adapted to prove evidence or facts object of the evaluation of said parameter of reputational rating,
assigning a positive or negative weighted value to each of said data, proportional to a suitability factor of said evidence or facts to contribute to said determination, on the basis of respective positions of said data in a tree structure in said database;
determining said parameter of reputational rating of said natural or legal person by summing up all the contributions derived from the weighted values relating to said natural or legal persons, and depending on a number of occurrences of the evidence or facts in said database and on a time factor.

Preferably said means for assigning a positive or negative weighted value to each of said data comprises:
deriving metadata from said data, said metadata comprising data relating to the specific type of the instances and the values of enumerated attributes of each certain piece of information,
assigning numerical values to said metadata;
obtaining said positive or negative weighted value on the basis of said metadata.

It is a particular objects of the present invention a system and a method for calculating parameters for the determination of the reputational rating of natural and legal persons, as described in the attached claims, which are considered an integral part of the present description.

### BRIEF DESCRIPTION OF THE DRAWINGS

For a better understanding of the invention, examples of embodiments of the invention are described in the following, which shall be considered only as non-limiting examples, in connection with the attached drawings wherein:

FIGS. 1 to 49 show activity flow charts defined through action diagrams of the steps of the method for the determination of the parameters of reputational rating of natural and legal persons subject of the invention;

FIGS. 50 to 71 show the logic structures of the data model about the reputational profile defined through composition of class diagrams relating to the method for the determination of the parameters of reputational rating of natural and legal persons subject of the invention;

FIG. 72 shows an exemplary embodiment of the system of the present invention;

FIG. 73 shows a graphical trend of a function of the algorithm according to the invention, determining both negative ratings and positive ratings.

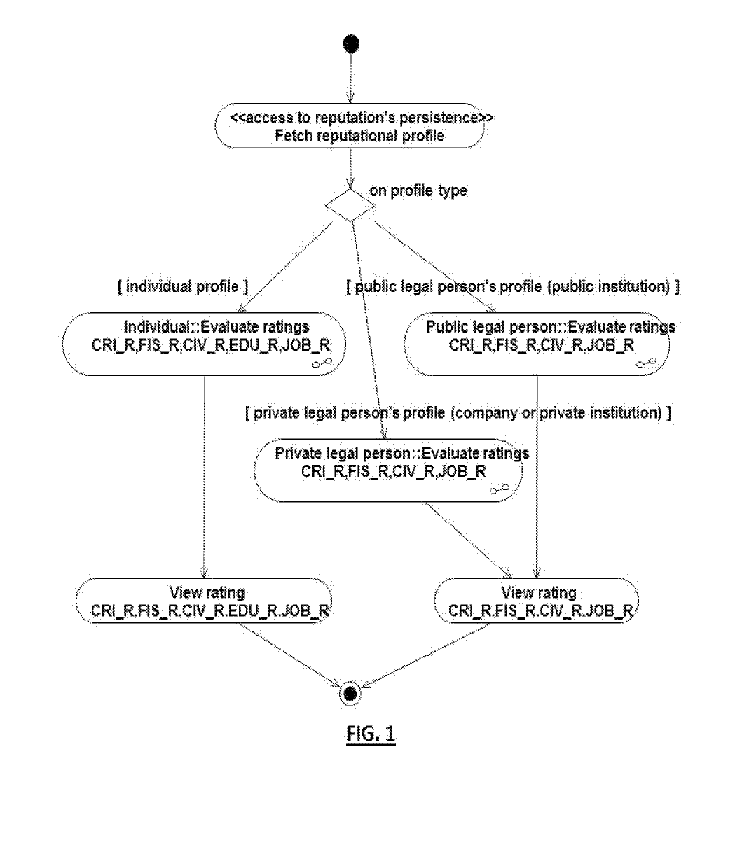

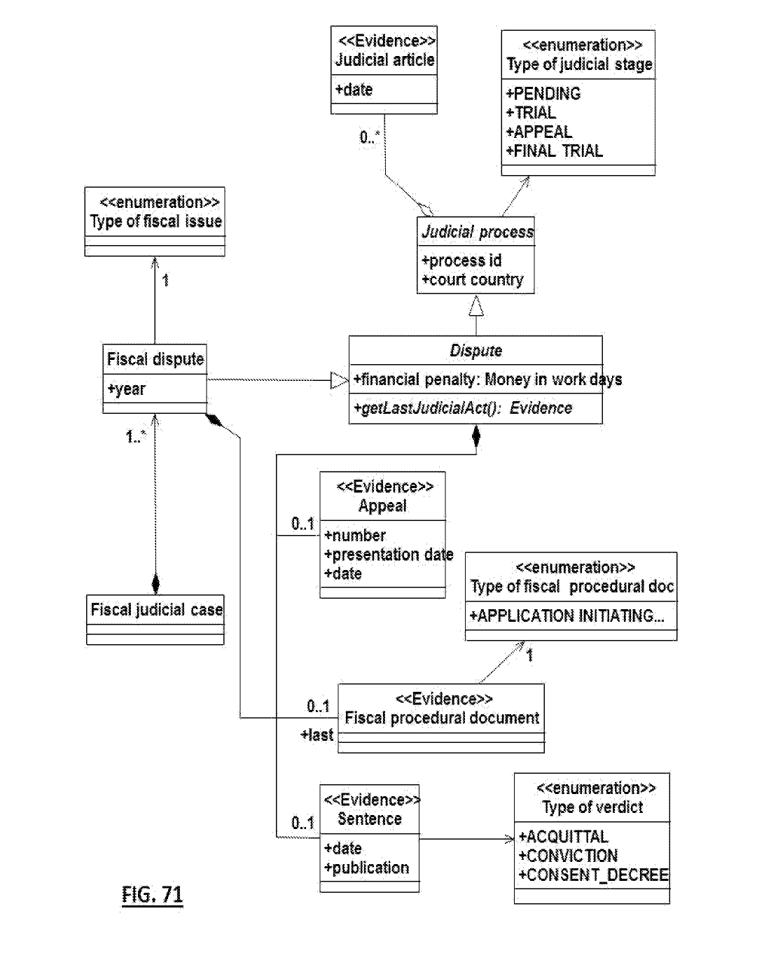

The terms included in the blocks of the activity flow charts and of the logic structures of the data model of FIGS. 1 to 71 correspond to software definitions in English language of instructions and classes that cannot be translated into other languages, as the skilled in the art of any country and mother tongue understands them unambiguously.

### DETAILED DESCRIPTION OF THE PREFERRED EMBODIMENTS

In the following exemplary non-limiting examples of embodiments of the system and method of the invention are described, with reference to different kinds of features of the same.

### Basic Principles.

In the following a general description is given of the basic principles underlying the method for the determination of the reputational rating of natural and legal persons, subject of the invention.

The basic principles start from the determination of a “Universal Code for Reputation” (UCR), hereinafter summarized with the following considerations.

All natural and legal persons come into existence with a neutral reputation. All the actions they perform or do not perform and behavior they demonstrate or do not demonstrate, take or do not take, in the course of their lives contribute to their reputation, which is defining from time to time, in a measurable way, as a positive or negative reputation.

All natural and legal persons have the right to protect their own reputation, and have the right to know the reputation of third parties in order to protect themselves from moral or material damages that may result from the relationship with such third parties.

All natural and legal persons therefore have the right to social security of transactions that they are engaged in and the effectiveness of that right is much more protected by a system of accreditation of the reputation which complies with principles of objectivity, transparency, widespread public scrutiny.

Each piece of information, provided it is suitably documented, can be used for deriving corresponding data for determining the reputational rating. The information must be documented in a written or image form, objectively proving that an action has been actually accomplished or not. In this exercise each one has the right and duty to participate, when a benefit derives to the community, through the use of documented information, relating to himself or even other persons.

The actions, omissions and significant conducts accomplished by natural and legal persons have a positive impact on the respective reputation if they lead to physical, social, cultural or economic benefits to one or more subjects.

On the contrary, the actions, omissions and significant behaviors performed by natural and legal persons have a negative effect on the respective reputation if they result in physical, social, cultural or economic harm to one or more subjects.

The reiteration of a given act, omission, conduct by a natural or legal person has an effect proportional to the weight it will have for the purpose of reputation building.

The amount of time elapsed since the completion of an act, omission, conduct by a natural or legal person has an effect which is inversely proportional to the weight they will have for the purpose of reputation building.

Each person has therefore the right to input data in the system relating to said documented information for contributing to build up the reputational rating of himself or other legal or natural persons.

The technical implementation of these basic principles is the subject of the present invention.

### General Rules for the Determination of the Reputational Rating.

In the following the general rules for the determination of the parameters of reputational rating according to the method of the invention are described.

### 1. The UCR (Universal Code for Reputation) Provides a Structured Reputational Rating.

The structured reputation rating provides for subdivisions into: types of persons, for each type of person a number of categories of facts, for each category a number of subcategories, for each subcategory a number of classes.

The structure provides for the following kinds of subjects:

INDIVIDUALS

PRIVATE LEGAL PERSONS

PUBLIC LEGAL PERSON

### 2. Individuals

The parameters of reputational rating relate to five Categories, all consisting of data on “facts” of life:

The First is indicative of criminal reputation (relating to possible crimes committed).

The Second is indicative of the fiscal reputation (relative to any outstanding tax and/or social security funds and assistance dispute)

The Third is indicative of the civil reputation (relating to possible civil disputes).

The Fourth is indicative of the reputation for studies and training.

The Fifth is indicative of job reputation, including any civic engagement activities (e.g. volunteering, no profit).

The first, second and third Categories are each represented by a letter from A to Z, where A is the best and Z the worst reputation.

The fourth and fifth Category are represented by two numbers from 0 to 100 where 0 is the worst reputation and 100 is the best.

Then, the reputational rating of the entire humanity (individuals) goes from Z.Z.Z.0.0. (Worst reputation) to A.A.A.100.100. (Best reputation).

To determine these ratings, all the facts of each Category is assigned a value. This value is identified by giving a value to each elementary fact which is then weighted according to:

type of act that proves the fact

pertaining SUBCATEGORY

any other characterizations of fact.

This way a proportionality is determined between the events/actions that constitute the essence of the reputational rating.

Among the various possible characterizations also the elapsed time contributes, so that a fact is given a higher value if more recent and a lower value if it is older in the time.

For the purpose of making homogeneous over time the values calculated for the facts giving rise to fines or other sentences in civil disputes, the same penalties/sums are indexed using as a weight the GDP (Gross Domestic product) of the year when the very fact has materialized.

Similarly, in order to making homogeneous among the various countries the values for the facts giving rise to fines or other sentences in the same penalties/sums are indexed using as a weight the country's relative GDP.

### 2.1. Criminal Reputation Category—Individuals

Subcategories of FACTS-CRIMES:
Crimes against the person
Crimes against the State
Crimes against the Public Administration
Crimes against property
Crimes against public faith

Each of the above five Subcategories (representative of facts prohibited by the rules of a criminal nature) is assigned a weight proportional to the negative value defined by the UCR.

Each of these five Subcategories is divided into five Classes of imprisonment and fines, each of which is assigned a value.

All of the five Subcategories are related to types of acts, each of which is assigned a weight proportional to the suitability of the Act itself to establish the facts of a particular Subcategory.

The accessory Acts (print and video) (Attachments) are divided into two types of Acts (Attachments), according to their diffusion (national or local) and refer to five Classes of the penalty, in which case the value attributed to these accessory Acts (Attachments) is inversely proportional to the value of the sentence.

The discharging accessory Acts (Attachments) (print and video) are valued with opposite sign to reduce the value achieved.

In the event of recurrence or security measures adopted by order of the court (which require an offense and the permanence of the social dangerousness) will cancel the mitigating effect of the passage of time compared to the offense committed.

All Category CRIMINAL REPUTATION apply the reduction related to the passage of time, which, however, vanishes in case of reiteration (recidivism) or security measures or prevention.

### 2.2. Fiscal Reputation Category—Individuals

Each tax and contribution pendency is divided into five subcategories of value to each of which a value is assigned.

All five value subcategories are related to types of acts, each of which is assigned a weight proportional to the suitability of the Act itself to establish the facts.

The accessory Acts (Attachments) (print and video) are divided into two types of Acts (Attachment), according to their diffusion (national or local), in which case the value attributed to these accessory Acts (Attachments) is inversely proportional to the value of the tax pendency.

The discharging accessory Acts (print and video) (Attachments) are valued because they go with the opposite sign to reduce the value achieved.

All Category FISCAL REPUTATION apply the reduction related to the passage of time, which, however, vanishes in case of reiteration (recidivism).

### 2.3. Civil Reputation Category—Individuals

Subcategories of FACTS-DISPUTES:
Family
Working
Other breaches of contract
Extra-contractual damages
Succession

For each of the above five Subcategories (representative of facts-disputes) is assigned a weight proportional to the negative value defined by the UCR.

Each of these five Subcategories is divided into five classes of disputes value to each of which is assigned a value.

All of the five Subcategories are related to types of acts, each of which is assigned a weight proportional to the suitability of the Act to establish the facts of a particular SUBCATEGORY.

The accessory Acts (print and video) (Attachments) are divided into two types of Acts (Attachments), according to their diffusion (national or local) and refer to five Classes of disputes, in which case the value attributed to these accessory Acts (Attachments) is inversely proportional to the value of the dispute.

The discharging accessory Acts (Attachments) (print and video) are valued because they go with the opposite sign to reduce the value achieved.

All Category CIVIL REPUTATION apply the reduction related to the passage of time, which, however, vanishes in case of reiteration (recidivism).

### 2.4. Education Reputation Category—Individuals

The Category is segmented into various qualifications: graduation from primary school to PhD, to the post-university qualifications.

Only the earned title is significant and not the possible attendance to the course to which the qualification refers.

Any qualification is assigned a weight that takes into account the importance of the title.

In addition, the weights are attributed in particular taking into account the time required for the attainment of the qualifications.

The result, however, is weighed in a different way depending on the various types of qualification, in four classes:
No difference in terms of result (included in this class diplomas in primary school, lower secondary school and professional qualification)
Maximum ratio between the maximum and minimum marks obtained (included in this class the bachelor's level, degree or unified)
Intermediate ratio between maximum and minimum marks obtained (belong to this class upper secondary school and PhD)
Minimum ratio between maximum and minimum marks obtained (in this class graduate schools) Honor gives additional points.

A certification of the knowledge of each additional language to the mother tongue increases by a percentage of the total value of Education and Training Category.

A certification of the completion of an extra-curricular or extra-university diploma gives a score for each year of the course of study.

The certificate testifying the attainment of a license in accordance with the law gives a score.

The references of teachers are assigned a score that varies according to their number.

The value of RATING so identified is increased by a percentage proportionate to the age of the person (according to the principle “the more he lived the more improved”).

The predicted percentage increase is related to CRIMINAL RATING in the sense that the more it gets worse the more decreased the incidence of this percentage decreases.

### 2.5. Job Reputation Category—Individuals

Subcategories FACTS AND WORK:
Employment
Professional work
Entrepreneurial work
Family Management (home)
Civil commitment.

Classes of facts evaluated for the establishment of the RATING:
age of work beginning: the age at which The first work began generates a value inversely proportional to age of the person;
duration of the working career: each year of employment gives a score that is weighted differently depending on the type of work done;
Particular enablements closely related to the exercise of the work and which do not require a compulsory training and/or the achievement of a particular educational qualification;
Ownership of patents and/or other intellectual property rights: a score is given based for each patent/right; a reduction applies related to the passage of time.
scientific publications: a score is given based on the number of publications: a reduction applies related to the passage of time.
printed articles and/or TV/Radio/Web services; a score is given based on the number of articles, distinguished on the basis of national or local character: a reduction applies related to the passage of time.
Praise: a score is given based on the kind of the Administration assigning it and the number of praises received; a reduction applies related to the passage of time
Awards/Bonuses: a score is given based on the nature of the entity giving it and the number of awards/bonuses received; a reduction applies related to the passage of time

For the SUBCATEGORY EMPLOYMENT:
Mobility (average duration in months of employment in relation to the duration of his career); a score is given based on length of experience
References of colleagues: a score is given based on the number of references; a reduction applies related to the passage of time.
References of functional and/or hierarchical superior; a score is assigned based on the number of references; a reduction applies related to the passage of time.
References of users (e.g. students with respect to a professor); a score is assigned based on the number of references; a reduction applies related to the passage of time.

For the SUBCATEGORY OF PROFESSIONAL ACTIVITY AND BUSINESSMAN
Average turnover of last three years; a score is assigned proportional to the turnover;
Client References; a score is given based on the number of references; a reduction applies related to the passage of time.
References of suppliers: a score is given based on the number of references; a reduction applies related to the passage of time.

For the SUBCATEGORY PROFESSIONAL WORK
Annual certification of Professional Credits; a score is given for the annual certification.

For the SUBCATEGORY FAMILY MANAGEMENT
Number of household members; a score is given based on the number of components;
Elapsed time (working career in the position of Family Manager); a score is assigned based on the time spent.

For the SUBCATEGORY CIVIL COMMITMENT
Awards for Civil Valor; a score is given based on the kind of the Administration giving it and the number of awards received; a reduction applies related to the passage of time;
Volunteer activities; a fixed score is given; a reduction applies related to the passage of time

### 3. Private Legal Persons

REPUTATIONAL RATING consists of four CATEGORIES, all consisting of “facts”:

The First indicative of criminal reputation (relating to possible offenses committed);

The Second, indicative of the tax and contributions reputation (relative to any outstanding tax and/or social security funds and assistance);

The Third, indicative of the civil reputation (relating to possible civil disputes)

The Fourth, indicative of the job reputation.

The First three Categories are each represented by a letter from A to Z, where A is the best and Z the worst reputation.

The fourth Category is represented by a number from 0 to 1000 where 0 is the worst reputation and 1000 is the best.

Then, the reputational RATING of the entire Category of private legal entities ranges from Z.Z.Z.0. (Worst reputation) to A.A.A.1000. (Best reputation).

To determine these RATINGS, all the facts of each Category is assigned a value. This value is identified by giving a value to each elementary fact which is then weighted according to:

type of act that documents the fact

pertaining SUBCATEGORY

any other characterizations of the fact.

A proportionality is determined among the events/actions that constitute the essence of the RATING.

Among the various possible characterizations also the passage of time is important, in that given a fact, a higher value is assigned if it is more recent and less if it is older.

For the purpose of homogenizing in the time the values for the facts that provide for fines or sums of civil disputes, the same penalties/sums are indexed using weight as the GDP of the year when the very fact has materialized.

Similarly, in order to homogenize among the various countries the values for the facts that provide for fines or sums of civil disputes, the same penalties/sums are indexed using as a weight the relating country's GDP.

### 3.1. Criminal Reputation Category—Private Legal Persons

SUBCATEGORIES OF FACTS-CRIMES:
Offences against the Public Administration
Offences against property

For each of the above two Subcategories (representative of facts prohibited by the criminal law) a weight is assigned proportional to the negative value defined by the UCR

Each of these two Subcategories is divided into five classes of financial penalties and two classes of disqualifications each of which is assigned a value.

The two Subcategories are related to types of acts, each of which is assigned a weight proportional to the suitability of the Act to establish the facts of a particular SUBCATEGORY.

The accessory Acts (Attachments)(print and video) are divided into two types of Acts, according to their diffusion (national or local) and refer to the five Classes of penalties and the two Classes of disqualification, in which case the value attributed to these accessory Acts (Attachments) is inversely proportional to the value of the penalty.

The accessory Acts (Attachments)(print and video) to discharge are valued with contrary sign because they reduce the value achieved.

In the event of recurrence and/or prohibitive measures (which require the commission of an offense and the permanence of the social dangerousness) the mitigating effect of the passage of time is canceled compared to the offense committed.

All Category CRIMINAL REPUTATION is subject to the reduction related to the passage of time, which, however, vanishes in case of recurrence or security measures.

### 3.2. Fiscal Reputation Category—Private Legal Persons

Each tax and contribution pendency is divided into five classes of value to each of which a value is assigned.

All five value classes are related to types of acts, each of which is assigned a weight proportional to the suitability of the Act to establish the facts.

The accessory Acts (Attachments)(print and video) are divided into two types of Acts (Attachments), according to their diffusion (national or local), in which case the value attributed to these accessory Acts (Attachments) is inversely proportional to the value of the tax pendency.

The accessory Acts (Attachments) (print and video) to discharge are valued with the opposite sign to reduce the value achieved.

All Category FISCAL REPUTATION is subject to the reduction related to the passage of time, which, however, vanishes in case of recurrence.

### 3.3. Civil Reputation Category—Private Legal Persons

SUBCATEGORIES OF FACTS-DISPUTES:
Working
Other breaches of contract
Extra-contractual damages

For each of the above three Subcategories (representative of facts-disputes) a weight is assigned proportional to the negative value defined by the UCR.

Each of these three Subcategories is divided into five classes of values of disputes to each of which is assigned a value.

The three Subcategories are related to types of acts, each of which is assigned a weight proportional to the suitability of the Act to establish the facts of a particular SUBCATEGORY.

The accessory Acts (Attachments)(print and video) are divided into two types of Acts (Attachments), according to their diffusion (national or local) and refer to five Classes of disputes, in which case the value attributed to these Acts is inversely proportional to the value of the dispute.

The accessory Acts (Attachments)(print and video) to discharge are valued with the opposite sign to reduce the value achieved.

All Category CIVIL REPUTATION is subject to the reduction related to the passage of time, which, however, vanishes in case of recurrence.

### 3.4. Job Reputation Category—Private Legal Persons

SUBCATEGORIES OF WORK-FACTS:
Work activity
Civil commitment

Classes of facts evaluated for the establishment of the RATING:
duration of the activity: a score is given for each year of activity
mandatory qualifications closely related to the exercise of the activity (e.g. security clearance): a score is given for each qualification.
Ownership of patents and/or other intellectual property rights: a score is given for each patent/right.
Optional certification (e.g. ISO 9000, SA 8000, etc.): a score is given for each certification
Printing articles and/or TV/Radio/Web contributions: a score is given based on the number of articles relating to the person concerned, distinguishing if they are at national or local level.
Average turnover last three year: a score is given proportional to the turnover.
Praises: a score is given based on the nature of the Body giving them and the number of citations received
Awards: a score is given based on the nature of the Body giving them and the number of awards received

For the SUBCATEGORY CIVIL COMMITMENT
Awards for Civil Valor: a score is given based on the nature of the Body giving them and the number of awards received
Volunteer activities ongoing: a fixed score is given

### 4. Public Legal Persons

REPUTATION RATING consists of four CATEGORIES, all consisting of “facts”:

The First indicative of criminal reputation (relating to possible offenses committed)

The Second, indicative of the fiscal reputation (relative to any outstanding tax and/or social security funds and assistance)

The Third, indicative of the civil reputation (relating to possible civil disputes),

The Fourth, indicative of the job reputation.

The First three Categories are each represented by a letter from A to Z, where A is the best and Z the worst reputation.

The fourth Category is represented by a number from 0 to 1000 where 0 is the worst reputation and 1000 is the best.

Then, the reputational RATING of the entire Category of private legal entities ranging from Z.Z.Z.0. (Worst reputation) to A.A.A.1000. (Best reputation).

To determine these RATING, all the facts of each Category is assigned a value. This value is identified by giving a value to each elementary fact which is then weighted according to:

type of act that documents the fact

pertaining SUBCATEGORY

any other characterizations of fact.

A proportionality is determined between the events/actions that constitute the essence of the RATING.

Among the various possible characterizations also the passage of time has its importance, then the same kind of fact is given a higher value if more recent and less if it is older.

For the purpose of homogenizing time values for the facts that provide for fines or sums of civil disputes, the same penalties/sums are indexed using as a weight the GDP of the year when the very fact has materialized.

Similarly, in order to homogenize the various countries the values for the facts that provide for fines or sums of civil disputes, the same penalties/sums are indexed using as a weight the country's GDP.

### 4.1. Criminal Reputation Category—Public Legal Persons

SUBCATEGORIES OF FACTS-CRIMES:
Offences against the Public Administration
Offences against property

For each of the above two Subcategories (representative of facts prohibited by the criminal law) a weight is assigned proportional to the negative value defined by the UCR

Each of these two Subcategories is divided into five classes of financial penalties and two classes of disqualifications, each of which is assigned a value.

Each of the two Subcategories is related to types of acts, each of which is assigned a weight proportional to the suitability of the Act to establish the facts of a particular SUBCATEGORY.

The accessory Acts (Attachments)(print and video) are divided into two types of Acts (Attachments), according to their diffusion (national or local) and refer to the five Classes of penalties and the two Classes of disqualification, in which case the value attributed to these accessory Acts (Attachments) is inversely proportional to the value of the penalty.

The accessory Acts (Attachments)(print and video) to discharge are valued with the opposite sign because they reduce the value achieved.

In the event of recurrence and/or prohibitive measures (which require the commission of an offense and the permanence of the social dangerousness) the mitigating effect of the passage of time is canceled for the offense committed.

All Category CRIMINAL REPUTATION is subject to the reduction related to the passage of time, which, however, vanishes in case of recurrence or security measures.

### 4.2. Fiscal Reputation Category—Public Legal Persons

Each tax and contribution pendency is divided into five classes of value to each of which a value is assigned.

All five classes of value are related to types of acts, each of which is assigned a weight proportional to the suitability of the Act to establish the facts.

The accessory Acts (Attachments)(print and video) are divided into two types of Acts (Attachments), according to their diffusion (national or local), in which case the value attributed to these accessory Acts (Attachments)is inversely proportional to the value of the tax pendency.

The accessory Acts (Attachments) (print and video) to discharge are valued with the opposite sign because they reduce the value achieved.

All FISCAL REPUTATION Category is subject to the reduction related to the passage of time, which, however, vanishes in case of recurrence.

### 4.3. Civil Reputation Category—Public Legal Persons

Subcategories of FACTS-DISPUTES:
Working
Other breaches of contract
Extra-contractual damages

For each of the above three Subcategories (representative of facts-disputes) a weight is assigned proportional to the negative value defined by the UCR.

Each of these three Subcategories is divided into five value classes of disputes to each of which a value is assigned.

Each of the three Subcategories are related to types of acts, each of which is assigned a weight proportional to the suitability of the Act to establish the facts of a particular SUBCATEGORY.

The accessory Acts (Attachments)(print and video) are divided into two types of Acts

(Attachments), according to their diffusion (national or local) and refer to five Classes of disputes, in which case the value attributed to these accessory Acts (Attachments)is inversely proportional to the value of the tax pendency.

The accessory Acts (Attachments)(print and video) to discharge are valued with the opposite sign because they reduce the value achieved.

All CIVIL REPUTATION Category is subject to the reduction related to the passage of time, which, however, vanishes in case of recurrence.

### 4.4. Job Reputation Category—Public Legal Persons

Subcategories of FACTS-WORK:
Working activity
Civil commitment

Some classes of facts have been identified to build the RATING:
Seniority of activity: a score is given for each year of activity;
Ownership of patents and/or other intellectual property rights: a score is given for each patent/right.
Optional certification (eg ISO 9000, SA 8000, etc.): a score is given for each certification.
Printed articles and/or TV/Radio/Web services: score is given based on the number of articles relating to the party concerned, distinguishing if they have a national or local character;
Personnel expenses, average of last three years: a score is given depending on the personnel expenses incurred;
Percentage of administrative costs (for the existence and functioning of the institution) on the total benefits paid calculated as the average of the last three financial years: a score is given for each percentage point;
Praises: a score is given based on the kind of Administration giving them, and the number of citations received;
Awards: a score is given based on the kind of Body giving them, and the number of awards received.

For the SUBCATEGORY of CIVIL COMMITMENT
Awards for Civil Valor: a score is given based on the kind of Administration giving them, and the number of citations received;
Volunteer activities ongoing: a fixed score is given
Occasional volunteer activities: a fixed score is given

### Algorithms of the Method

In the following non-limiting examples of the algorithms used in the method of the invention to calculate the reputational rating of a subject are described, by means of flow charts of sequences of steps. The detailed description does not include specific reference to numerals in the drawing figures, as from the following description the skilled in the art, having a look to the interconnection of the blocks in the diagrams, is able to implement software routines carrying out the algorithms, keeping in mind that a possible programming language is the well-known Java.

The algorithms examine all the data concerning the reputational profile stored in the data-base of the system.

The data-base containing the data of the subjects covered by the invention is fed with metadata (evidence) derived from and supported by certain pieces of information filed by the parties interested to promote surveys of reputation, documented in favor of themselves or in favor or against third parties. Everything is in accordance with the above defined UCR. The metadata (evidence) and supporting certain pieces of information (documents) are inserted in the data-base by the interested parties by means of web applications connecting to the server of the hardware system described below.

In particular the metadata comprise data relating to the specific type of the instance and the values of enumerated attributes of each of the certain piece of information,

Basically the algorithm calculates polynomial formulae with coefficients taken from configuration tables, the coefficients being the specific weighting values of the evidence or facts, and variables given by number of occurrences of the evidence or facts and time factor. The configuration tables are indexed by keeping into account the position of the facts and evidence in the tree structure above described of categories, subcategories, classes.

The following explanation of the algorithms comprises:
activity flows defined through activity diagrams;
data model about the reputational profile, defined through class diagrams.

The definitions included in the diagrams are in English, that the man skilled in the art is able to use in the same way in every country.

### 5. Activity Diagrams.

### 5.1. Algorithm Diagram.

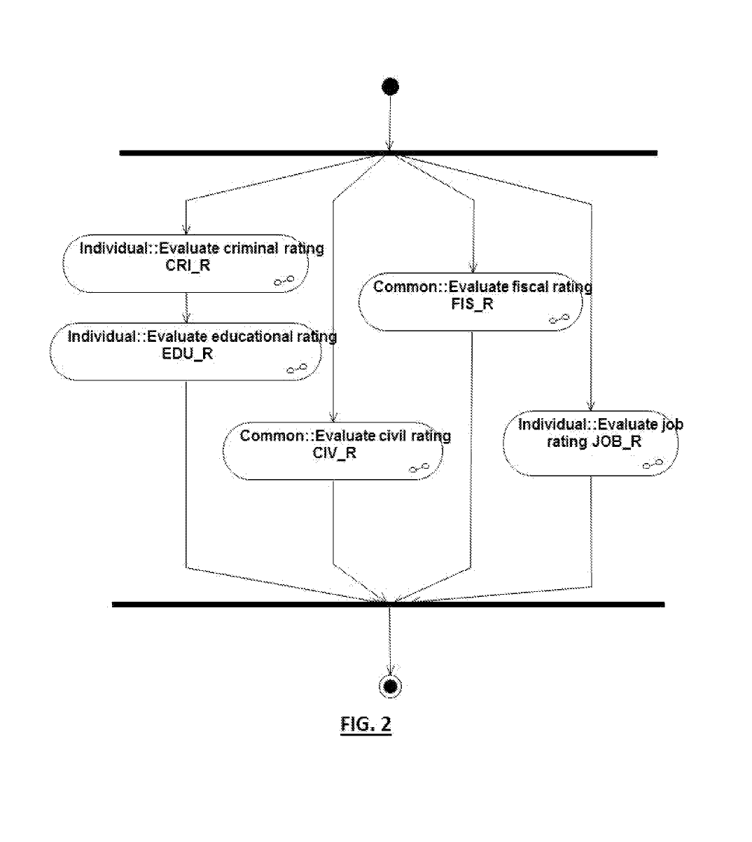

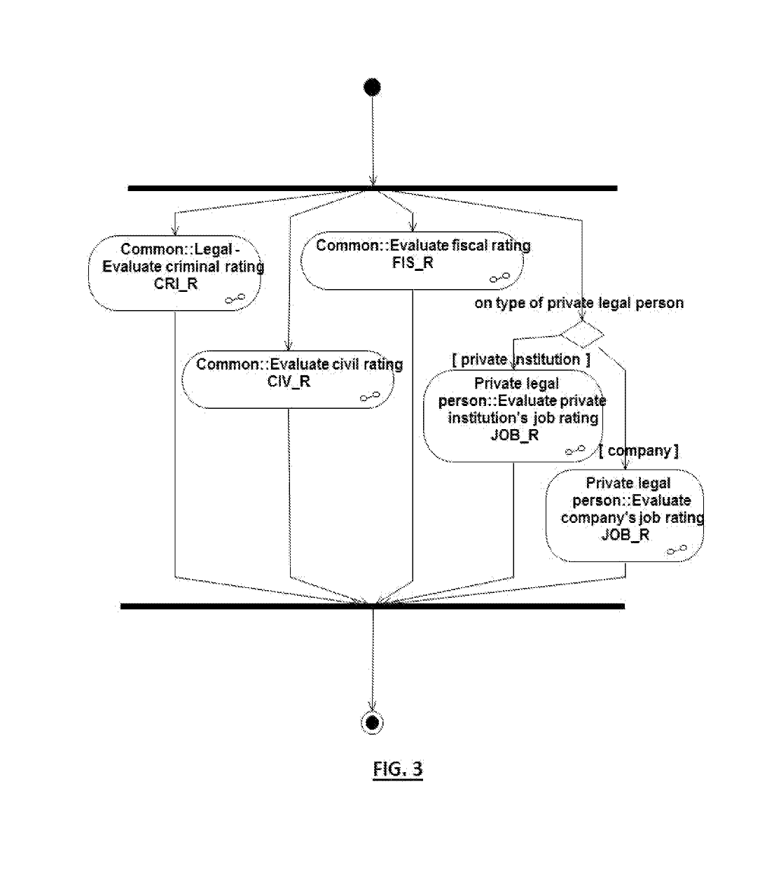

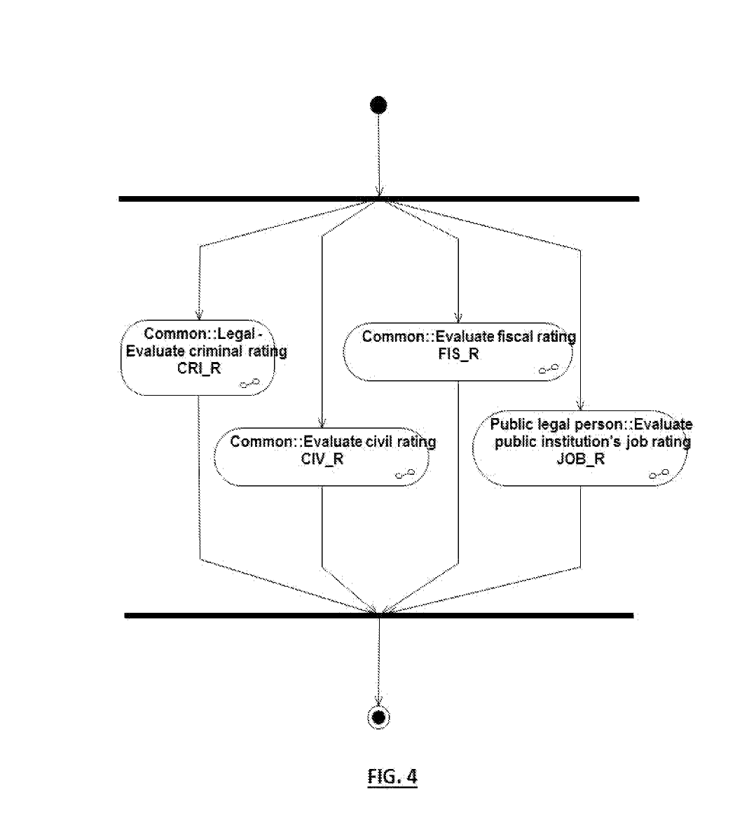

With reference to FIGS. 1 to 4 the main flow chart that determines the URC rating algorithm of the invention is described. In particular FIG. 1 is a general overview diagram, FIG. 2 relates to the evaluation rating of an individual, FIG. 3 relates to the evaluation rating of a private legal person, FIG. 4 relates to the evaluation rating of a public legal person.

This is the main flow chart that defines the rating algorithm.

The reputational rating is structured in three ways, related to the type of subject:
INDIVIDUALS;
PRIVATE LEGAL PERSONS (companies, private institutions);
PUBLIC LEGAL PERSONS (public institutions).

The rating of INDIVIDUALS is composed by 5 parts:
criminal reputation (related to crimes or special preventive measures);
fiscal reputation (related to fiscal disputes);
civil reputation (related to civil disputes);
education;
job reputation.

The rating of LEGAL PERSONS, PRIVATE or PUBLIC, is composed by 4 parts:
criminal reputation (related to crimes or special preventive measures);
fiscal reputation (related to fiscal disputes);
civil reputation (related to civil disputes);
job reputation.

The rating is evaluated through the facts and their supporting evidences that compose the reputational profile, excluding the suspended ones (e.g. a fact may be suspended because there is a related discrepancy pending).

In all the following diagrams are used the stereotypes below:
<<access to reputation's persistence>>:
   it means that the activity performs a database access;
<<read algorithm's configuration>>:
   it means that the activity reads the coefficient related to a specific category of facts or evidences, from a configuration table or matrix;
<<read reputation's properties>>:
   it means that the activity fetches information from the reputational profile (according to the data model defined in the class diagrams).

NOTES ABOUT THE DIAGRAMS
The amounts of money (revenues, financial penalties, . . . ) must be measured in normalized working days, defined with the formula:

working_days=(amount*365/GDP per capita)

where GDP per capita=daily gross domestic product per capita related to the year during which the amount was defined.
The time factor concerning the age of a fact, is applied through a multiplicative coefficient (TF) read from the table below, indexed by the age

| Range of years | TF |
|---|---|
| m1, M1 | TF1 |
| m2, M2 | TF2 |
| m3, M3 | TF3 |
| . . . | |

### 5.2. General—Evaluate Category of Facts Diagram

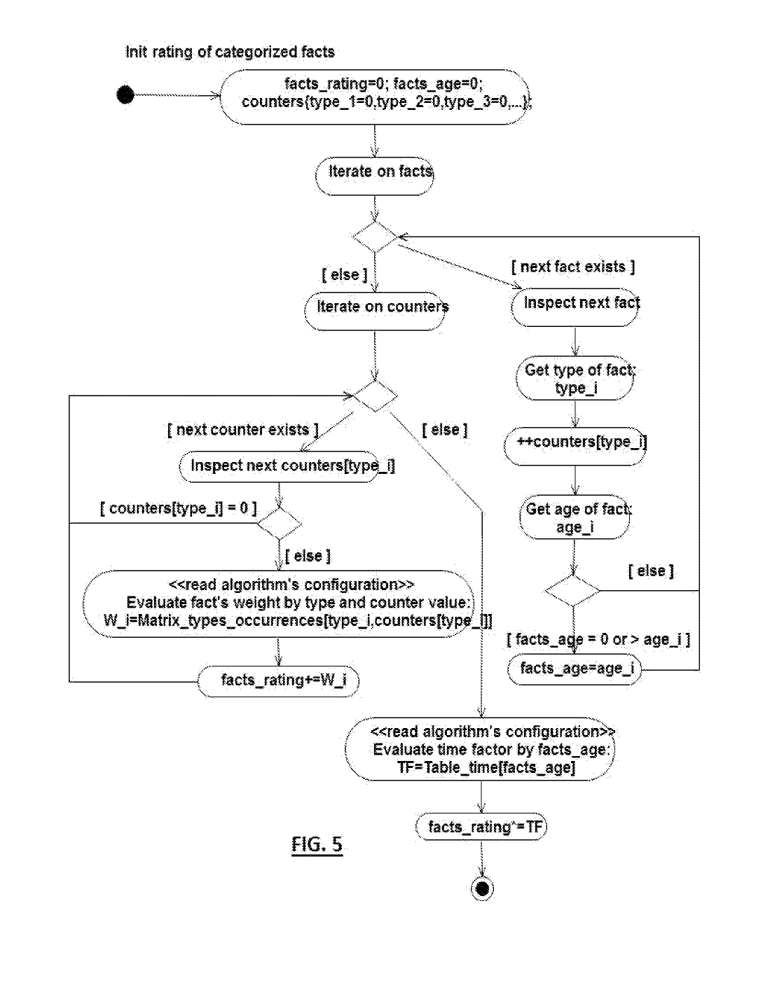

FIG. 5 shows a flow chart of actions with a general scope and included in other charts.

It defines the rating contribution of set of facts with a specific type, considering their subtypes (categories), the number of occurrences for each subtype (distributed in ranges) and the age of the facts.

The matrix below with types and occurrences (Matrix_types_occurrences) defines the coefficient W related to a fact.

number of occurrences

| Type of fact | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

The time factor is applied at the end of the flow, as a global factor evaluated on the age of the most recent fact (criterion of continuity).

### 5.3. Evaluate Civil Rating Diagram

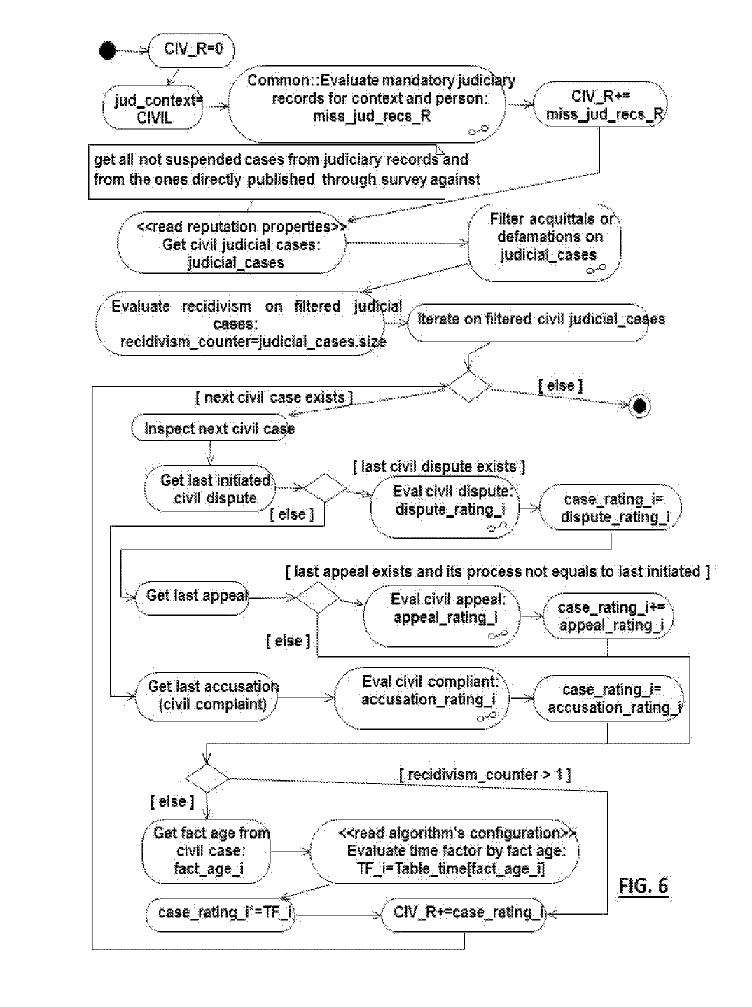

FIG. 6 shows a flow chart of actions for determining the civil rating (CIV_R) of individuals and legal persons (private or public).

This rating is based on the weights assigned to the facts (valid or certified, not suspended) fetched from the civil judicial cases published through the surveys against a third party and from the items of the mandatory judiciary records published through the surveys pro oneself.

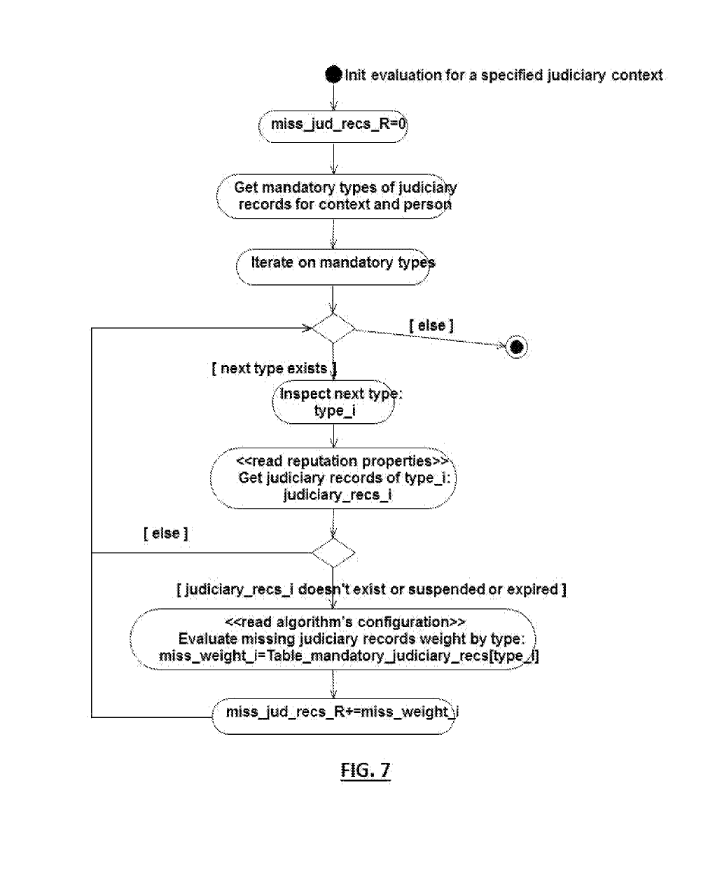

If some mandatory judiciary records are missed, then a weight is applied—ref. subactivity diagram “Evaluate civil, fiscal and criminal rating—Evaluate mandatory judiciary records” (FIG. 7).

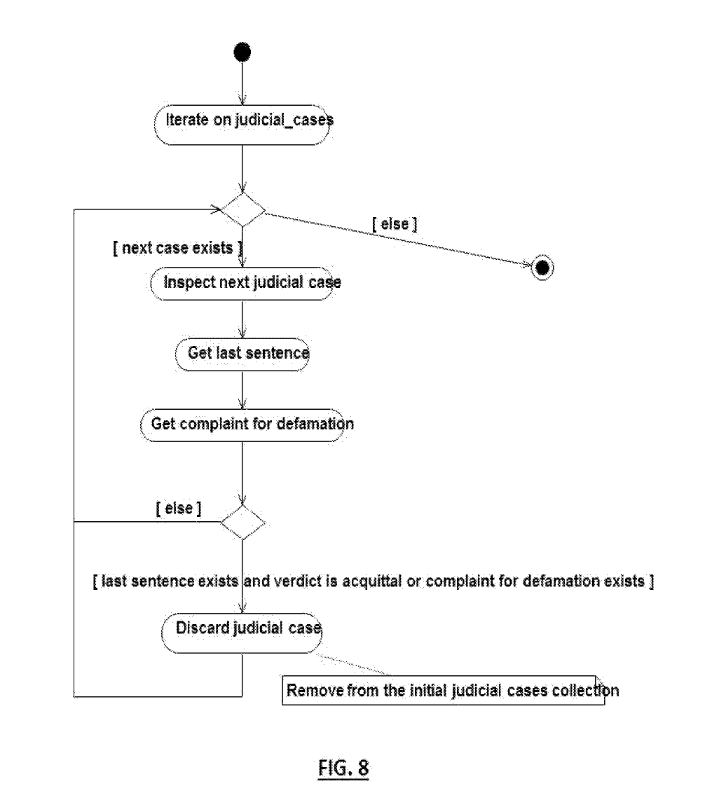

Judicial cases with a sentence of acquittal or associated to a complaint for defamation are discarded from the evaluation—ref subactivity diagram “Evaluate civil, fiscal and criminal rating—Filter acquittals or defamations” (FIG. 8).

Recidivism happens when there is more than one judicial case (recidivism_counter>1).

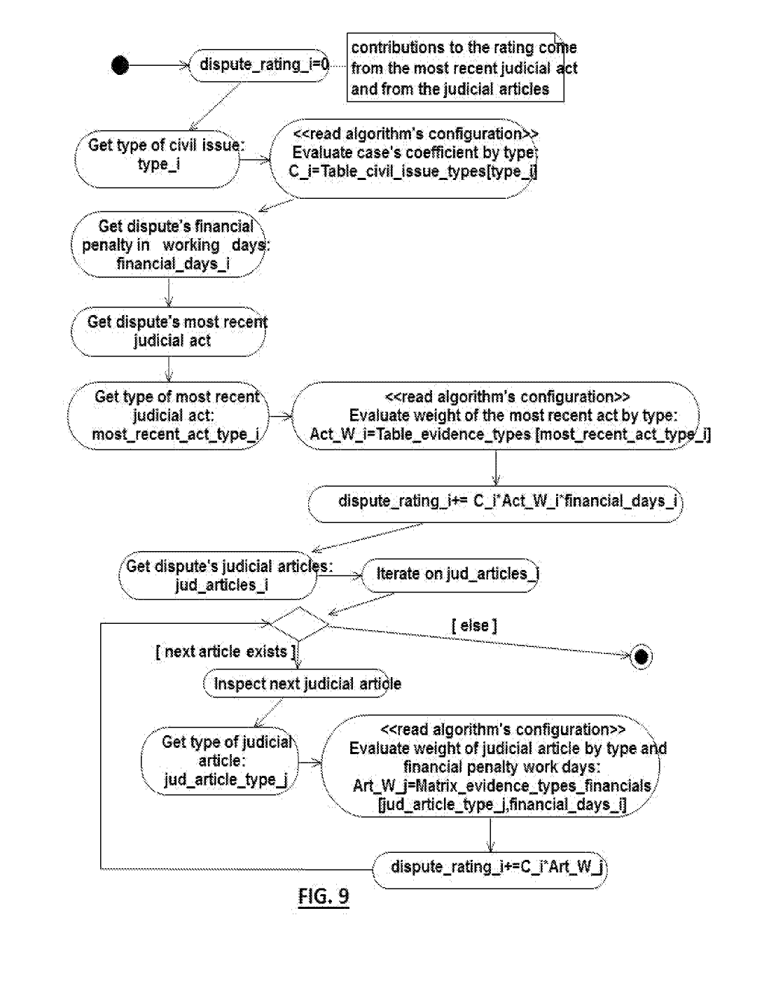

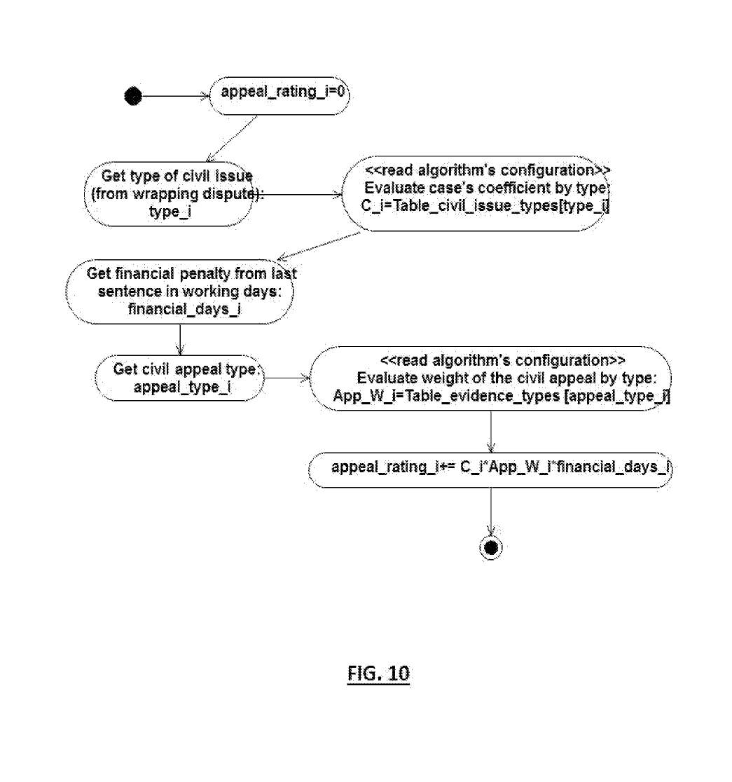

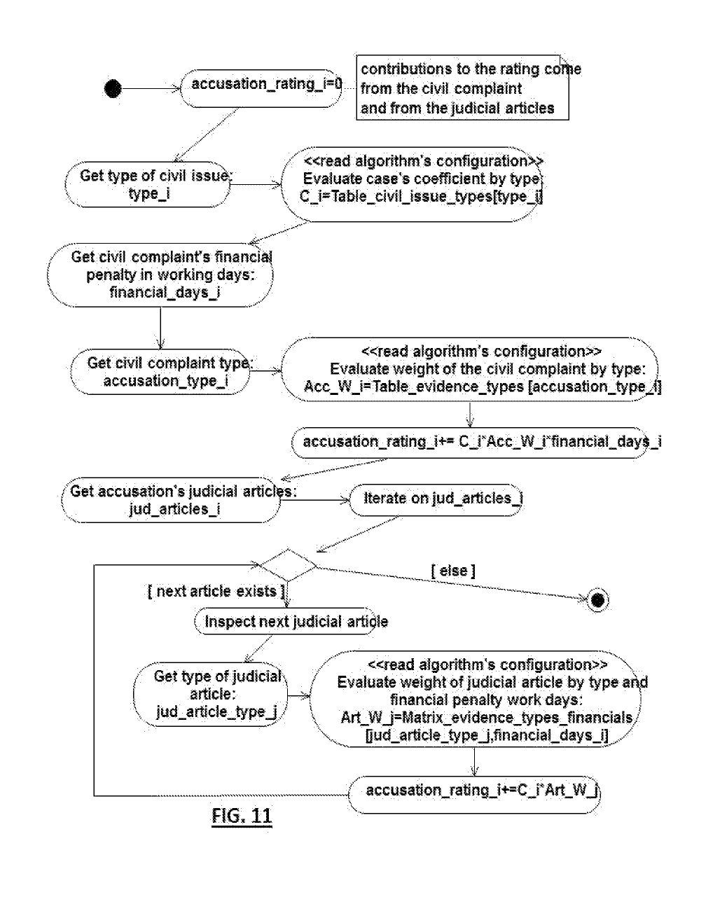

Each case contributes to the rating with the most recent judicial act (ref. subactivity diagram “Evaluate civil rating—Evaluate dispute”, FIG. 9) or the most recent accusation (ref. subactivity diagram “Evaluate civil rating—Evaluate complaint”, FIG. 11), including all the related judicial articles (videos, articles, . . . ), and with the appeal (ref. subactivity diagram “Evaluate civil rating—Evaluate appeal”, FIG. 10).

The time factor is applied only if recidivism doesn't happen and is based on the age of the fact.

### 5.4. Evaluate Civil, Fiscal and Criminal Rating—Evaluate Mandatory Judiciary Records Diagram

FIG. 7 shows a flow chart of actions for determining the validity of the mandatory judiciary records included in the reputation. It's a subactivity of all the judicial cases' evaluations as described in “Evaluate civil rating” diagram, “Evaluate fiscal rating” diagram, “Legal person—Evaluate criminal rating” diagram, “Individual—Evaluate criminal rating” diagram.

Fixed a judicial context (criminal, civil, fiscal) and a type of person (individual, private or public legal), there are a set of judiciary records that must be included and must be periodically updated in the reputation through the publication of the curriculum vitae.

If this doesn't happen, then a weight is added to the rating for each missing judiciary records.

This miss_weight is defined through the table of mandatory judiciary records (Table_mandatory_judiciary_recs) below

| Type of judiciary recs | Weight |
|---|---|
| type 1 | W1 |
| type 2 | W2 |
| type 3 | W3 |
| . . . | |

### 5.5. Evaluate Civil, Fiscal and Criminal Rating—Filter Acquittals or Defamations Diagram

FIG. 8 shows a flow chart of actions for inspecting the judicial cases, discarding the ones with a verdict of acquittal or a complaint for defamation. It's a subactivity of all the judicial cases' evaluations as described in “Evaluate civil rating” diagram, “Evaluate fiscal rating” diagram, “Legal person—Evaluate criminal rating” diagram, “Individual—Evaluate criminal rating” diagram.

### 5.6. Evaluate Civil Rating—Evaluate Dispute Diagram

FIG. 9 shows a flow chart of actions for determining the contribution (dispute_rating_i) of a single civil dispute to the rating of individuals and legal persons (private or public). Its a subactivity of “Evaluate civil rating” diagram.

Considering a dispute and the related type of civil issue examined, the coefficient C is defined through the table of issue's types (Table_civil_issue types) below

| Type of civil issue | Coefficient |
|---|---|
| type 1 | C1 |
| type 2 | C2 |
| type 3 | C3 |
| . . . | |

The evidences are inspected, evaluating the contribution of the most recent judicial act and of every judicial article.

The weight Act_W (for a single working day) related to a judicial act is evaluated considering the type of evidence, through the table of evidence's types (Table_evidence_types) below

| Type of evidence | Weight |
|---|---|
| type 1 | W1 |
| type 2 | W2 |
| type 3 | W3 |
| . . . | |

For each judicial article, the weight Art_W is evaluated considering the type and the penalty amount measured in working days, through the matrix types/working days (Matrix_evidence_types_work_days) below

Range of working days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.7. Evaluate Civil Rating—Evaluate Appeal Diagram

FIG. 10 shows a flow chart of actions for determining the contribution (appeal_rating_i) of an appeal to a civil sentence to the rating of individuals and legal persons (private or public). It's a subactivity of “Evaluate civil rating” diagram.

Considering the appeal and the related type of civil issue examined in the dispute, the coefficient C is defined through the table of issue's types (Table_civil_issue_types) below

| Type of civil issue | Coefficient |
|---|---|
| type 1 | C1 |
| type 2 | C2 |
| type 3 | C3 |
| . . . | |

The weight App_W (for a single working day) related to the appeal is evaluated considering the type of appeal (that is an Evidence), through the table of evidence's types (Table_evidence_types) below

| Type of evidence | Weight |
|---|---|
| type 1 | W1 |
| type 2 | W2 |
| type 3 | W3 |
| . . . | |

### 5.8. Evaluate Civil Rating—Evaluate Complaint Diagram

FIG. 11 shows a flow chart of actions for determining the contribution (accusation_rating_i) of a single civil complaint to the rating of individuals and legal persons (private or public). It's a subactivity of “Evaluate civil rating” diagram.

Considering a civil complaint and the related type of civil issue examined, the coefficient C is defined through the table of issue's types (Table_civil_issue_types) below

| Type of civil issue | Coefficient |
|---|---|
| type 1 | C1 |
| type 2 | C2 |
| type 3 | C3 |
| . . . | |

The evidences are inspected, evaluating the contribution of the civil complaint and of every judicial article.

The weight Acc_W (for a single working day) related to the complaint is evaluated considering the type of evidence, through the table of evidence's types (Table_evidence_types) below

| Type of evidence | Weight |
|---|---|
| type 1 | W1 |
| type 2 | W2 |
| type 3 | W3 |
| . . . | |

For each judicial article, the weight Art_W is evaluated considering the type and the penalty amount measured in working days, through the matrix types/working days (Matrix_evidence_types_work_days) below

Range of working days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.9. Evaluate Fiscal Rating Diagram

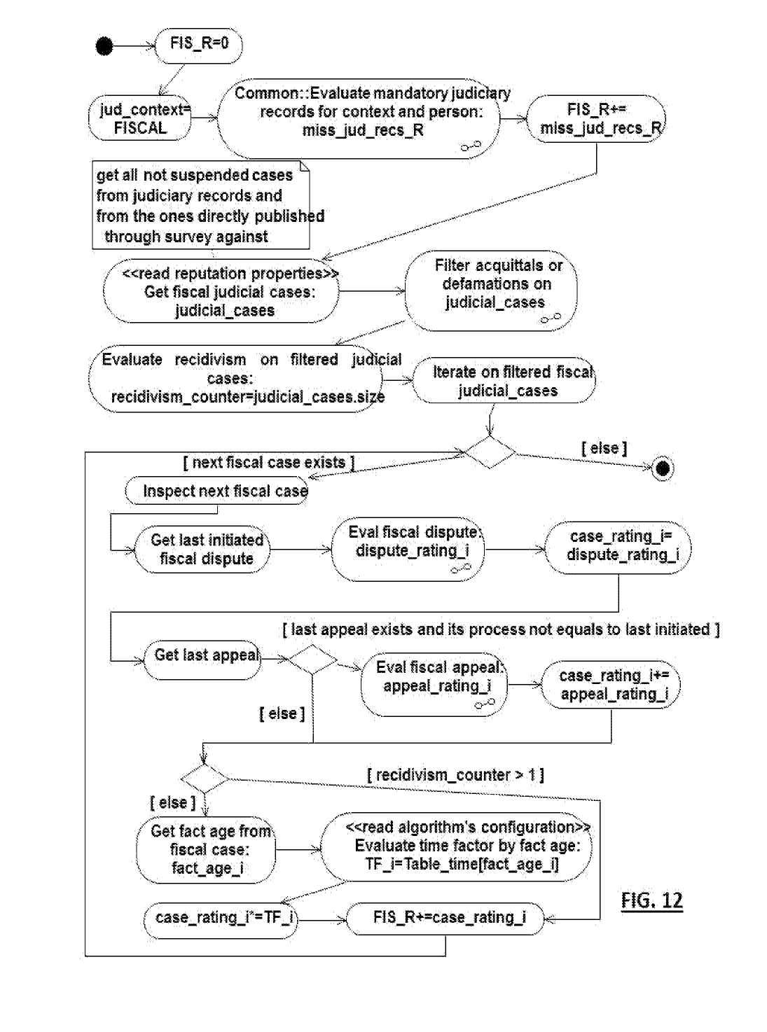

FIG. 12 shows a flow chart of actions for determining the fiscal rating (FIS_R) of individuals and legal persons (private or public).

This rating is based on the weights assigned to the facts (valid or certified, not suspended) fetched from the fiscal judicial cases published through the surveys against a third party and from the items of the mandatory judiciary records published through the surveys pro oneself.

If some mandatory judiciary records are missed, then a weight is applied—ref. subactivity diagram “Evaluate civil, fiscal and criminal rating—Evaluate mandatory judiciary records” (FIG. 7).

Judicial cases with a sentence of acquittal or associated to a complaint for defamation are discarded from the evaluation—ref subactivity diagram “Evaluate civil, fiscal and criminal rating—Filter acquittals or defamations” (FIG. 8).

Recidivism happens when there is more than one judicial case (recidivism_counter>1).

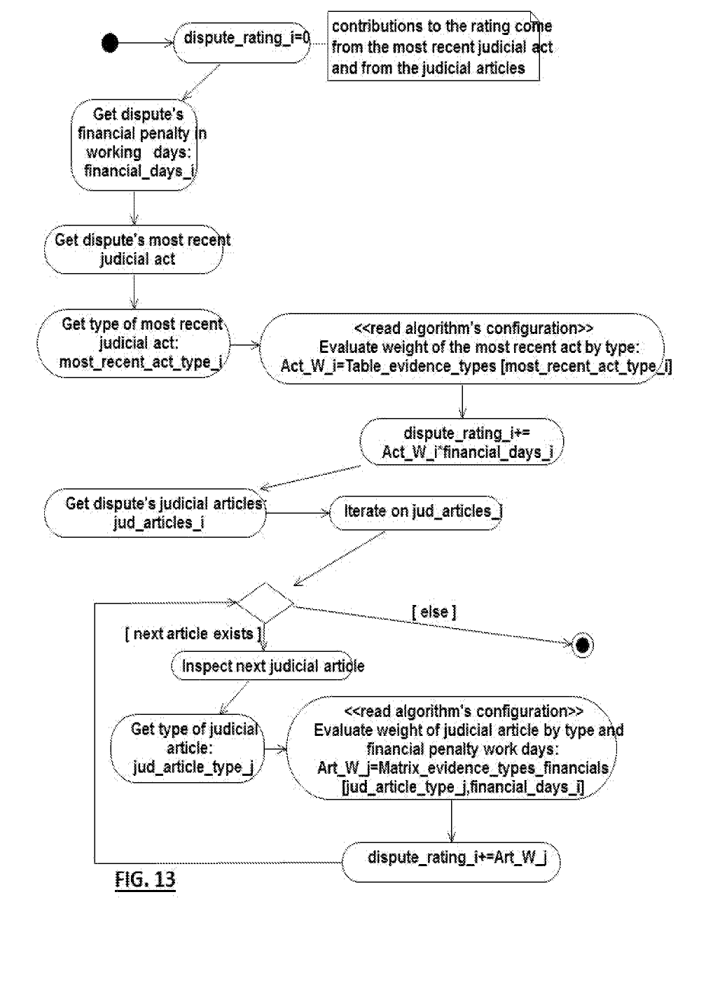

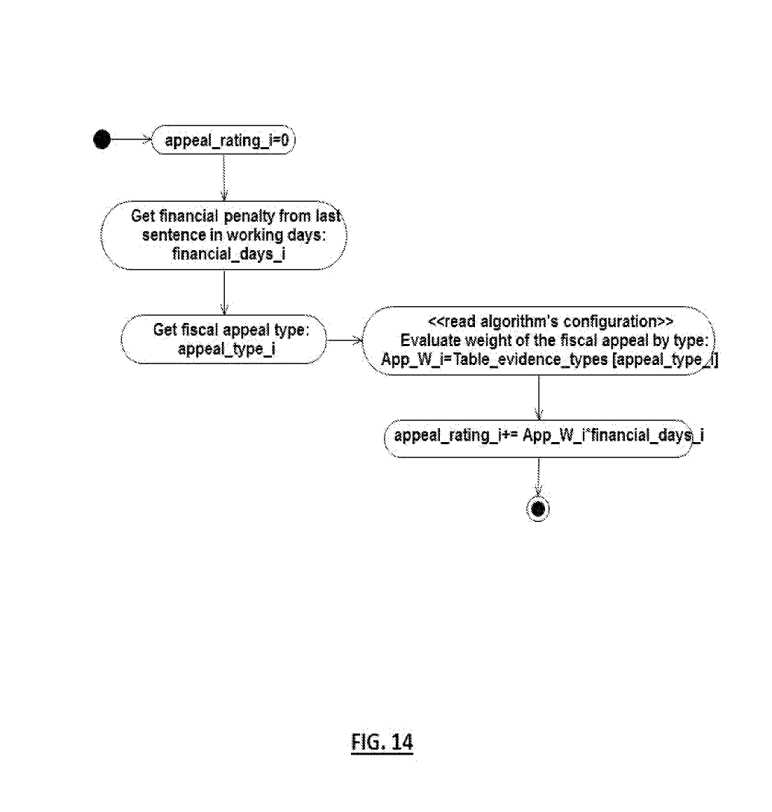

Each case contributes to the rating with the most recent judicial act (ref subactivity diagram “Evaluate fiscal rating—Evaluate dispute”, FIG. 13), including all the related judicial articles (videos, articles, . . . ), and with the appeal (ref. subactivity diagram “Evaluate fiscal rating—Evaluate appeal”, FIG. 14).

The time factor is applied only if recidivism doesn't happen and is based on the age of the fact.

### 5.10. Evaluate Fiscal Rating—Evaluate Dispute Diagram

FIG. 13 shows a flow chart of actions for determining the contribution (dispute_rating_i) of a single fiscal dispute to the rating of individuals and legal persons (private or public). Its a subactivity of “Evaluate fiscal rating” diagram.

Considering a dispute, the evidences are inspected, evaluating the contribution of the most recent judicial act and of every judicial article.

The weight Act W (for a single working day) related to a judicial act is evaluated considering the type of evidence, through the table of evidence's types (Table_evidence_types) below

| Type of evidence | Weight |
|---|---|
| type 1 | W1 |
| type 2 | W2 |
| type 3 | W3 |
| . . . | |

For each judicial article, the weight Art_W is evaluated considering the type and the penalty amount measured in working days, through the matrix types/working days (Matrix_evidence_types work days) below

Range of working days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.11. Evaluate Fiscal Rating—Evaluate Appeal Diagram

FIG. 14 shows a flow chart of actions for determining the contribution (appeal_rating_i) of an appeal to a fiscal sentence, to the rating of individuals and legal persons (private or public). It's a subactivity of “Evaluate fiscal rating” diagram.

The weight App_W (for a single working day) related to the appeal is evaluated considering the type of appeal (that is an Evidence), through the table of evidence's types (Table_evidence_types) below

| Type of evidence | Weight |
|---|---|
| type 1 | W1 |
| type 2 | W2 |
| type 3 | W3 |
| . . . | |

### 5.12. Individual—Evaluate Criminal Rating Diagram

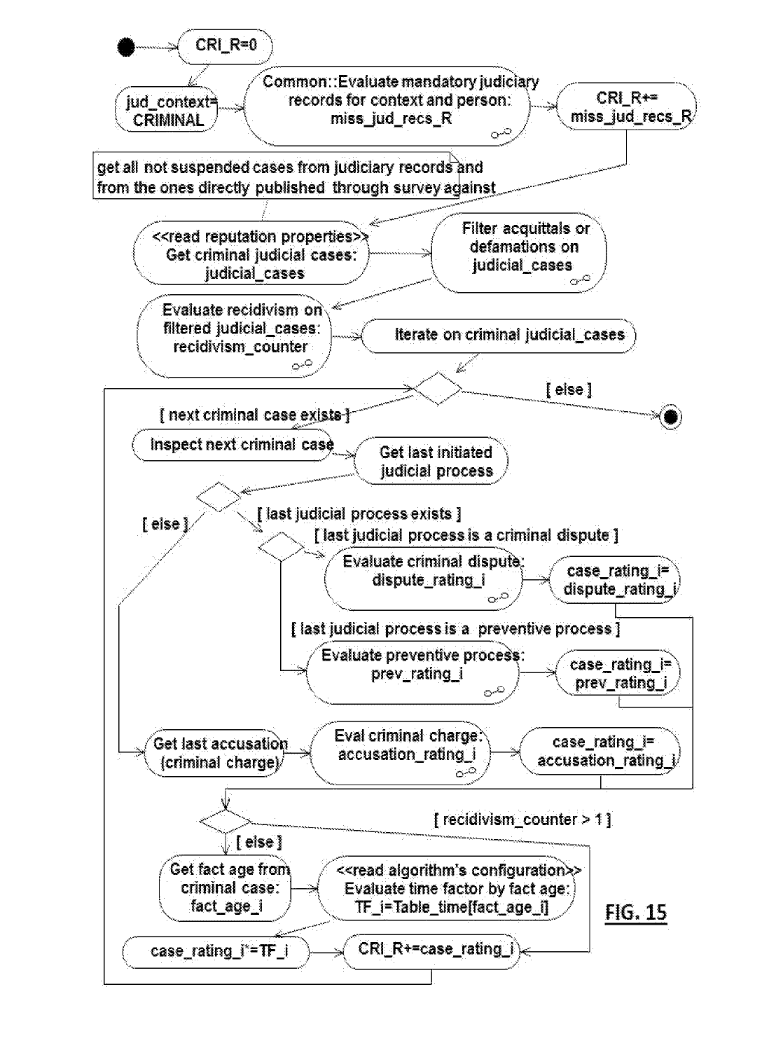

FIG. 15 shows a flow chart of actions for determining the criminal rating (CRI_R) of individuals.

This rating is based on the weights assigned to the facts (valid or certified, not suspended) fetched from the civil judicial cases published through the surveys against a third party and from the items of the mandatory judiciary records published through the surveys pro oneself.

If some mandatory judiciary records are missed, then a weight is applied—ref. subactivity diagram “Evaluate civil, fiscal and criminal rating—Evaluate mandatory judiciary records” (FIG. 7).

Judicial cases with a sentence of acquittal or associated to a complaint for defamation are discarded from the evaluation—ref subactivity diagram “Evaluate civil, fiscal and criminal rating—Filter acquittals or defamations” (FIG. 8).

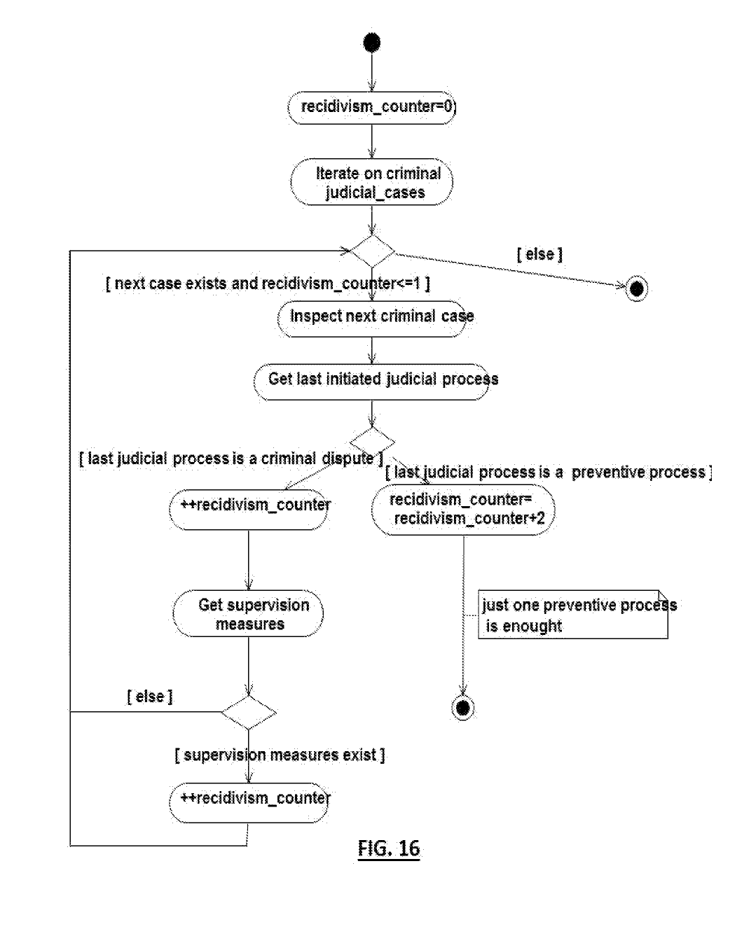

Recidivism happens when there is more than one judicial case or if there is just one special preventive measure or supervision measure (recidivism_counter>1)—ref subactivity diagram “Individual—Evaluate criminal rating—Evaluate recidivism” (FIG. 16).

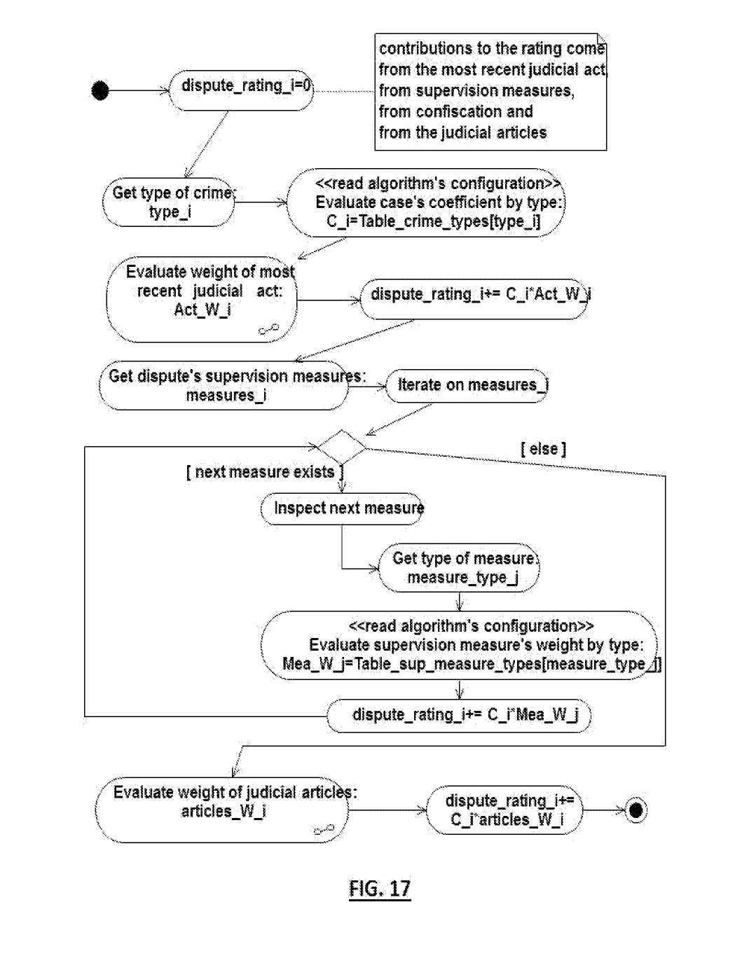

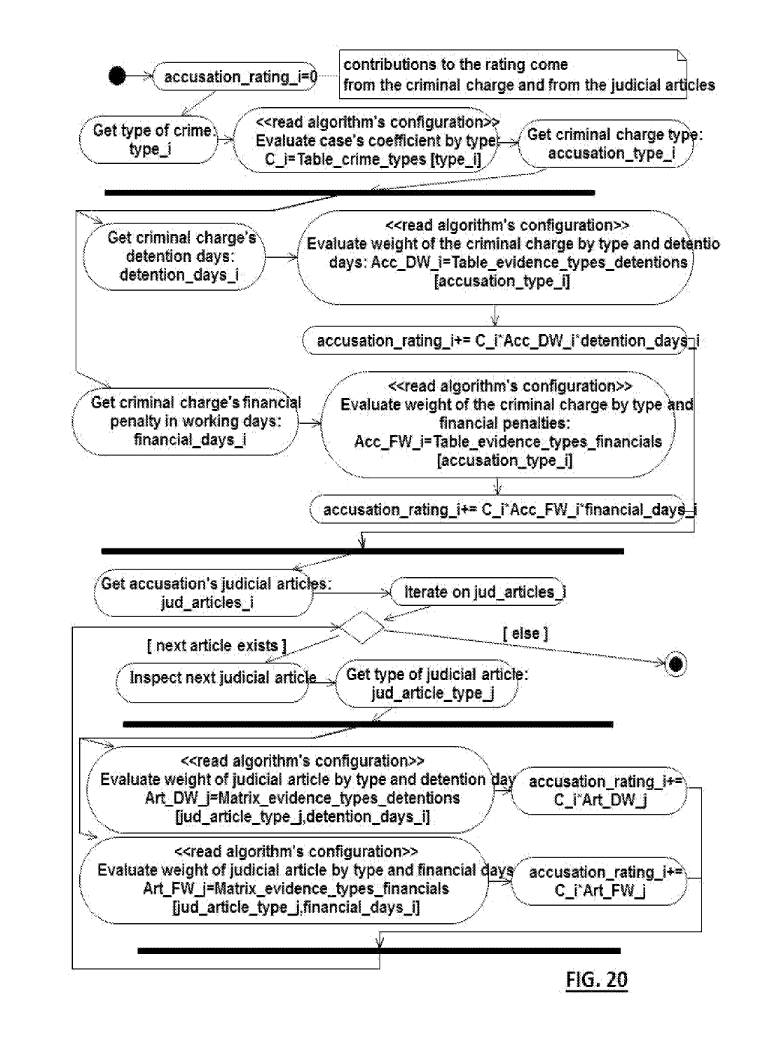

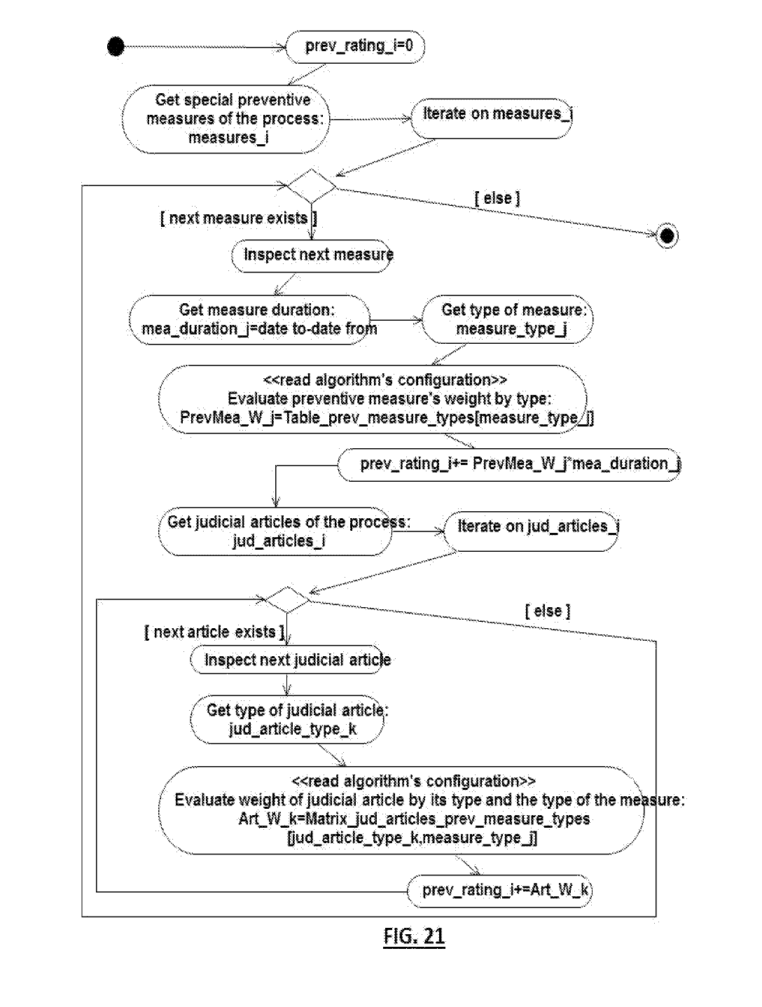

Each case contributes to the rating with the most recent judicial act and its supervision measures (ref subactivity diagram “Individual—Evaluate criminal rating—Evaluate dispute”, FIG. 17) or with the special preventive measures (ref subactivity diagram “Individual—Evaluate criminal rating—Evaluate preventive process”, FIG. 21) or with the most recent accusation (ref subactivity diagram “Individual—Evaluate criminal rating—Evaluate criminal charge”, FIG. 20), including all the related judicial articles (videos, articles, . . . ).

The time factor is applied only if recidivism doesn't happen and is based on the age of the fact.

### 5.13. Individual—Evaluate Criminal Rating—Evaluate Recidivism Diagram

FIG. 16 shows a flow chart of actions for determining the recidivism for individuals about criminal cases. It's a subactivity of “Individual—Evaluate criminal rating” diagram.

Recidivism happens when there is more than one dispute or if there is just one special preventive measure or supervision measure (recidivism_counter>1).

### 5.14 Individual—Evaluate Criminal Rating—Evaluate Dispute Diagram

FIG. 17 shows a flow chart of actions for determining the contribution (case_rating_i) of a single criminal dispute to the rating of individuals. It's a subactivity of “Individual—Evaluate criminal rating” diagram.

Considering a dispute and the related type of crime examined, the coefficient C is defined through the table of crime's types (Table crime types) below

| Type of crime | Coefficient |
|---|---|
| type 1 | C1 |
| type 2 | C2 |
| type 3 | C3 |
| . . . | |

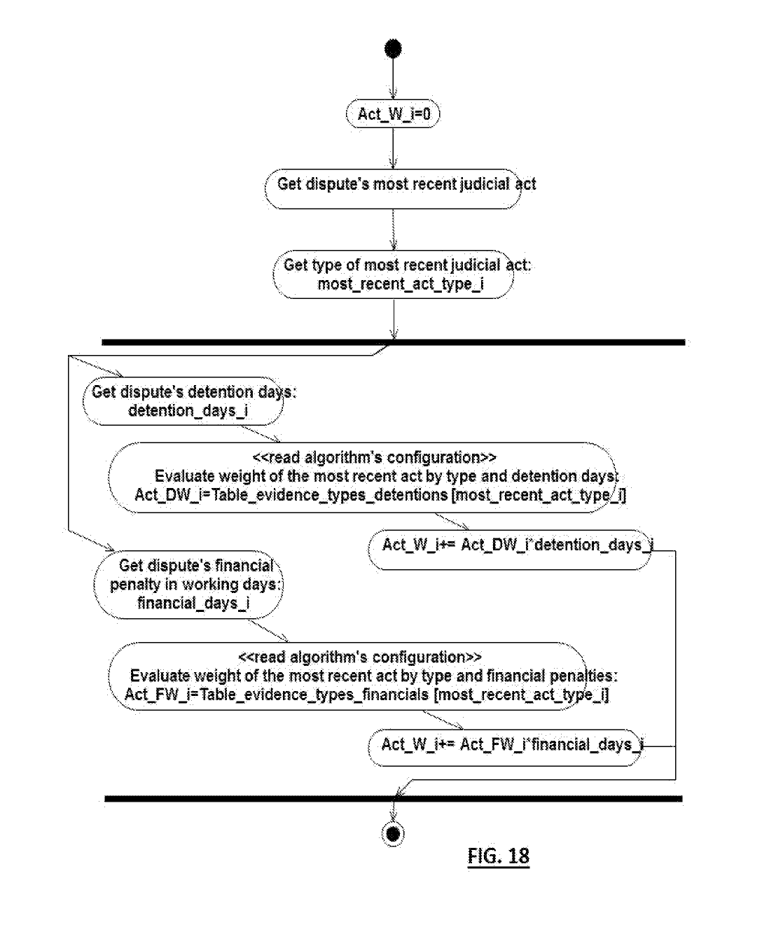

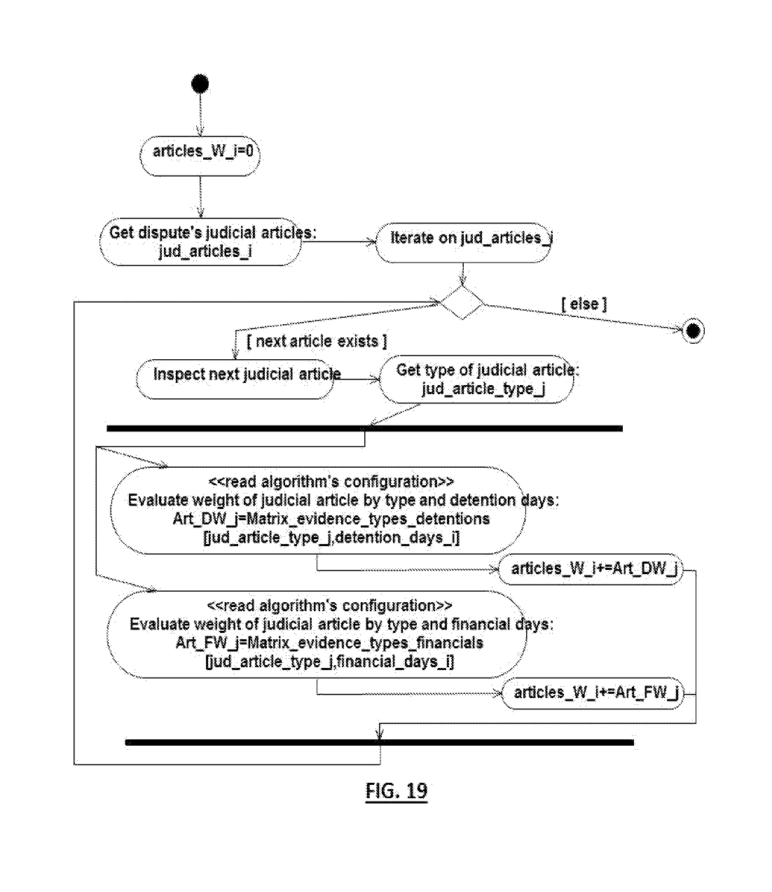

The evidences are inspected, evaluating the contribution of the most recent judicial act (ref. subactivity diagram “Individual—Evaluate criminal rating—Evaluate dispute's last act”, FIG. 18), of the supervision measures and of every judicial article (ref. subactivity diagram “Individual—Evaluate criminal rating—Evaluate dispute's judicial articles”, FIG. 19).

For each supervision measure, the weight Mea_W (for a single day of application of the measure) is evaluated considering the type of the measure, through the table of measure's types (Table_sup_measure_types) below

| Type of measure | Weight |
|---|---|
| type 1 | W1 |
| type 2 | W2 |
| type 3 | W3 |
| . . . | |

### 5.15. Individual—Evaluate Criminal Rating—Evaluate Dispute's Last Act Diagram

FIG. 18 shows a flow chart of actions for determining the contribution (Act_W_i) of the most recent judicial act in a criminal dispute against an individual. It's a subactivity of “Individual—Evaluate criminal rating—Evaluate dispute” diagram.

The contribution is the sum of a first weight (Act_DW) calculated through the detention penalty and a second weight (Act_FW) calculated through the financial penalty measured in working days. The weight Act_DW (for a single detention's day) is evaluated considering the type of evidence, through the table of evidence's types for detentions (Table_evidence_types_detentions); furthermore, the weight Act_FW (for a single working day) is evaluated considering the type of evidence, through the table of evidence's types for financial penalties

(Table_evidence_types_financials);

both tables have the same structure below

| Type of evidence | Weight |
|---|---|
| type 1 | W1 |
| type 2 | W2 |
| type 3 | W3 |
| . . . | |

### 5.16. Individual—Evaluate Criminal Rating—Evaluate Dispute's Judicial Articles Diagram

FIG. 19 shows a flow chart of actions for determining the contribution (articles_W_i) of the judicial articles about a criminal dispute against an individual. It's a subactivity of “Individual—Evaluate criminal rating—Evaluate dispute” diagram.

For each judicial article,the contribution is the sum of a first weight (Art_DW) calculated through the detention penalty (previously determined in the last act's evaluation) and a second weight (Art_FW) calculated through the financial penalty measured in working days (previously determined in the last act's evaluation).

The weight Art_DW is evaluated considering the type and the detentions days, through the matrix types/detention days (Matrix_evidence_types_detentions);

furthermore, the weight Art_FW is evaluated considering the type with the financial penalties measured in working days for the second one, through the matrix types/financial penalties working days (Matrix_evidence_types_financials);
both matrices have the same structure below

Range of days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.17. Individual—Evaluate Criminal Rating—Evaluate Criminal Charge Diagram

FIG. 20 shows a flow chart of actions for determining the contribution (accusation_rating_i) of a single criminal charge to the rating of individuals. Its a subactivity of “Individual—Evaluate criminal rating” diagram.

Considering a criminal charge and the related type of crime examined, the coefficient C is defined through the table of crime's types (Table_crime_types) below

| Type of crime | Coefficient |
|---|---|
| type 1 | C1 |
| type 2 | C2 |
| type 3 | C3 |
| . . . | |

The evidences are inspected, evaluating the contribution of the criminal charge and of every judicial article.

Each contribution is the sum of a first weight calculated through the detention penalty and a second weight calculated through the financial penalty measured in working days.

For the criminal charge, the weight Acc_DW (for a single detention's day) is evaluated considering the type of evidence, through the table of evidence's types for detentions (Table_evidence_types_detentions);

furthermore, the weight Acc_FW (for a single working day) is evaluated considering the type of evidence, through the table of evidence's types for financial penalties (Table evidence types financials); both tables have the same structure below

| Type of evidence | Weight |
|---|---|
| type 1 | W1 |
| type 2 | W2 |
| type 3 | W3 |
| . . . | |

In the same way, for each judicial article, the weight Art_DW is evaluated considering the type and the detentions days, through the matrix types/detention days (Matrix_evidence_types_detentions); furthermore, the weight Art FW is evaluated considering the type with the financial penalties measured in working days, through the matrix types/financial penalties working days (Matrix_evidence_types_financials);

both matrices have the same structure below

Range of days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.18. Individual—Evaluate Criminal Rating—Evaluate Preventive Process Diagram

FIG. 21 shows a flow chart of actions for determining the contribution (prev_rating_i) of a single preventive process to the rating of individuals. It's a subactivity of “Individual—Evaluate criminal rating” diagram.

The evidences are inspected, evaluating the contribution of every preventive measure and of every judicial article.

For each supervision measure, the weight PrevMea_W (for a single application day of the measure) is evaluated considering the type of the measure, through the table of preventive measure's types (Table_prev_measure_types) below

| Type of measure | Weight |
|---|---|
| type 1 | W1 |
| type 2 | W2 |
| type 3 | W3 |
| . . . | |

For each judicial article, the weight Art_W is evaluated considering the type of the article and the type of each measure, through the matrix (Matrix jud articles prev measure types) below

Type of jud article

| Type of measure | art type 1 | art type 2 | art type 3 | |
|---|---|---|---|---|
| mea type 1 | W11 | W12 | W13 | . . . |
| mea type 2 | W21 | W22 | W23 | . . . |
| mea type 3 | W31 | W32 | W33 | . . . |
| . . . | | | | |

### 5.19. Legal Person—Evaluate Criminal Rating Diagram

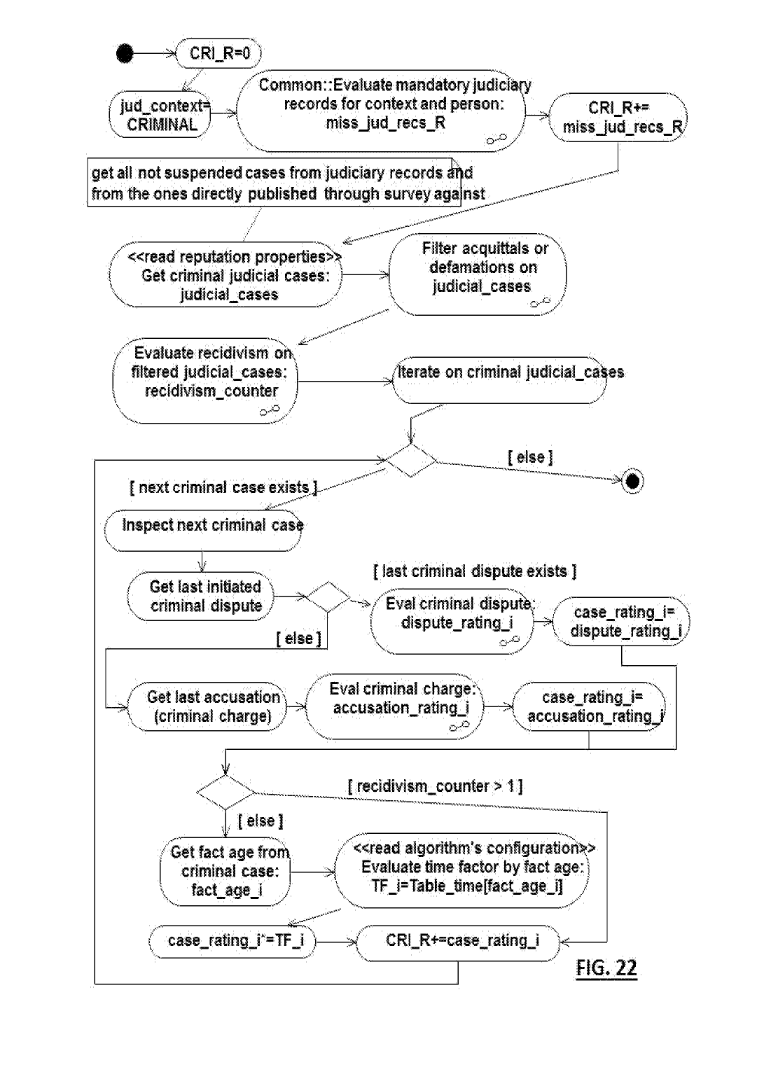

FIG. 22 shows a flow chart of actions for determining the criminal rating (CRI_R) of a legal person (private or public).

This rating is based on the weights assigned to the facts (valid or certified, not suspended) fetched from the civil judicial cases published through the surveys against a third party and from the items of the mandatory judiciary records published through the surveys pro oneself.

If some mandatory judiciary records are missed, then a weight is applied—ref. subactivity diagram “Evaluate civil, fiscal and criminal rating—Evaluate mandatory judiciary records” (FIG. 7).

Judicial cases with a sentence of acquittal or associated to a complaint for defamation are discarded from the evaluation—ref subactivity diagram “Evaluate civil, fiscal and criminal rating—Filter acquittals or defamations” (FIG. 8).

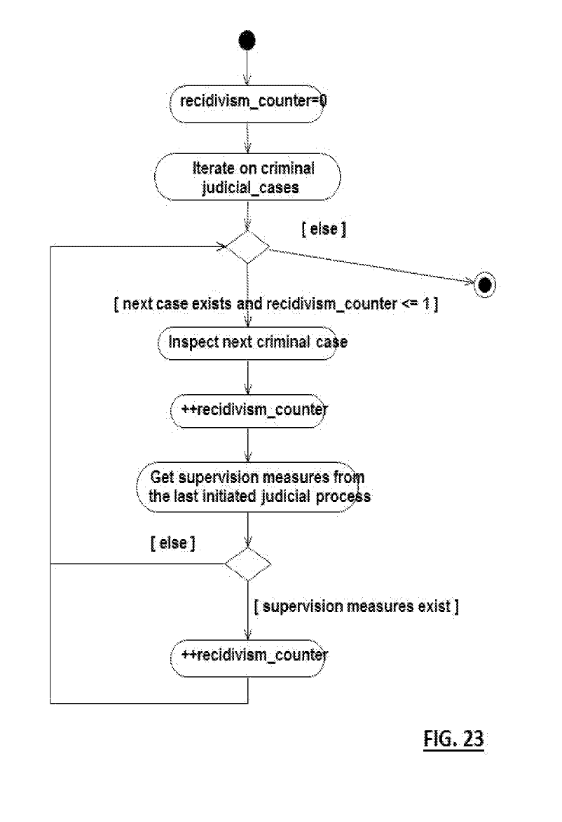

Recidivism happens when there is more than one judicial case or if there is just one supervision measure (recidivism_counter>1)—ref subactivity diagram “Legal person—Evaluate criminal rating—Evaluate recidivism” (FIG. 23).

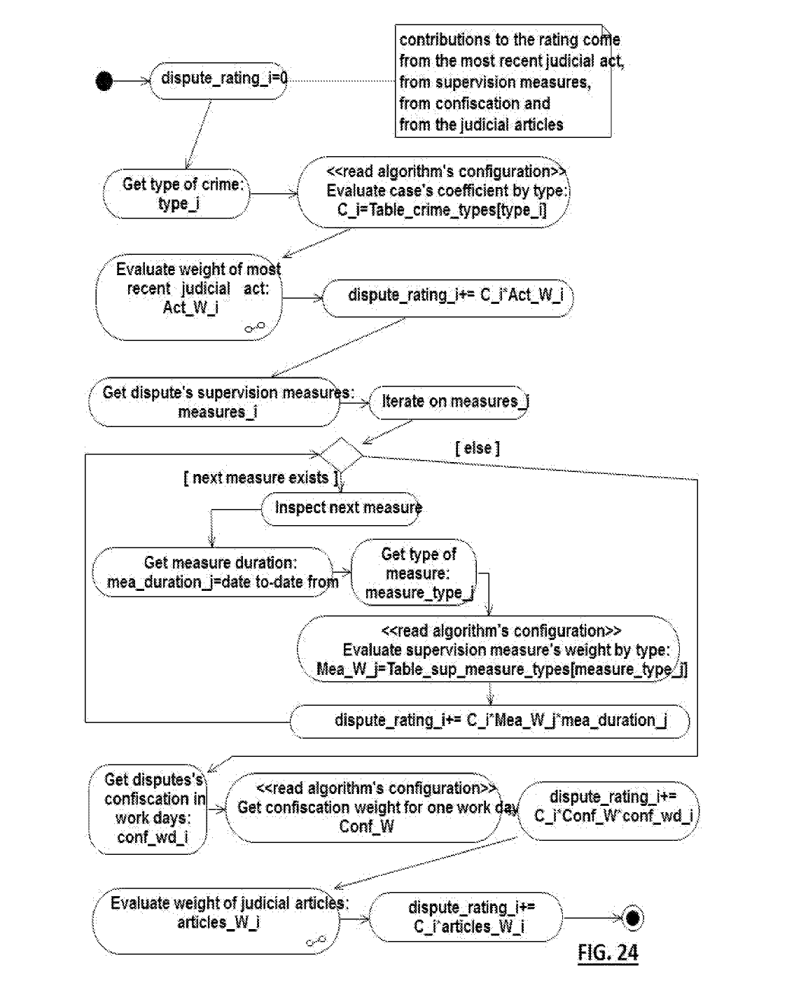

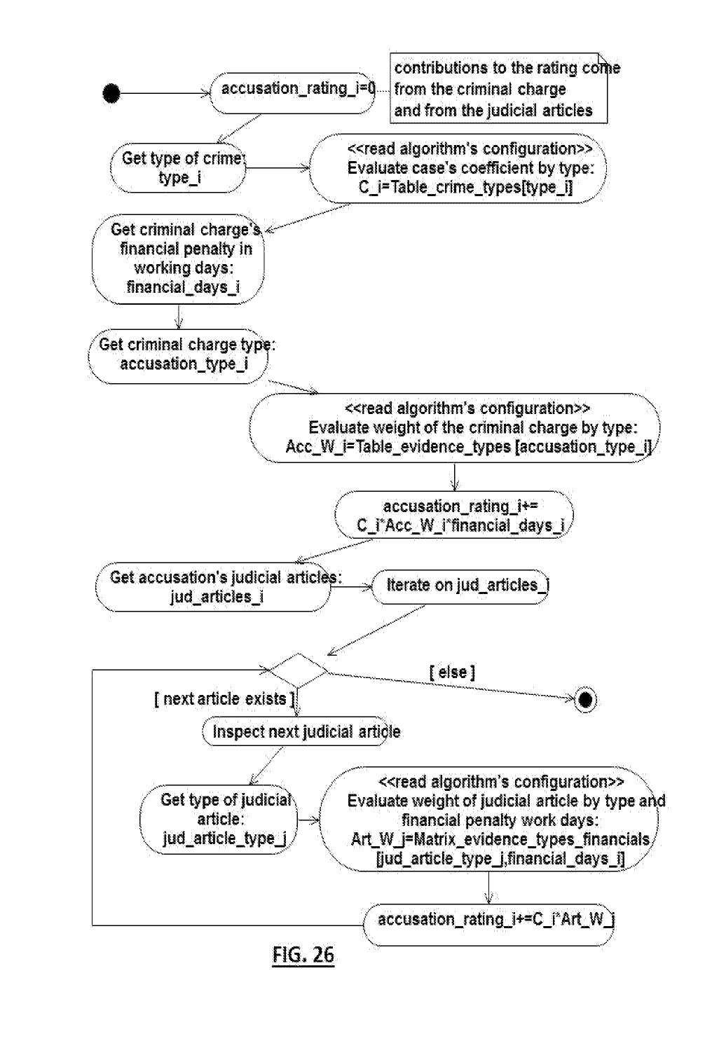

Each case contributes to the rating with the most recent judicial act and its supervision measures (ref subactivity diagram “Legal person—Evaluate criminal rating—Evaluate dispute”, FIG. 24) or with the most recent accusation (ref subactivity diagram “Legal person—Evaluate criminal rating—Evaluate criminal charge”, FIG. 26), including all the related judicial articles (videos, articles, . . . ). The time factor is applied only if recidivism doesn't happen and is based on the age of the fact.

### 5.20. Legal Person—Evaluate Criminal Rating—Evaluate Recidivism Diagram

FIG. 23 shows a flow chart of actions for determining the recidivism for legal persons (public or private) about criminal cases. It's a subactivity diagram of “Legal person—Evaluate criminal rating” diagram.

Recidivism happens when there is more than one dispute or if there is just one supervision measure (recidivism_counter>1).

### 5.21. Legal Person—Evaluate Criminal Rating—Evaluate Dispute Diagram

FIG. 24 shows a flow chart of actions for determining the contribution (case rating i) of a single criminal dispute to the rating of legal persons (private or public). It's a subactivity of “Legal person—Evaluate criminal rating” diagram.

Considering a dispute and the related type of crime examined, the coefficient C is defined through the table of crime's types (Table_crime_types) below

| Type of crime | Coefficient |
|---|---|
| type 1 | C1 |
| type 2 | C2 |
| type 3 | C3 |
| . . . | |

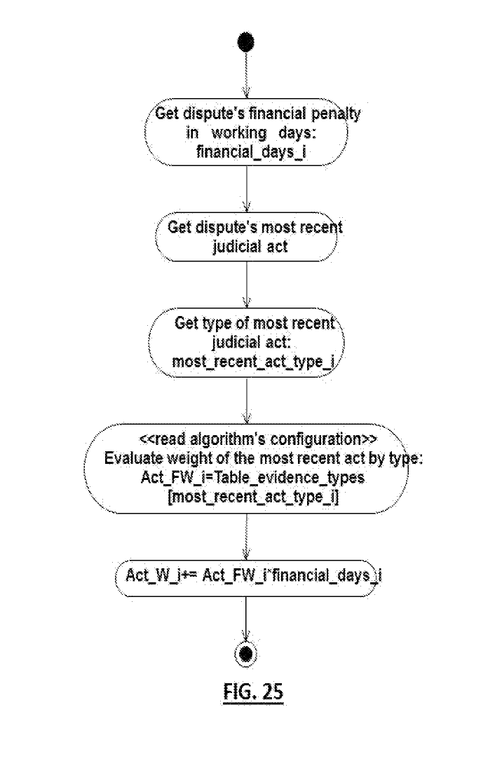

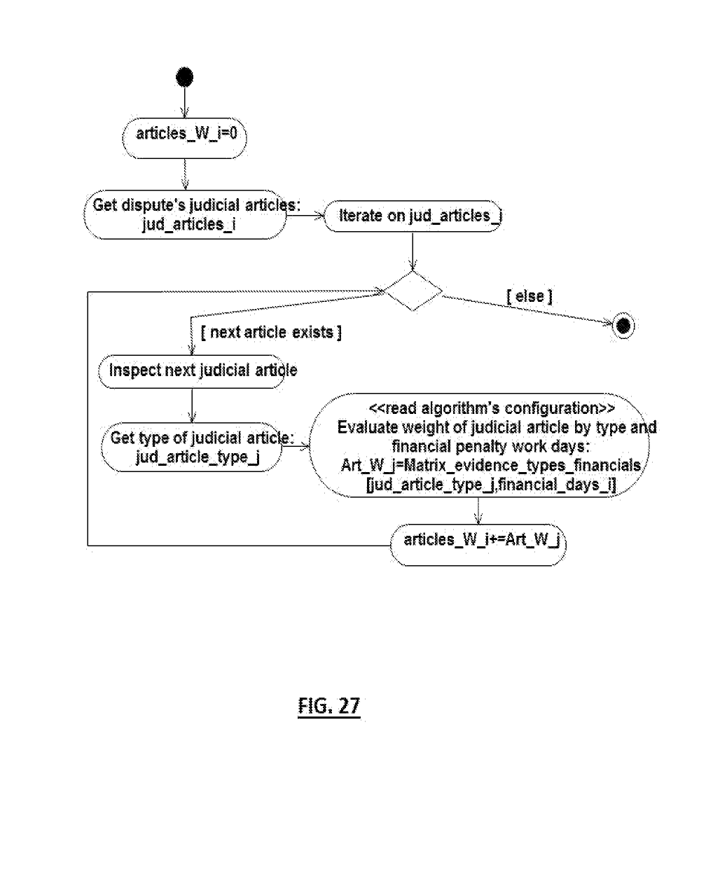

The evidences are inspected, evaluating the contribution of the most recent judicial act (ref subactivity diagram “Legal person—Evaluate criminal rating—Evaluate dispute's last act”, FIG. 25), of the supervision measures, of the confiscation and of every judicial article (ref subactivity diagram “Legal person—Evaluate criminal rating—Evaluate dispute's judicial articles”, FIG. 27).

For each supervision measure, the weight Mea_W (for a single application day of the measure) is evaluated considering the type of the measure, through the table of measure's types (Table_sup_measure_types) below

| Type of measure | Weight |
|---|---|
| type 1 | W1 |
| type 2 | W2 |
| type 3 | W3 |
| . . . | |

For the confiscation's penalty, measured in working days, the weight Conf_W is applied for each working days.

### 5.22. Legal Person—Evaluate Criminal Rating—Evaluate Dispute's Last Act Diagram

FIG. 25 shows a flow chart of actions for determining the contribution (Act_W_i) on a single working day of the most recent judicial act in a criminal dispute against a legal person. It's a subactivity of “Legal person—Evaluate criminal rating—Evaluate dispute” diagram.

The weight Act_W (for a single working day) related to a judicial act is evaluated considering the type of evidence, through the table of evidence's types (Table_evidence_types) below

| Type of evidence | Weight |
|---|---|
| type 1 | W1 |
| type 2 | W2 |
| type 3 | W3 |
| . . . | |

### 5.23. Legal Person—Evaluate Criminal Rating—Evaluate Criminal Charge Diagram

FIG. 26 shows a flow chart of actions for determining the contribution (accusation_rating_i) of a single criminal charge to the rating of legal persons (private or public). It's a subactivity of “Legal person—Evaluate criminal rating” diagram.

Considering a criminal charge and the related type of crime examined, the coefficient C is defined through the table of crime's types (Table_crime_types) below

| Type of crime | Coefficient |
|---|---|
| type 1 | C1 |
| type 2 | C2 |
| type 3 | C3 |
| . . . | |

The evidences are inspected, evaluating the contribution of the criminal charge and of every judicial article.

The weight Acc_W (for a single working day) related to the criminal charge is evaluated considering the type of evidence, through the table of evidence's types (Table_evidence_types) below

| Type of evidence | Weight |
|---|---|
| type 1 | W1 |
| type 2 | W2 |
| type 3 | W3 |
| . . . | |

For each judicial article, the weight Art_W is evaluated considering the type and the penalty amount measured in working days, through the matrix types/working days (Matrix_evidence_types_work_days) below

Range of working days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.24. Legal Person—Evaluate Criminal Rating—Evaluate Dispute's Judicial Articles Diagram

FIG. 27 shows a flow chart of actions for determining the contribution (articles_W_i) of the judicial articles about a criminal dispute against a legal person. It's a subactivity of “Legal person—Evaluate criminal rating—Evaluate dispute” diagram.

For each judicial article, the weight Art_W is evaluated considering the type and the penalty amount measured in working days (previously determined in the last act's evaluation), through the matrix types/working days (Matrix_evidence_types_work_days) below

Range of working days

| Type of evidence | m1-M1 | m2-M2 | m3-M3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

### 5.25. Individual—Evaluate Educational Rating Diagram

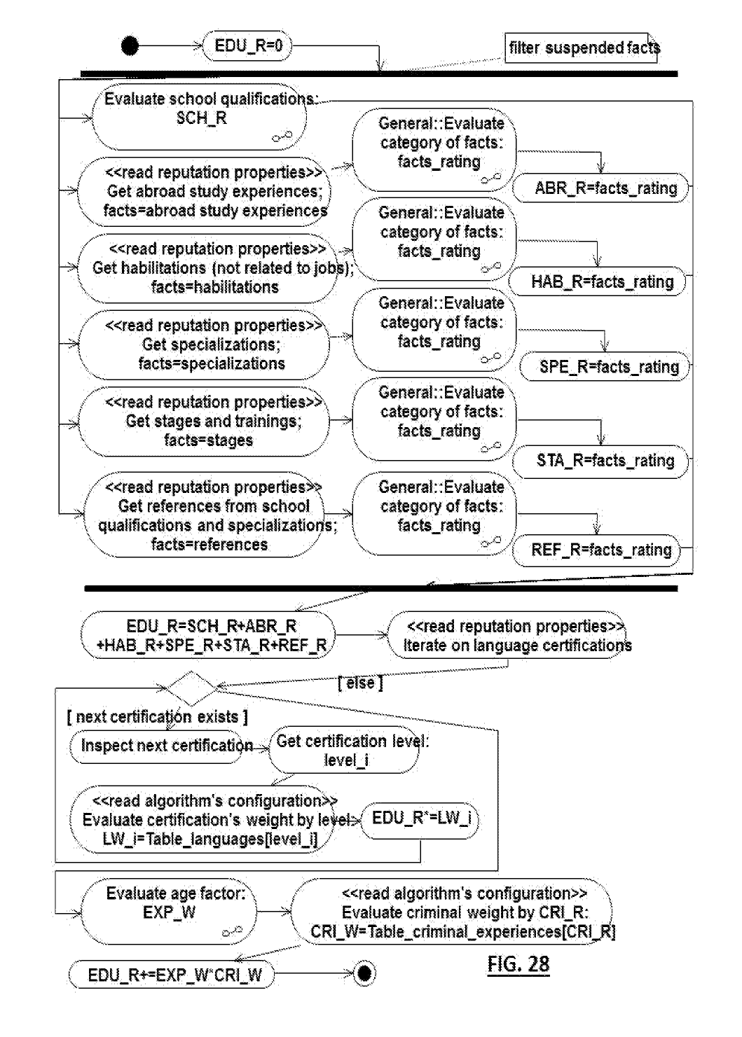

FIG. 28 shows a flow chart of actions for determining the rating (EDU_R) related to the education of individuals.

This rating is based on the weights assigned to the facts (valid or certified, not suspended) fetched from the list of school qualifications, abroad study experiences, habilitations (not associated to a job experience), specializations, language certifications, stages and trainings and references written by teachers, each one published with the curriculum vitae.

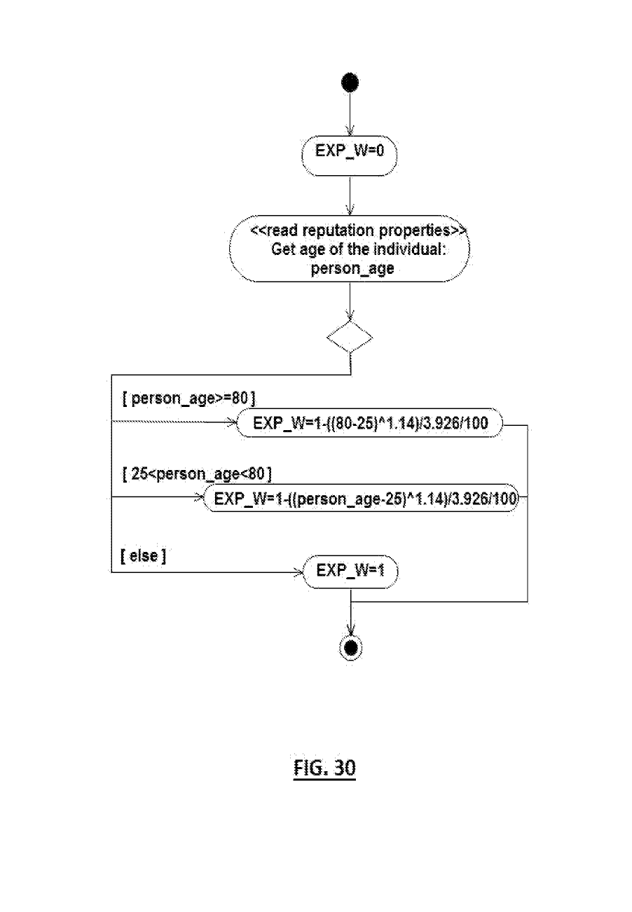

On this rating is considered the age factor (more someone grows up, more percentage of facts he is capable of transforming into life experience—ref. subactivity diagram “Individual—Evaluate educational rating—Age factor”, FIG. 30) and, eventually, it's applied a negative coefficient related to some socially negative behavior.

The weight LW of a language certification is evaluated considering the certification level, through the table of languages (Table_languages) below

| Level | Weight |
|---|---|
| level 1 | LW1 |
| level 2 | LW2 |
| level 3 | LW3 |
| . . . | |

Finally, the incidence of a socially negative behaviour is evaluated considering the criminal rating CRI R, previously calculated, through the table of the criminal history (Table_criminal_experiences) below

| CRI_R (range) | Weight |
|---|---|
| m1-M1 | CRI_W1 |
| m2-M2 | CRI_W2 |
| m3-M3 | CRI_W3 |
| . . . | |

### 5.26. Individual—Evaluate Educational Rating—Evaluate School Qualifications Diagram

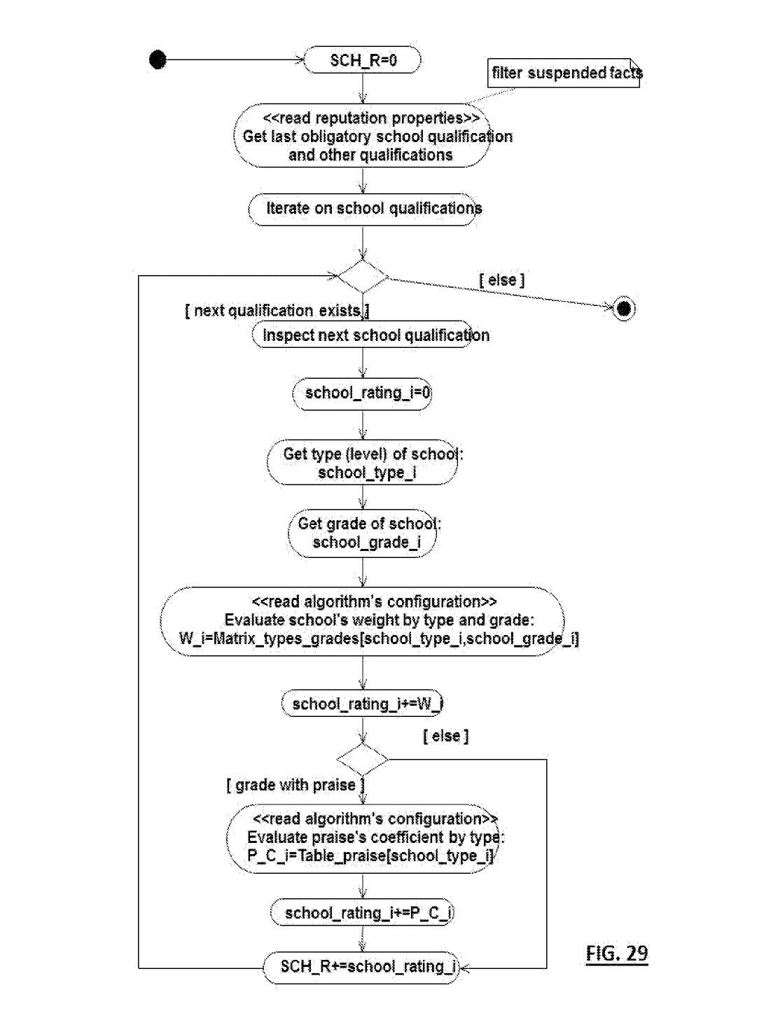

FIG. 29 shows a flow chart of actions for determining the contribution (SCH_R) of the school qualifications to the educational rating. It's a subactivity of “Individual—Evaluate educational rating” diagram.

Only the most recent obligatory school qualification is evaluated with all the others not obligatory.

The weight W of school qualification is evaluated considering the type of qualification and the final grade, through the matrix types/grades (Matrix_types_grades) below

range of grades

| School type | g1-G1 | g2-G2 | g3-G3 | . . . |
|---|---|---|---|---|
| type 1 | W11 | W12 | W13 | . . . |
| type 2 | W21 | W22 | W23 | . . . |
| type 3 | W31 | W32 | W33 | . . . |
| . . . | | | | |

In case of grade with praise, an additional coefficient P_C is evaluated considering the type of qualification, through the table of praises (Table_praise) below

| School type | Coefficient |
|---|---|
| type 1 | P_C1 |
| type 2 | P_C2 |
| type 3 | P_C3 |
| . . . | |

### 5.27. Individual—Evaluate Educational Rating—Age Factor Diagram

FIG. 30 shows a flow chart of actions for determining the weight (EXP_W) that contributes to the educational rating of individuals, due to the age of the individual and regarding the improvements of the personal knowledge related to the life's experiences.

Its a subactivity of “Individual—Evaluate educational rating” diagram.

### 5.28. Individual—Evaluate Job Rating Diagram

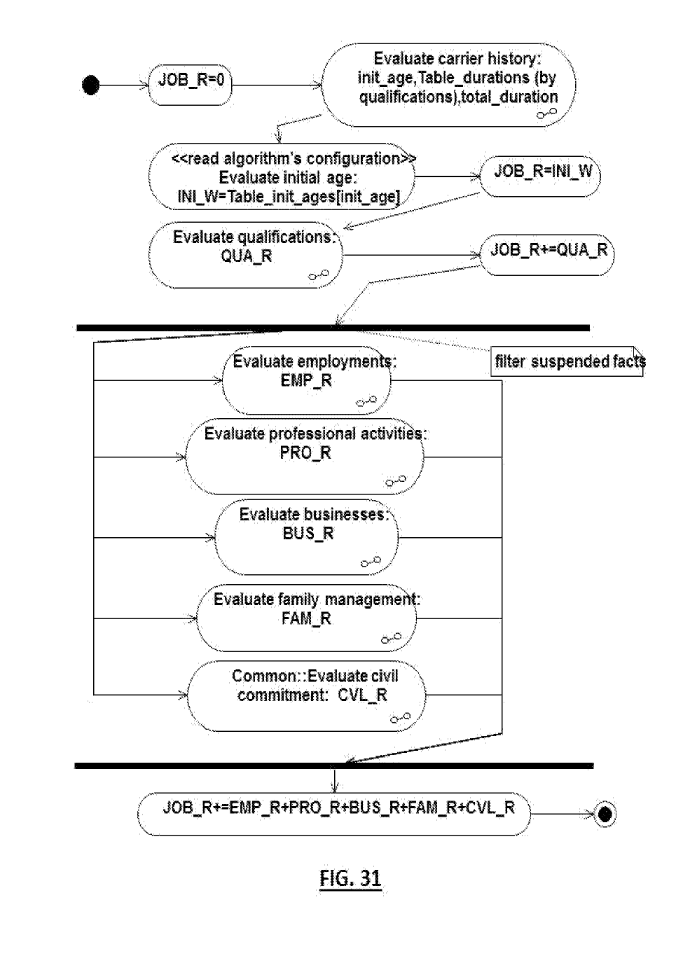

FIG. 31 shows a flow chart of actions for determining the job rating (JOB R) of individuals.

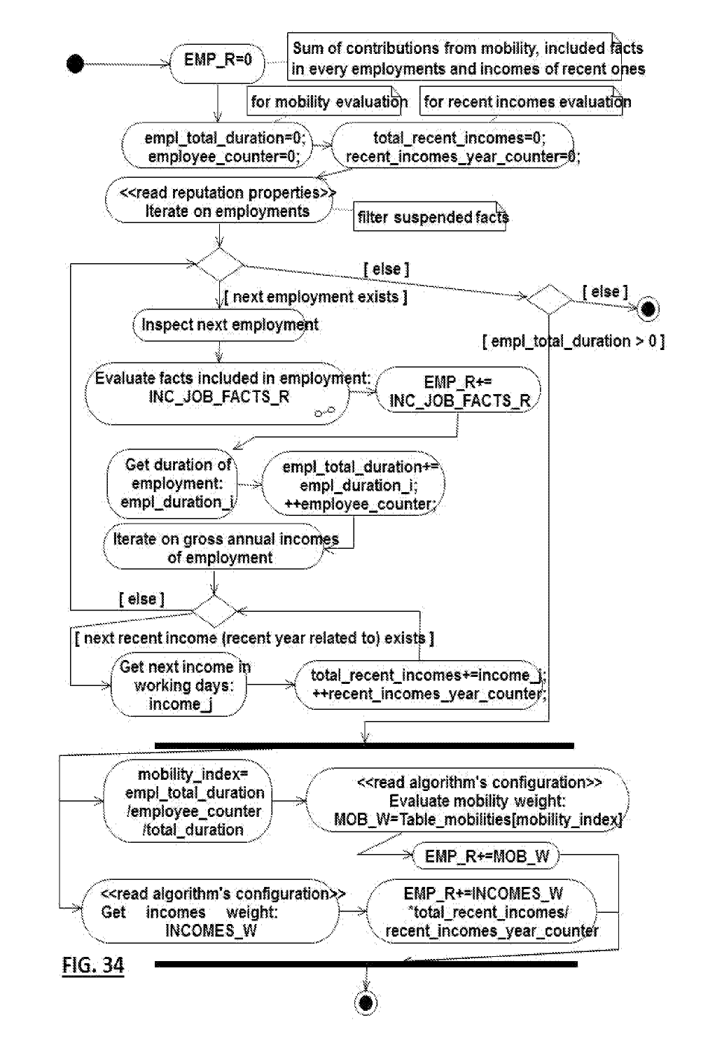

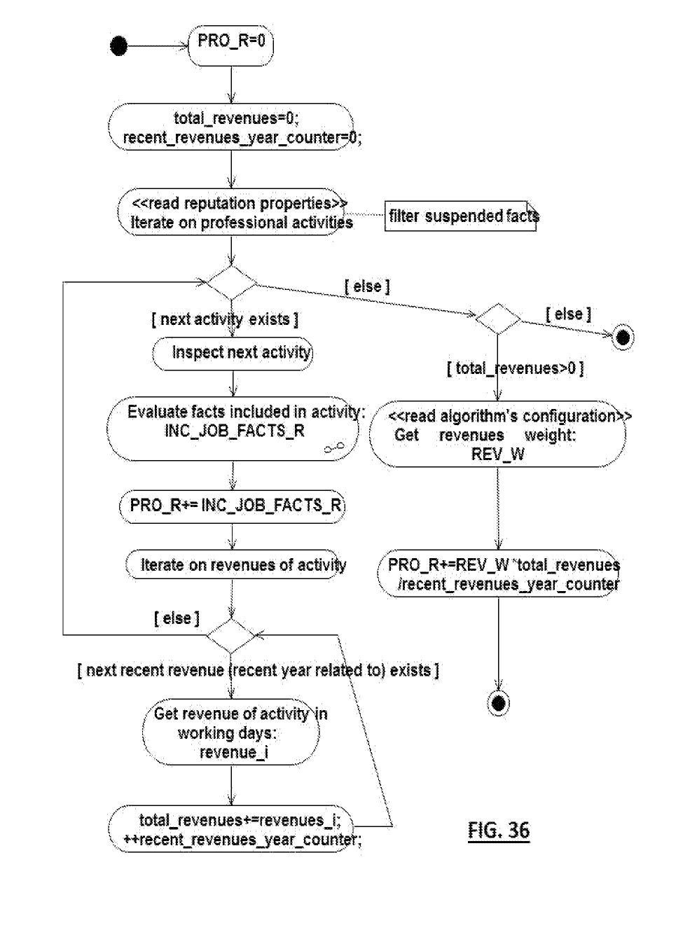

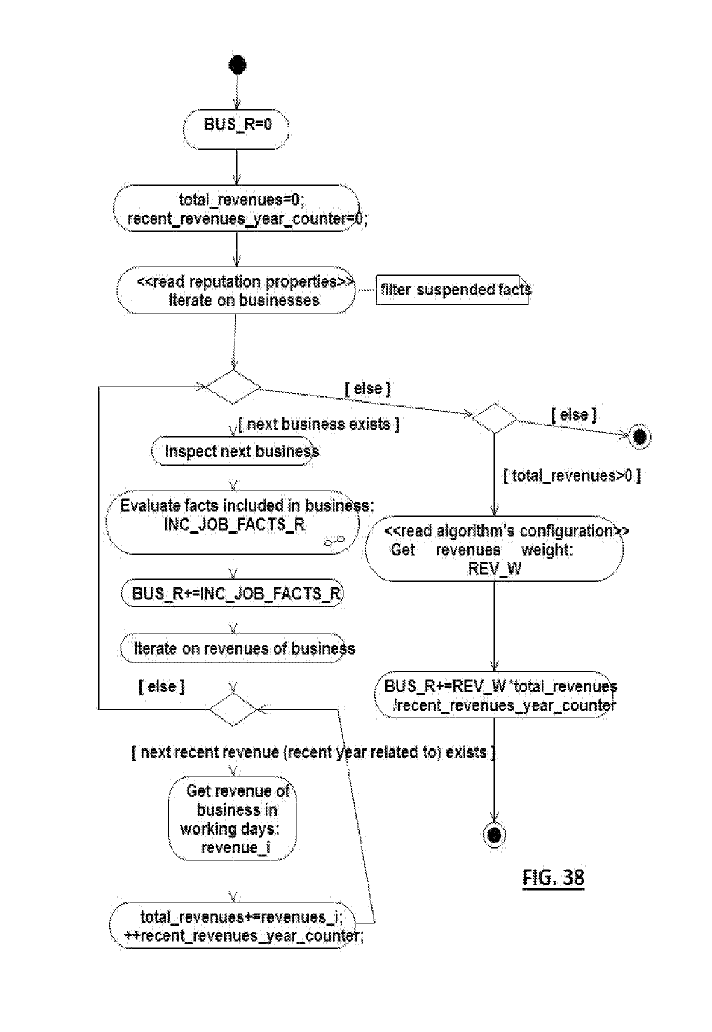

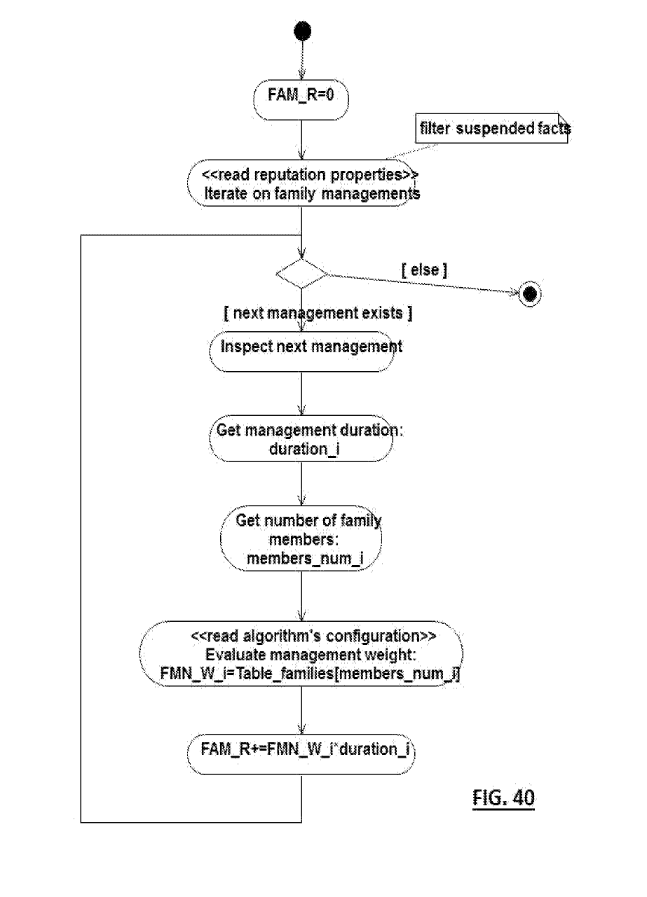

This rating is based on the weights assigned to the facts (valid or certified, not suspended) fetched from the individual job experiences:
employments (ref subactivity diagram “Individual—Evaluate job rating—Evaluate employments”, FIG. 34);
professional activities (ref subactivity diagram “Individual—Evaluate job rating—Evaluate professionals”, FIG. 36);
businesses (ref. subactivity diagram “Individual—Evaluate job rating—Evaluate businesses”, FIG. 38);
family management (ref subactivity diagram “Individual—Evaluate job rating—Evaluate family management”, FIG. 40).

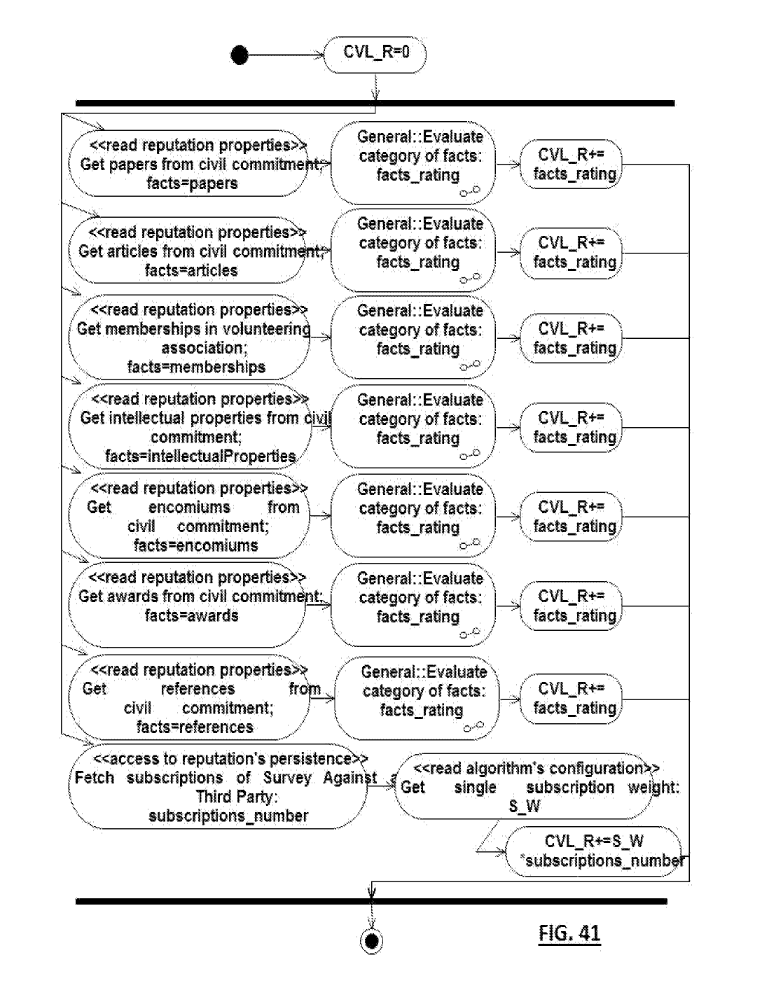

The contribution of the civil commitment's facts is also evaluated (ref. subactivity diagram “Evaluate job rating—Evaluate civil commitment”, FIG. 41) and added.

The flow chart starts with the analysis of the carrier history, determining the age of the first experience (init_age), the carrier duration (total_duration) and the durations of experiences with specific qualification (Table_durations is the table of these durations indexed by the qualifications). The weight INI_W of the first experience is evaluated through the table of initial ages (Table_init_ages) below

| Age (range) | Weight |
|---|---|
| m1-M1 | INI_W1 |
| m2-M2 | INI_W2 |
| m3-M3 | INI_W3 |
| . . . | |

Then, the job qualifications assumed during the carrier are evaluated.

Finally, all the contributions of the job experiences are summed.

### 5.29. Individual—Evaluate Job Rating—Evaluate Carrier History Diagram

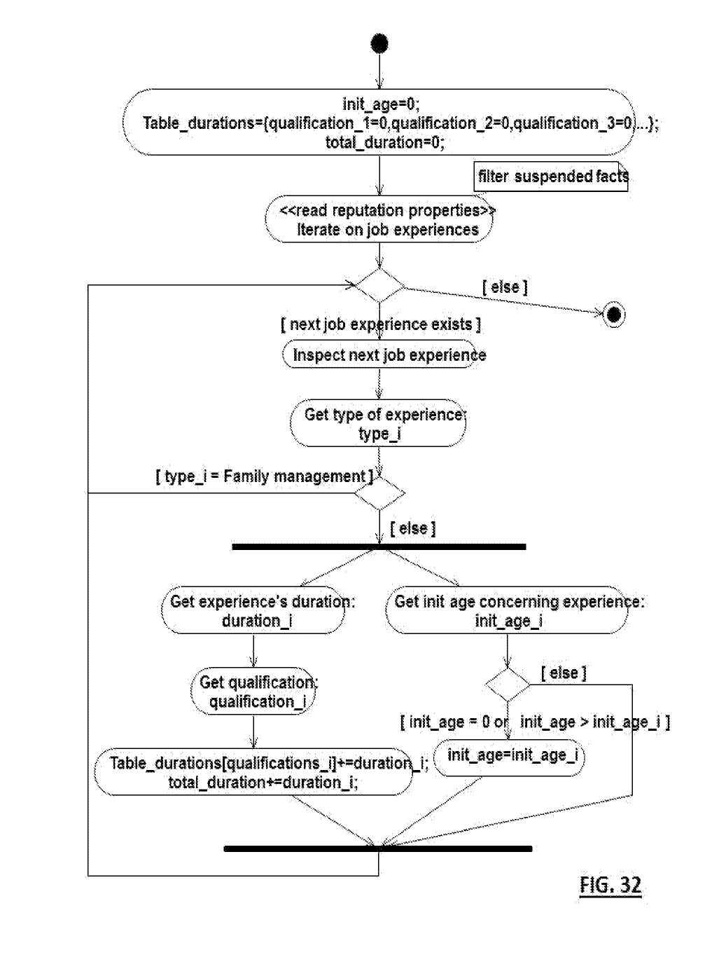

FIG. 32 shows a flow chart of actions for determining the carrier history of individuals.

It determines the age of the first experience (init age), the carrier duration (total_duration) and the durations of job experiences with specific qualification (Table_durations is the table of these durations indexed by the qualifications).

Qualifications are determined through the Job qualification associated to the Employments, through the Type of professional associated to the Professional activities and through the Type of business associated to the Businesses.

### 5.30. Individual—Evaluate Job Rating—Evaluate Qualifications Diagram

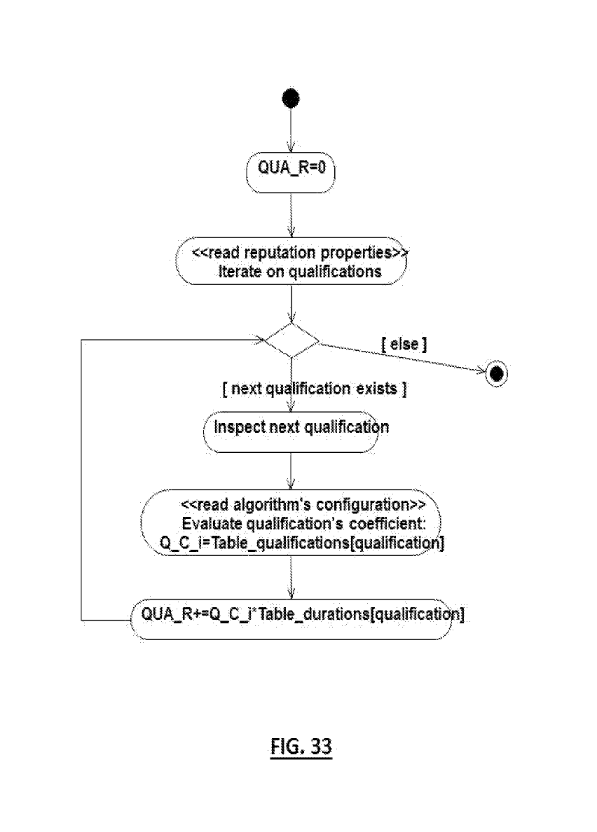

FIG. 33 shows a flow chart of actions for determining the rating (QUA_R) related to the job qualifications. It's a subactivity of “Individual—Evaluate job rating” diagram.

For each job qualification assumed during the carrier, the related duration (previously calculated) is multiplied by a coefficient Q_C evaluated through the table of qualifications (Table_qualifications) below

| Qualification | Coefficient |
|---|---|
| type1 | Q_C1 |
| type2 | Q_C2 |
| type3 | Q_C3 |
| . . . | |

### 5.31. Individual—Evaluate Job Rating—Evaluate Employments Diagram

FIG. 34 shows a flow chart of actions for determining the contribution (EMP_R) to the job rating of individuals related to employments.

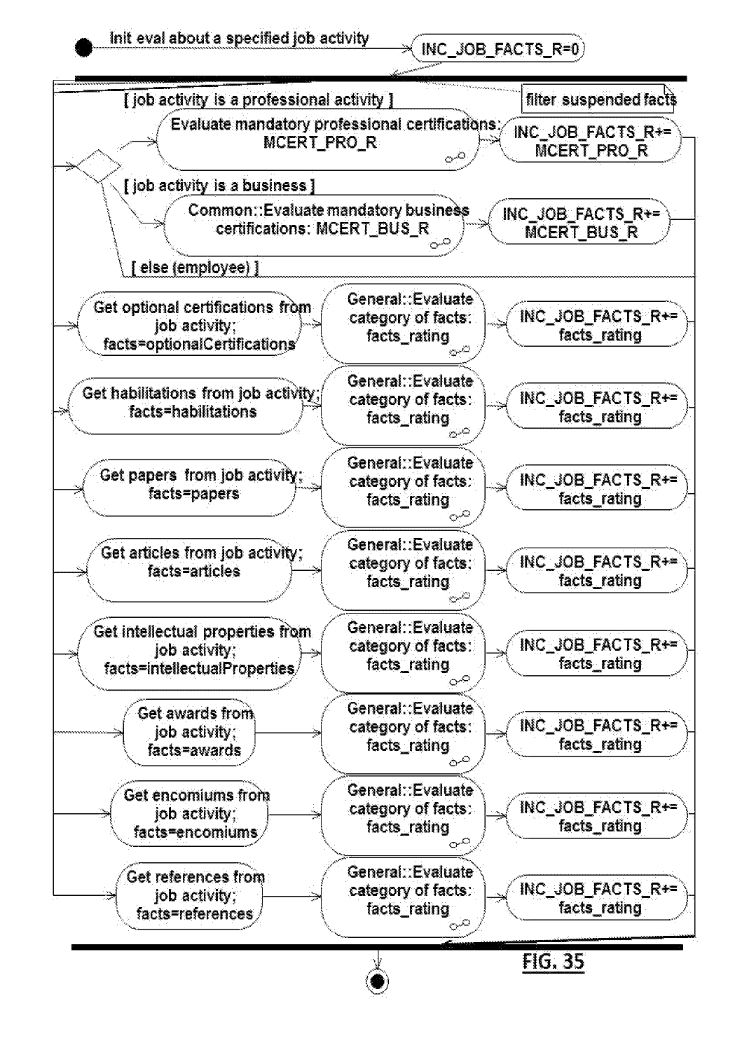

This contribution considers the mobility weight MOB_W, the contributions of all included facts in every employment (ref subactivity diagram “Individual—Evaluate job rating—Evaluate facts included in employment, prof activity or business”, FIG. 35) and the incomes from recent employments.

The coefficient of mobility MOB_W is calculated considering the average duration divided by the duration of the carrier history. Then it is used to evaluate the resulting weight through the table of mobilities (Table_mobilities) below

| Range of mobility values | Weight |
|---|---|
| m1-M1 | MOB_W1 |
| m2-M2 | MOB_W2 |
| m3-M3 | MOB_W3 |
| . . . | |

### 5.32. Individual—Evaluate Job Rating—Evaluate Facts Included in Employment, Prof Activity or Business Diagram

FIG. 35 shows a flow chart of actions for determining the contribution (INC_JOB_FACTS_R) to the job rating of all the facts (valid or certified, not suspended) included in an employment or professional activity or business for individuals.

These facts are the mandatory and optional certifications, habilitations, papers, articles, intellectual properties, awards, encomiums and references published through the surveys pro oneself

### 5.33. Individual—Evaluate Job Rating—Evaluate Professional Activities Diagram

FIG. 36 shows a flow chart of actions for determining the contribution (PRO_R) to the job rating of individuals related to professional activities.

It considers the contributions of all included facts in every activity (ref subactivity diagram “Individual—Evaluate job rating—Evaluate facts included in employment, prof activity or business”, FIG. 35) and the revenues from recent activities.

### 5.34. Individual—Evaluate Job Rating—Evaluate Mandatory Certifications for Professional Activity Diagram

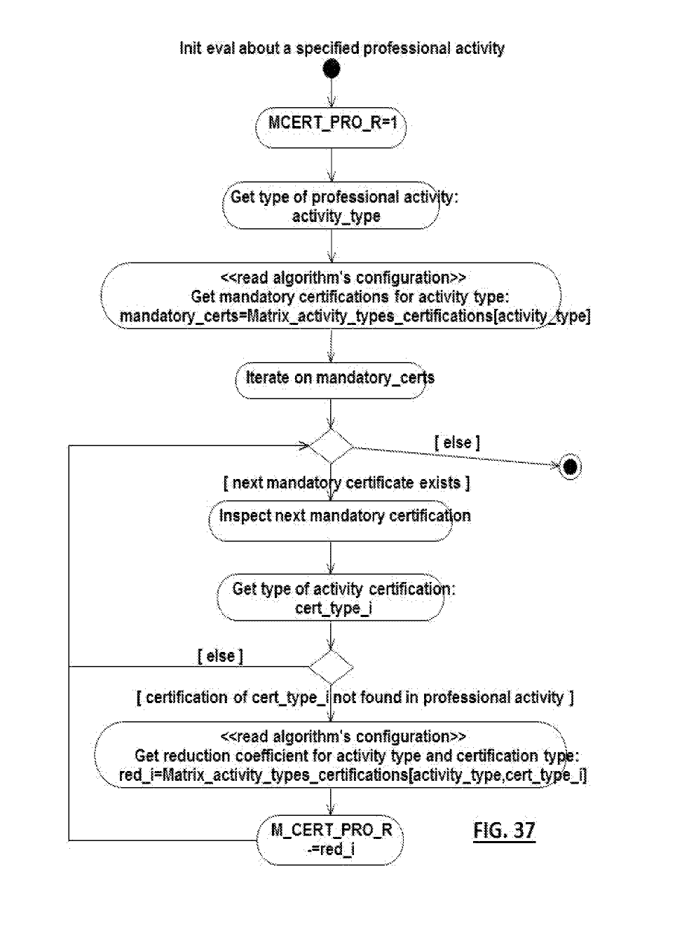

FIG. 37 shows a flow chart of actions for determining the contribution (MCERT_PRO_W) to the job rating related to the mandatory certifications for a specified professional activity.

When a mandatory certification is not included in the reputational profile, a reduction coefficient must be applied to the overall job rating.

The reduction coefficients depend on the type of professional activity and on the type of certification not found. They are evaluated through the matrix activity types/certifications (Matrix_activity_types_certifications) below

Certification

| Activity type | cert1 | cert2 | cert3 | . . . |
|---|---|---|---|---|
| activity1 | R11 | R12 | R13 | . . . |
| activity2 | R21 | R22 | R23 | . . . |
| activity3 | R31 | R32 | R33 | . . . |
| . . . | | | | |

### 5.35. Individual—Evaluate Job Rating—Evaluate Businesses Diagram

FIG. 38 shows a flow chart of actions for determining the contribution (BUS_R) to the job rating of individuals related to businesses.

The flow considers the contributions of all included facts in every business (ref. subactivity diagram “Individual—Evaluate job rating—Evaluate facts included in employment, prof activity or business”, FIG. 35) and the revenues from recent businesses.

### 5.36. Evaluate Job Rating—Evaluate Mandatory Certifications for Business Diagram

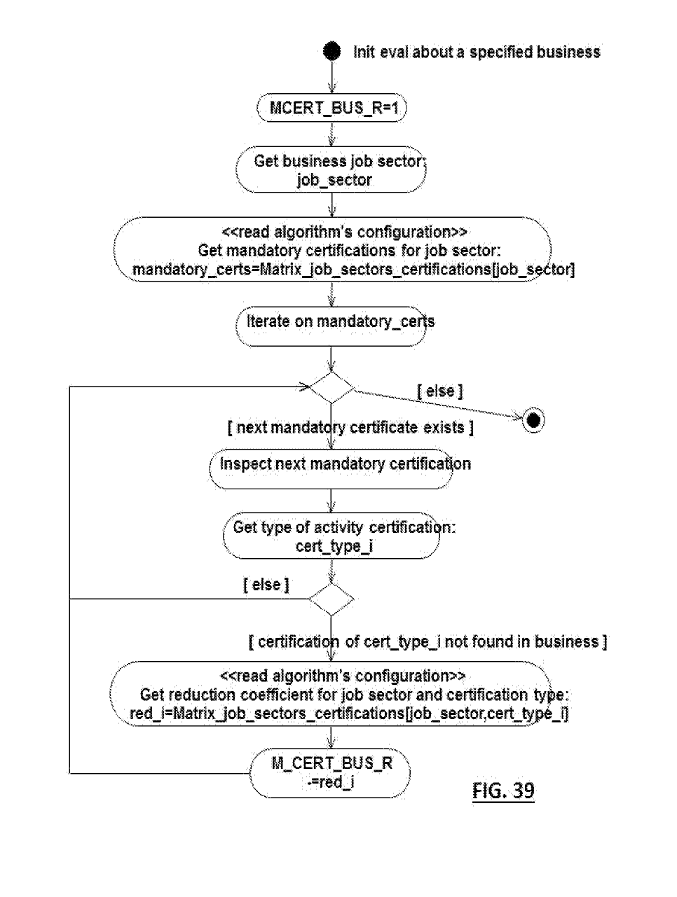

FIG. 39 shows a flow chart of actions for determining the contribution (MCERT_BUS_R) to the job rating related to the mandatory certifications for a specified business.

When a mandatory certification is not included in the reputational profile, a reduction coefficient must be applied to the overall job rating.

The reduction coefficients depend on the job sector and on the type of certification not found. They are evaluated through the matrix job sectors/certifications (Matrix_job_sectors_certifications) below

Certification

| Job sector | cert1 | cert2 | cert3 | . . . |
|---|---|---|---|---|
| sector1 | R11 | R12 | R13 | . . . |
| sector2 | R21 | R22 | R23 | . . . |
| sector3 | R31 | R32 | R33 | . . . |
| . . . | | | | |

### 5.37. Individual—Evaluate Job Rating—Evaluate Family Management Diagram

FIG. 40 shows a flow chart of actions for determining the rating (FAM_R) related to activities of family management.

These experiences are analyzed considering the duration and the number of family members; the weight FMN_W related to the family composition is evaluated through the table (Table_families) below

| Number of members | Weight |
|---|---|
| 1 | FMN_W1 |
| 2 | FMN_W2 |
| 3 | FMN_W3 |
| . . . | |

### 5.38. Evaluate Job Rating—Evaluate Civil Commitment Diagram

FIG. 41 shows a flow chart of actions for determining the rating (CIV_R) related to the civil commitment of individuals and legal persons (private or public).

This rating is evaluated as the sum of contributions related to papers, articles, memberships in volunteering association, intellectual properties, encomiums, awards (for civic value), references and the number of subscriptions to the surveys of Mevaluate (each one multiplied by a coefficient S_W).

### 5.39. Private Legal Person—Evaluate Company's Job Rating Diagram

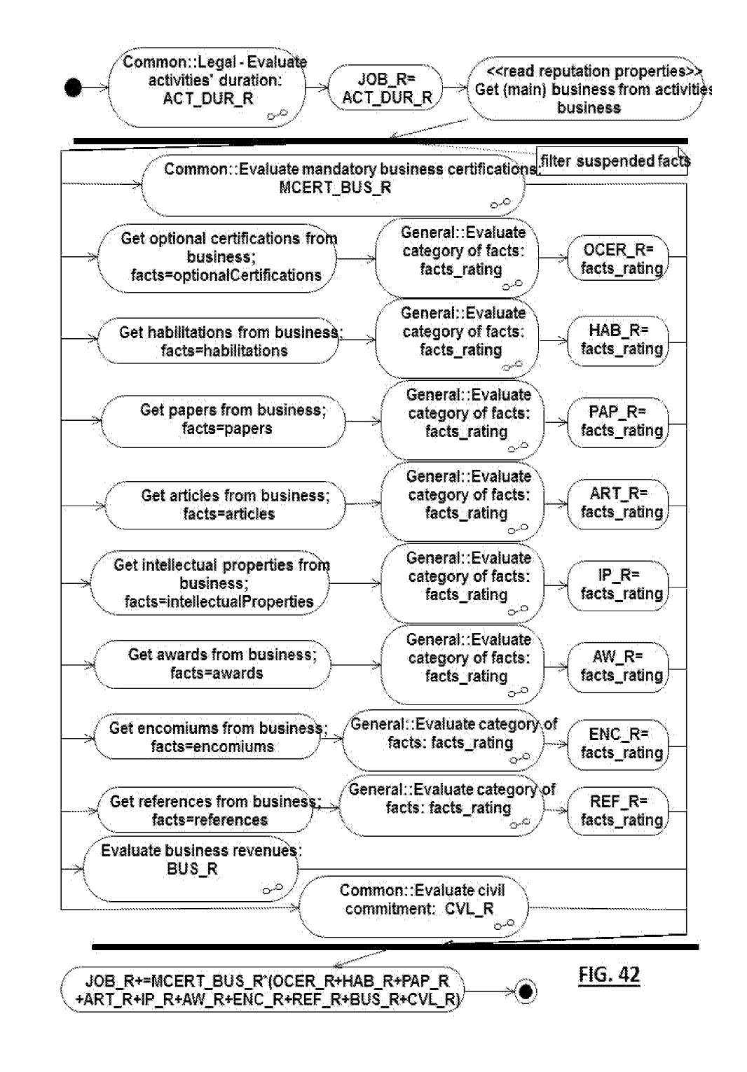

FIG. 42 shows a flow chart of actions for determining the job rating (JOB_R) of a company.

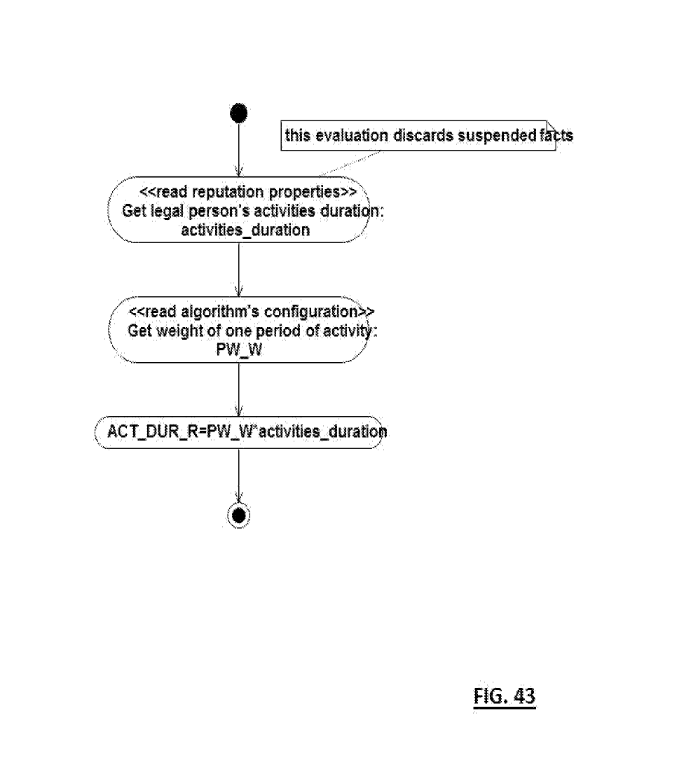

This rating is based on the weights assigned to the duration of the activities (ref. subactivity diagram “Legal person—Evaluate job rating—Evaluate activities' duration”, FIG. 43) and to the facts (valid or certified, not suspended) fetched from the business (wrapped in the job activities) with related mandatory certifications (ref subactivity diagram “Evaluate job rating—Evaluate mandatory certifications for business”, FIG. 39) and optional certifications, habilitations, papers, articles, intellectual properties, awards, encomiums and references published through the surveys pro oneself.

The contribution of the civil commitment's facts is also evaluated (ref. subactivity diagram “Evaluate job rating—Evaluate civil commitment”, FIG. 41) and added.

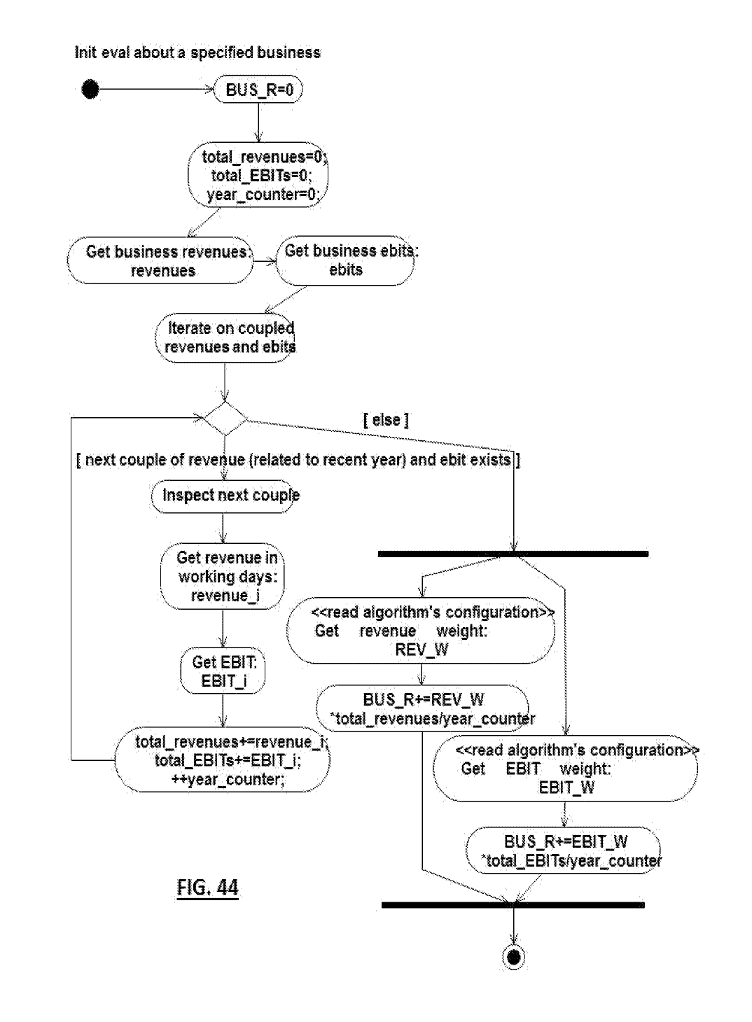

The revenues are evaluated as described in the subactivity diagram “Evaluate job rating—Evaluate business revenues” (FIG. 44).

### 5.40. Legal Person—Evaluate Job Rating—Evaluate Activities' Duration Diagram

FIG. 43 shows a flow chart of actions for determining the contribution to the job rating (ACT_DUR_R) related to the duration of the job activities of legal persons (private or public).

This contribution is multiplied by the coefficient PW_W.

### 5.41. Evaluate Job Rating—Evaluate Business Revenues Diagram

FIG. 44 shows a flow chart of actions for determining the rating (BUS_R) related to a specified business.

The recent revenues and ebits of the business are analyzed to calculate the revenues' average and the EBITs' average.

The revenues' average is multiplied by the coefficient REV_W and the EBITs' average is multiplied by the coefficient EBIT_W.

### 5.42. Private Legal Person—Evaluate Private Institution's Job Rating Diagram

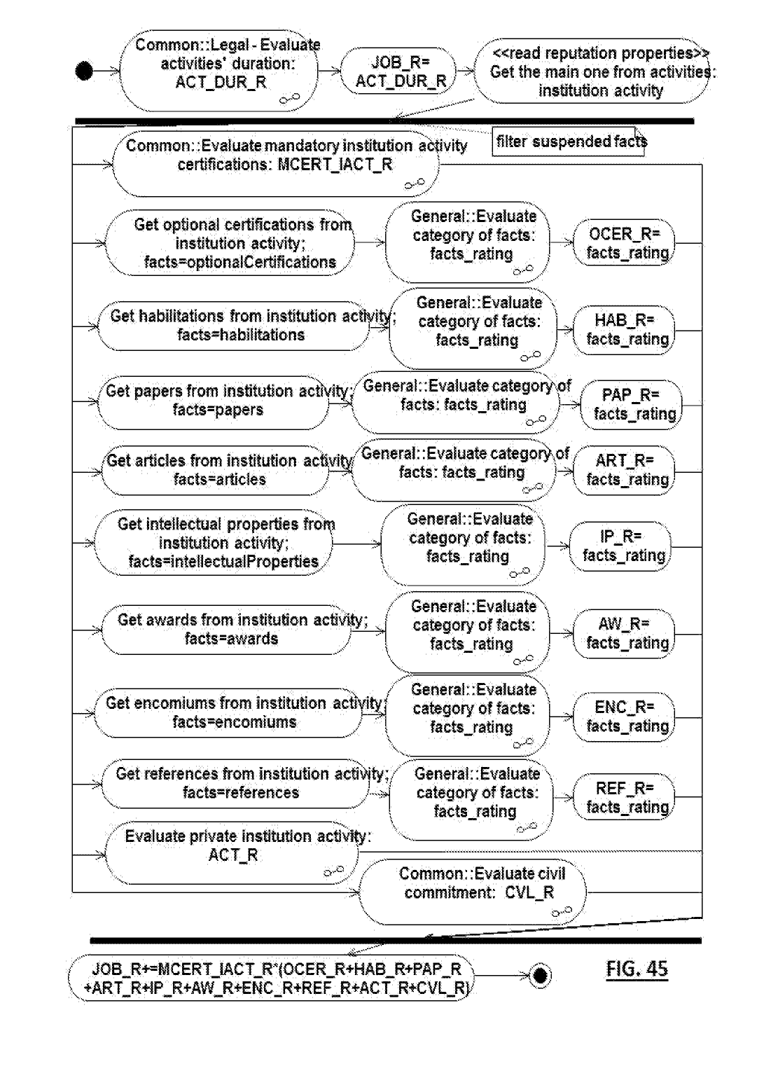

FIG. 45 shows a flow chart of actions for determining the job rating (JOB_R) of a private institution.

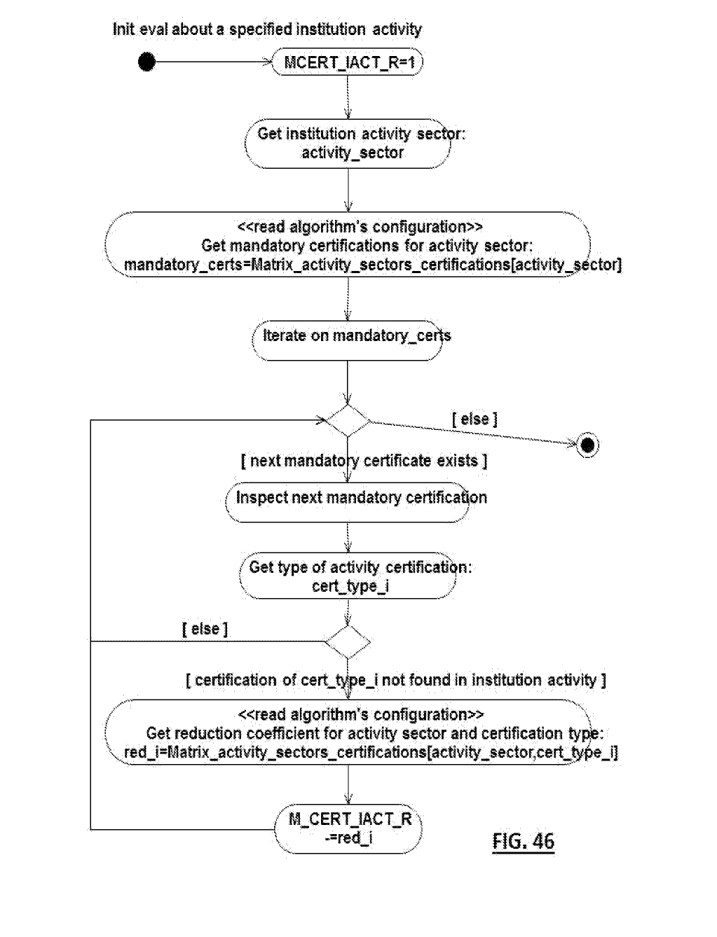

This rating is based on the weights assigned to the duration of the activities (ref. subactivity diagram “Legal person—Evaluate job rating—Evaluate activities' duration”, FIG. 43) and to the facts (valid or certified, not suspended) fetched from the main activity (wrapped in the job activities) with related mandatory certifications (ref subactivity diagram “Evaluate job rating—Evaluate mandatory certifications for institution activity”, FIG. 46) and optional certifications, habilitations, papers, articles, intellectual properties, awards, encomiums and references published through the surveys pro oneself.

The contribution of the civil commitment's facts is also evaluated (ref subactivity diagram “Evaluate job rating—Evaluate civil commitment”, FIG. 41) and added.

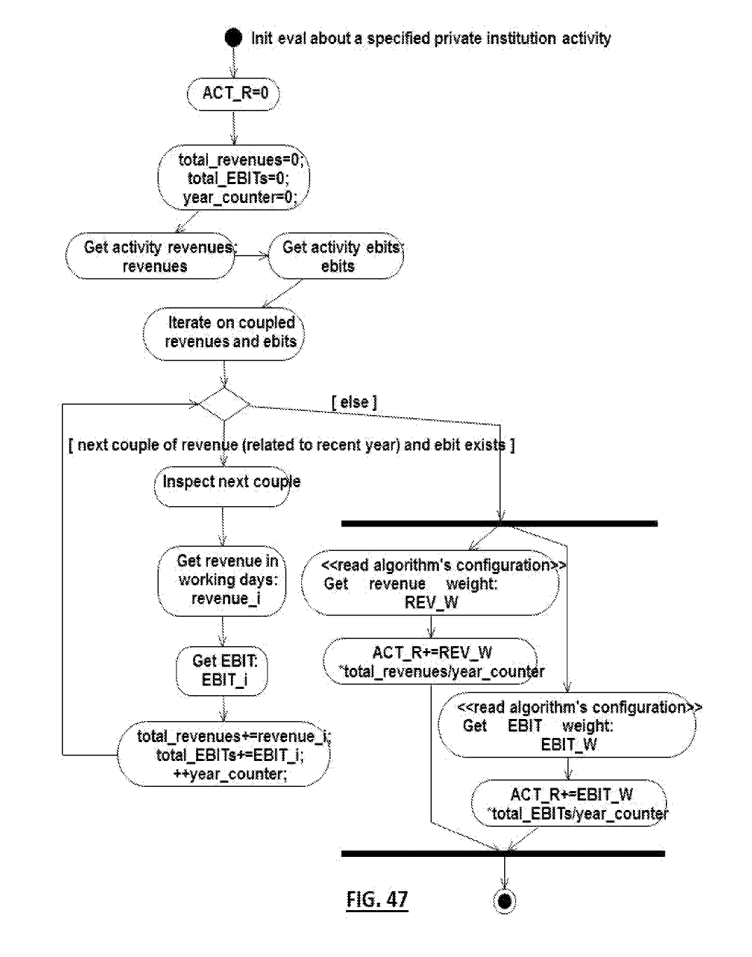

The revenues are evaluated as described in the subactivity diagram “Private legal person—Evaluate job rating—Evaluate institution activity revenues” (FIG. 47).

5.43. Evaluate Job Rating—Evaluate Mandatory Certifications for Institution activity Diagram

FIG. 46 shows a flow chart of actions for determining the contribution (MCERT_IACT_R) to the job rating related to the mandatory certifications for a specified institution activity.

When a mandatory certification is not included in the reputational profile, a reduction coefficient must be applied to the overall job rating.

The reduction coefficients depend on the activity sector and on the type of certification not found. They are evaluated through the matrix activity sectors/certifications (Matrix_activity_sectors_certifications) below

Certification

| Activity sector | cert1 | cert2 | cert3 | . . . |
|---|---|---|---|---|
| sector1 | R11 | R12 | R13 | . . . |
| sector2 | R21 | R22 | R23 | . . . |
| sector3 | R31 | R32 | R33 | . . . |
| . . . | | | | |

### 5.44. Private Legal Person—Evaluate Job Rating—Evaluate Institution Activity Revenues Diagram

FIG. 47 shows a flow chart of actions for determining the rating (ACT_R) related to a specified private institution activity.

The recent revenues and ebits of the activity are analyzed to calculate the revenues' average and the EBITs' average.

The revenues' average is multiplied by the coefficient REV_W and the EBITs' average is multiplied by the coefficient EBIT_W.

### 5.45. Public Legal Person—Evaluate Public Institution's Job Rating Diagram

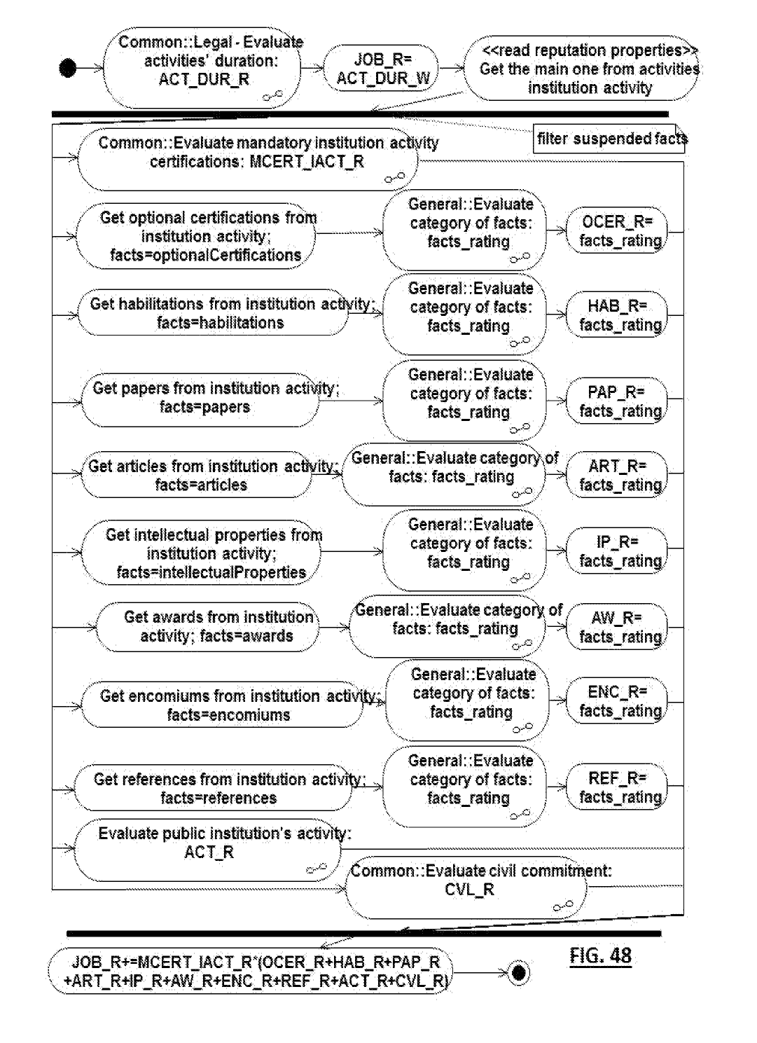

FIG. 48 shows a flow chart of actions for determining the job rating (JOB_R) of a public institution.

This rating is based on the weights assigned to the duration of the activities (ref. subactivity diagram “Legal person—Evaluate job rating—Evaluate activities' duration”, FIG. 43) and to the facts (valid or certified, not suspended) fetched from the main activity (wrapped in the job activities) with related mandatory certifications (ref. subactivity diagram “Evaluate job rating—Evaluate mandatory certifications for institution activity”, FIG. 46) and optional certifications, habilitations, papers, articles, intellectual properties, awards, encomiums and references published through the surveys pro oneself.

The contribution of the civil commitment's facts is also evaluated (ref. subactivity diagram “Evaluate job rating—Evaluate civil commitment”, FIG. 41) and added.

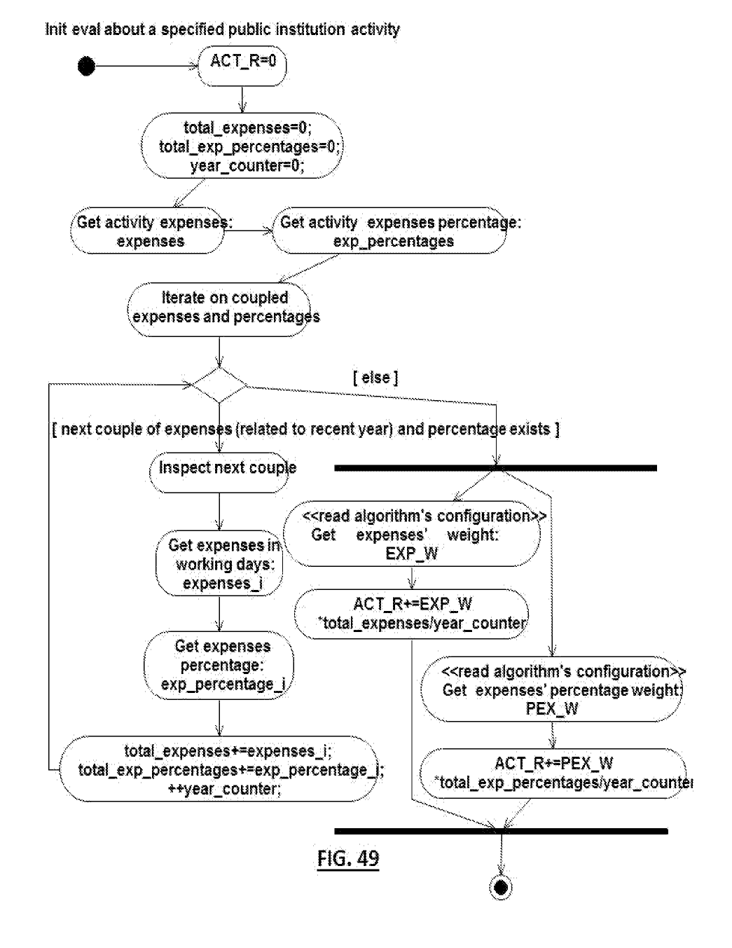

The expenses are evaluated as described in the subactivity diagram “Public legal person—Evaluate job rating—Evaluate institution activity expenses” (FIG. 49).

### 5.46. Public Legal Person—Evaluate Job Rating—Evaluate Institution Activity Expenses Diagram

FIG. 49 shows a flow chart of actions for determining the rating (ACT_R) related to a specified public institution activity.

The recent expenses and related percentages of the activity are analyzed to calculate the expenses' average and the percentages' average.

The expenses' average is multiplied by the coefficient EXP_W and the percentages' average is multiplied by the coefficient PEX_W.

### 6. Class Diagrams

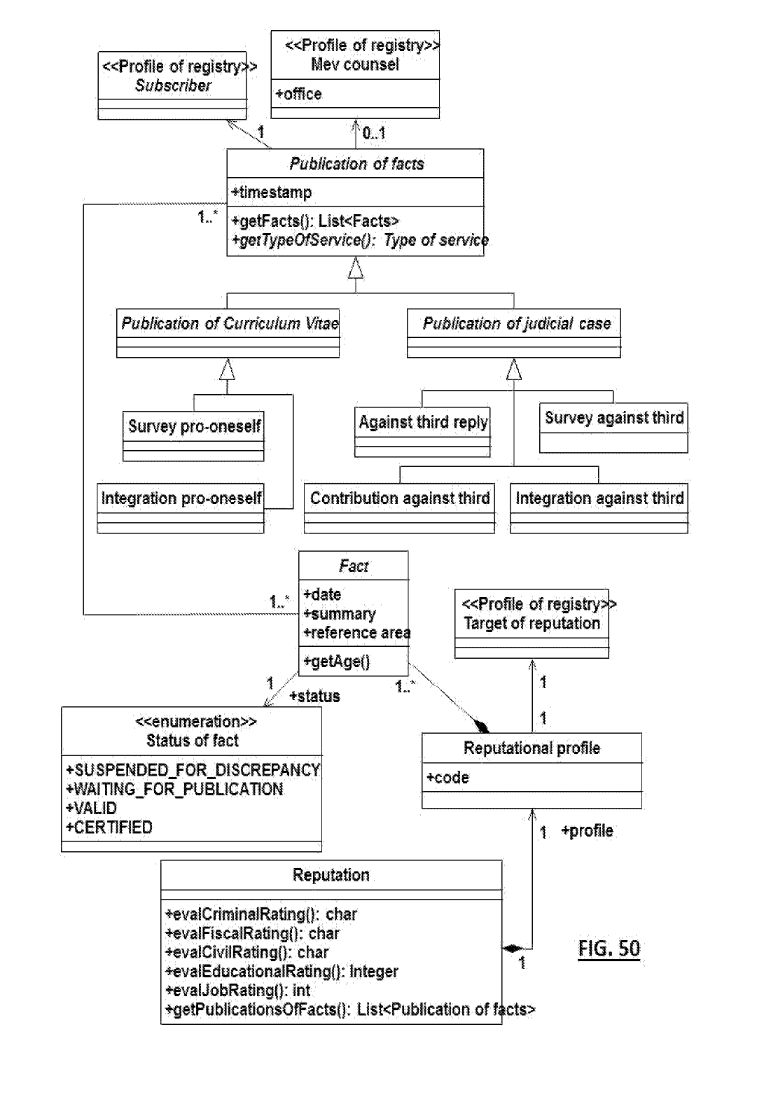

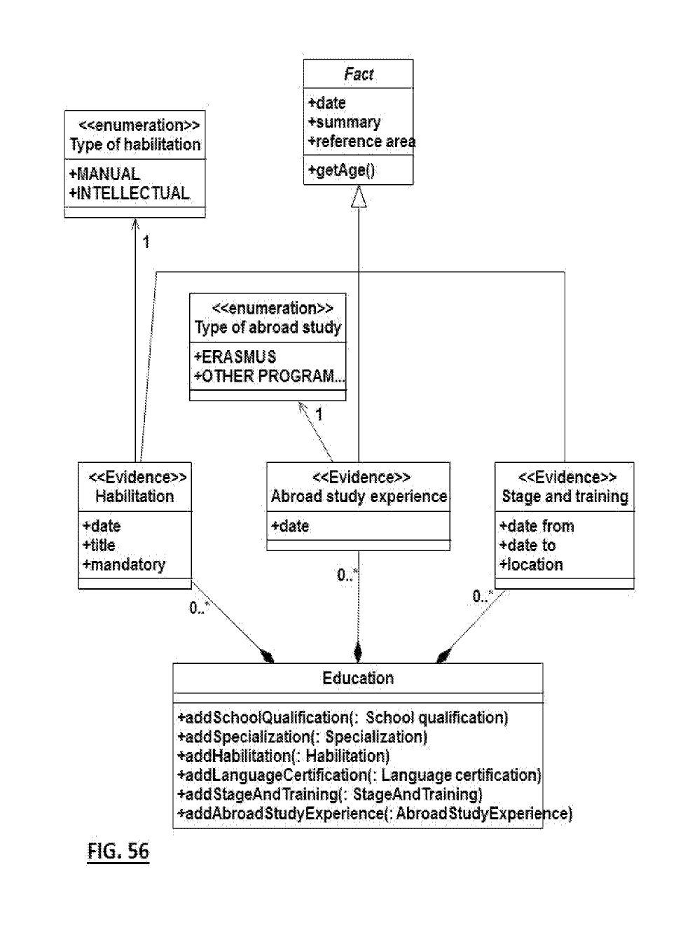

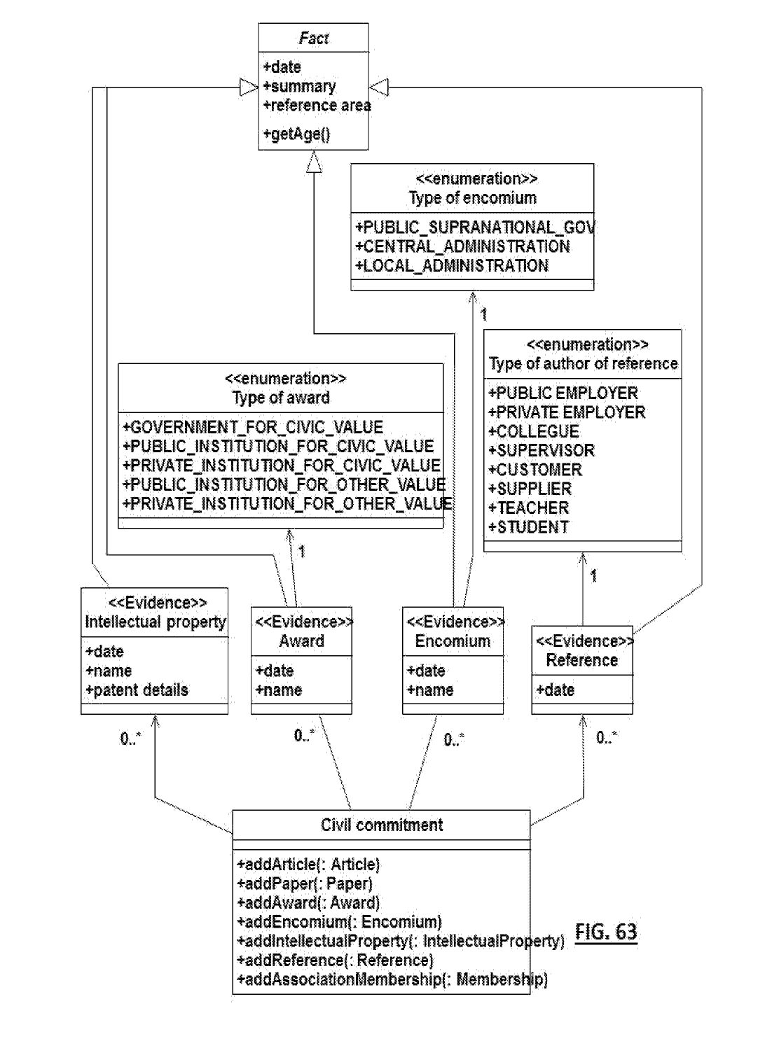

With reference to FIGS. 50 to 71, in the following it is described the logic structure of the data model about the reputational profile defined through composition and structure of class diagrams relating to the method for the determination of the parameters of reputational rating of natural and legal persons subject of the invention. The blocks of the diagrams include a definition of the meaning of the relating object or term used for describing the class and an enumeration of types of information added therein.

### 6. 1. Reputation Diagram

FIG. 50 shows the composition of a reputational profile of a person and its relationships with the surveys.

The reputational profile of a subject (target of reputation) is composed of a set of facts; each of them is supported by documented evidences.

Facts are collected through the publication of surveys.

There are two types of publications:

1. about the curriculum vitae of a person (made by the person itself, target of reputation—generally are facts pro-oneself—);

2. about judicial case (only one process or accusation for publication) (made by another person—generally are facts against—or by the target of reputation as reply to previous publication).

If the publication of a survey is done with the help of a counsel, then each published Fact is certified. This doesn't modify the ratings, but it is a warranty of the correctness of the information.

### 6.2. Profile of Registry Diagram

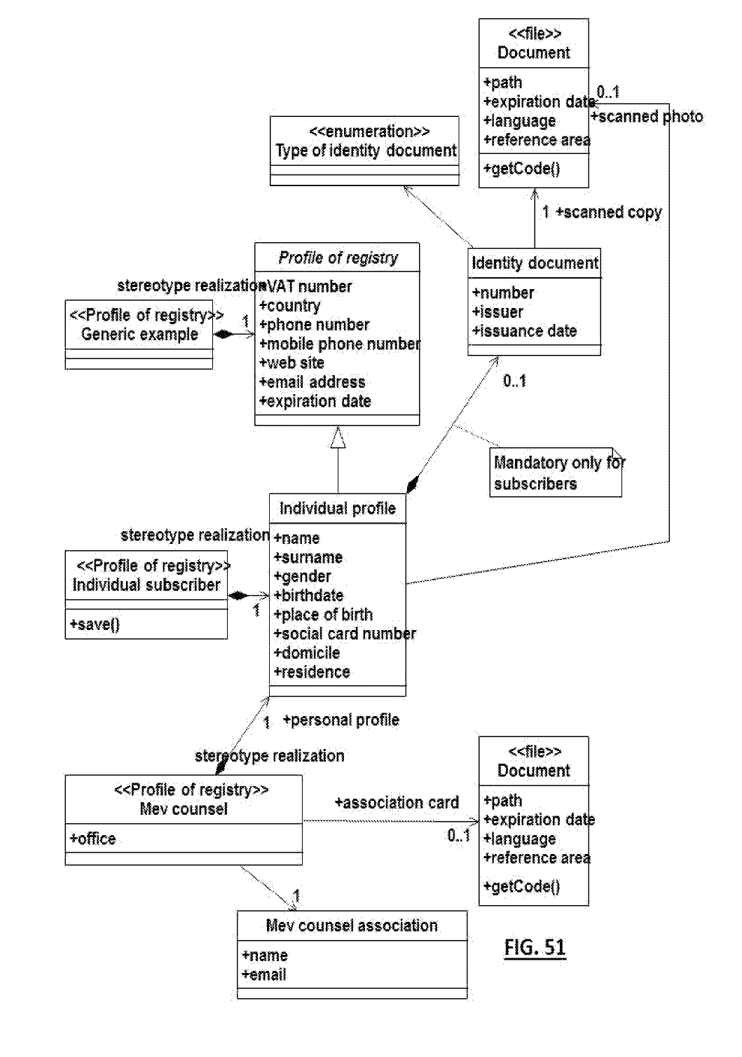

FIG. 51, 52 show the stereotype ‘Profile of registry’.

Every class tagged with this stereotype is associated to a profile of registry.

There are two specific profiles:

1—individual (described in the FIG. 51);

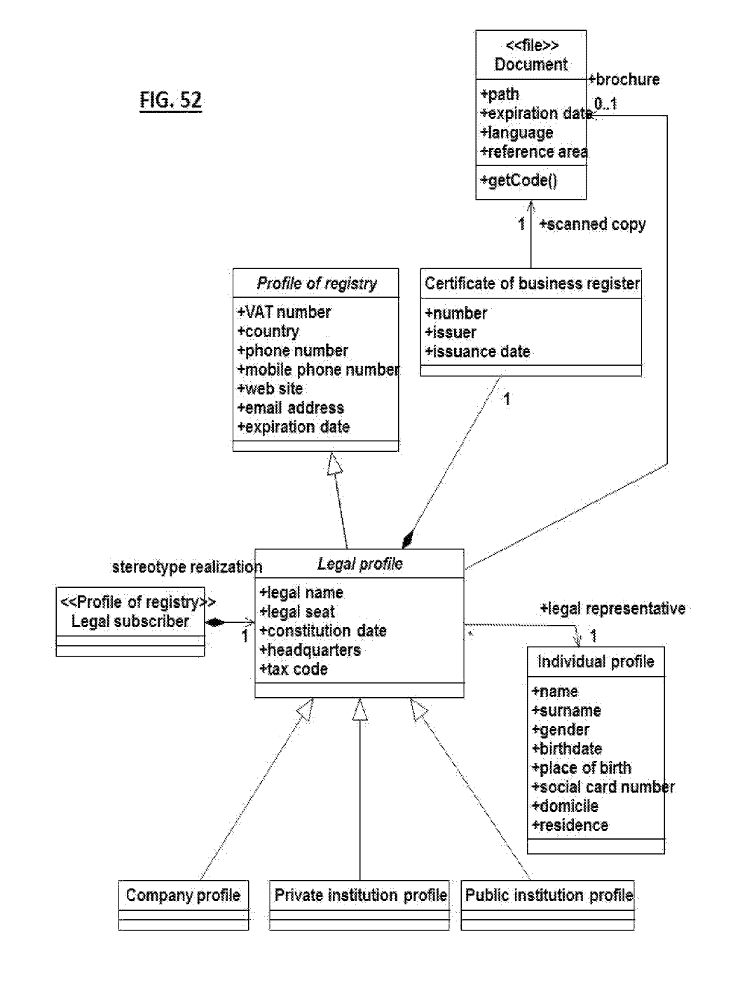

2—legal person (described in the FIG. 52).

Legal persons may be public (public institutions) or private (companies or private institutions).

The classes ‘Individual subscriber’, ‘Legal subscriber’ and ‘Lawyer’ are some examples of the stereotype's realization.

Finally, every class tagged with this stereotype is persistent.

### 6.3. Evidence and Money in Work Days Diagram

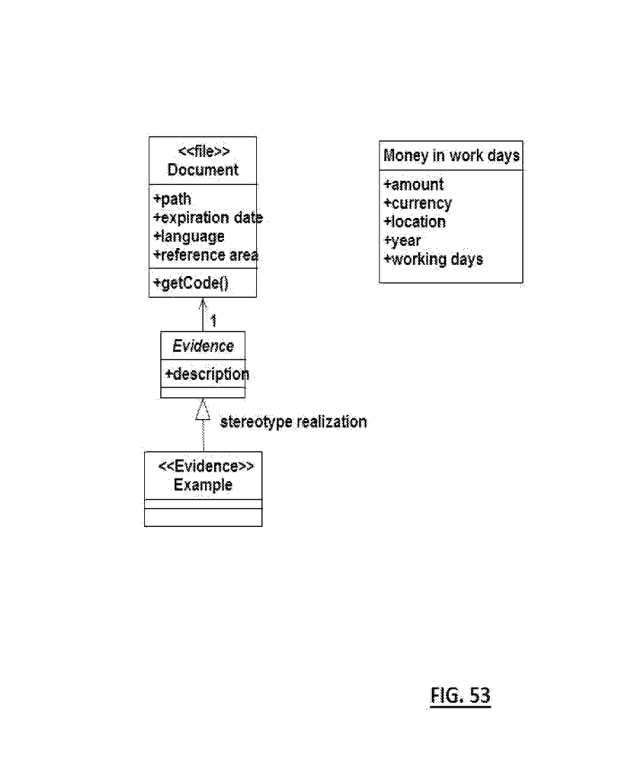

FIG. 53 shows common classes and interfaces.

On the left side is defined the stereotype ‘Evidence’.

Every class tagged with this stereotype is associated to a document attached as a digital evidence of a fact.

Every evidence contributes to the reputational rating.

Finally, every class tagged with this stereotype is persistent.

On the right side is defined the class ‘Money in working days’, applied for every amount of money included in the Facts of the Reputational profile.

### 6.4. Curriculum Vitae Diagram

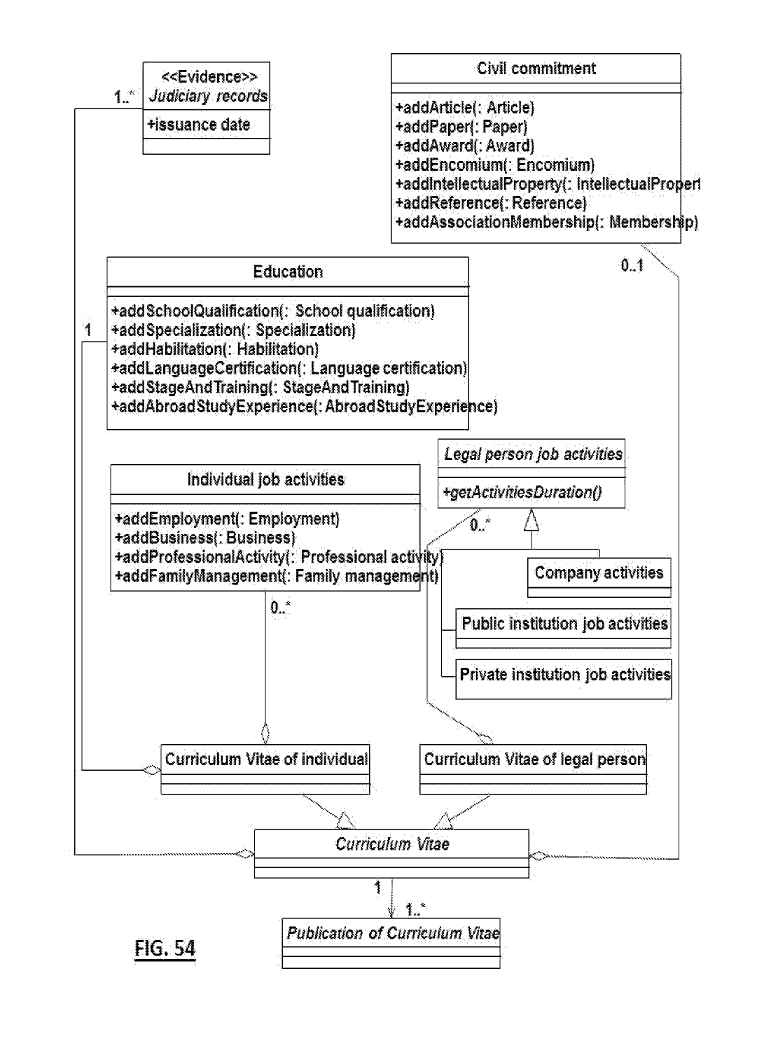

FIG. 54 shows the composition of the Curriculum Vitae of a person.

The CV differs for individuals and legal persons.

For individuals there are four main sections:
judiciary records;
education;
job;
civil commitment (articles, papers, awards, references, . . . ).

For legal persons there are three main sections:
judiciary records;
job;
civil commitment (articles, papers, awards, references, . . . ).

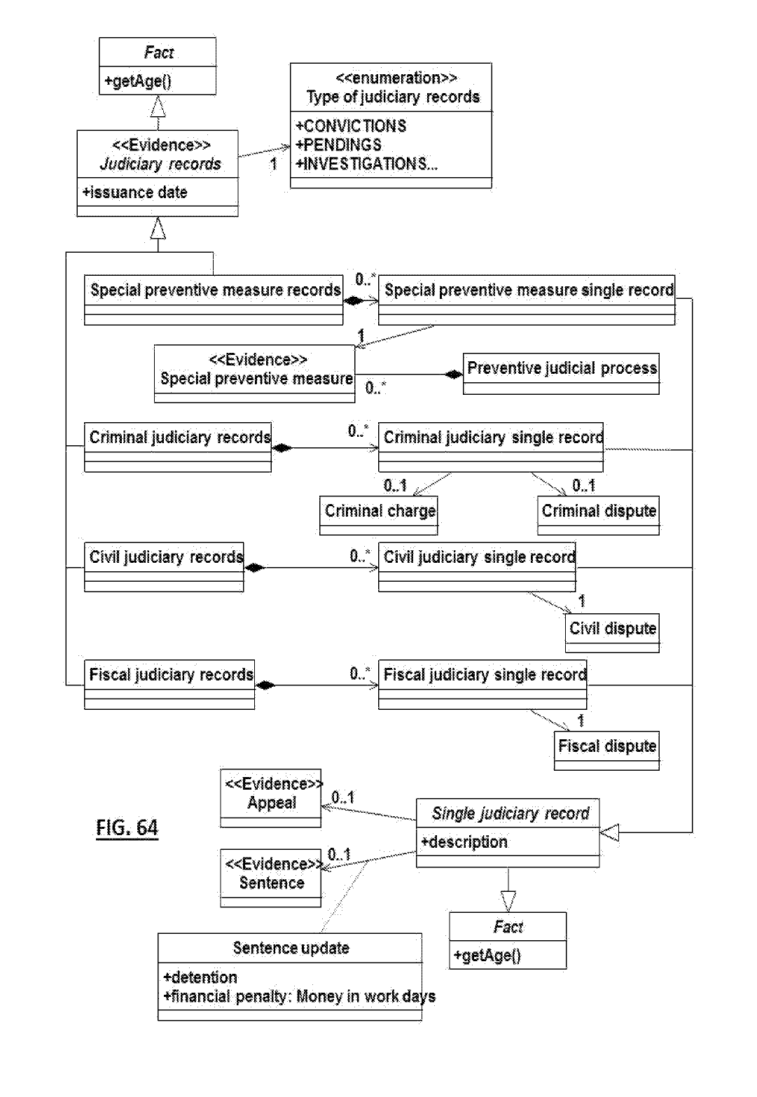

As explained in the ‘Judicial data’ class diagram (FIG. 64) and in the ‘Judicial cases’ class diagram

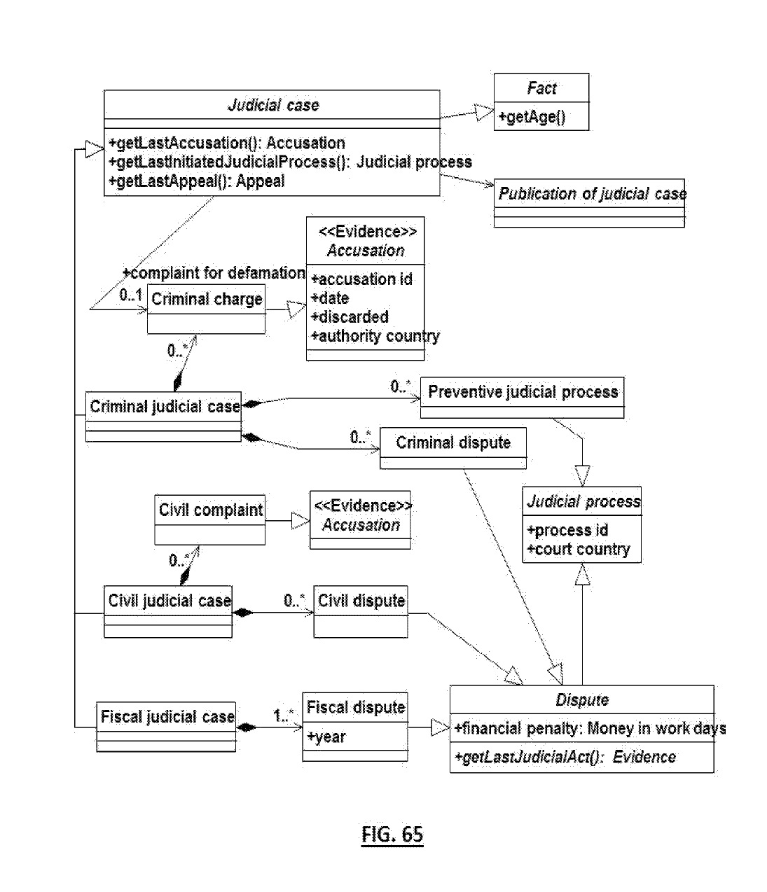

(FIG. 65), there are two ways to retrieve information about the judicial status of a person: through the judiciary records that must be included in the curriculum published with the survey pro or through the judicial cases directly published with the survey against.

### 6.5. Education Diagram

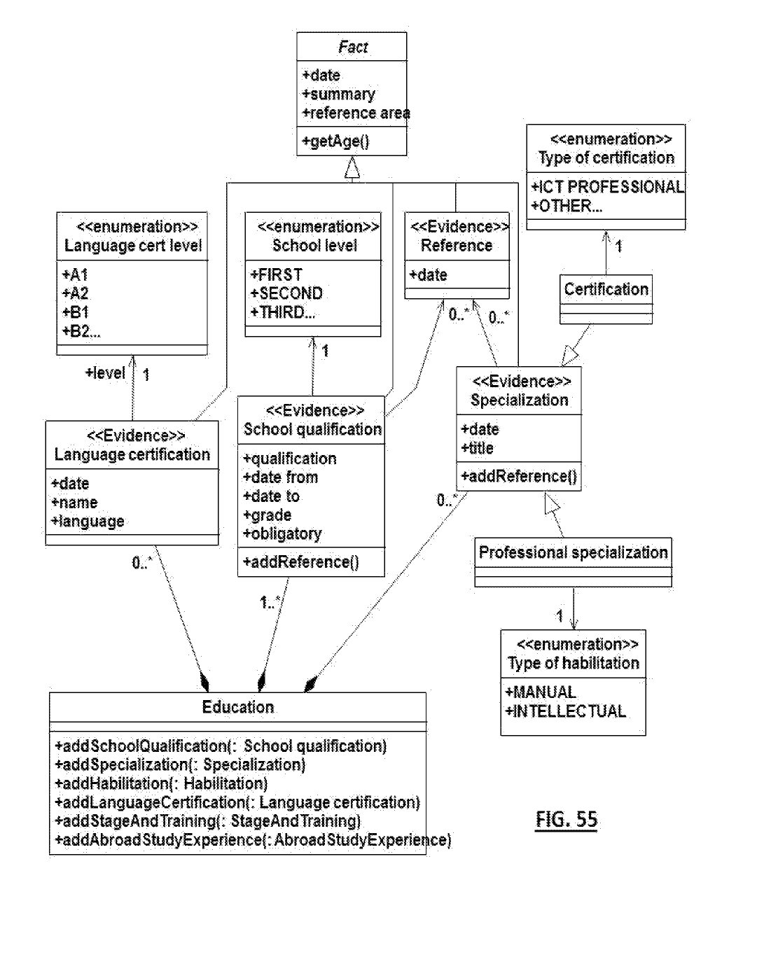

FIG. 55, 56 show the composition of the facts related to the education of an individual, target of reputation.

These facts are organized in the following sections:
school qualifications;
specializations;
habilitations (related to educational experiences);
language certifications about foreign languages;
stage and training experiences;
abroad study experiences.

### 6.6. Job Diagram

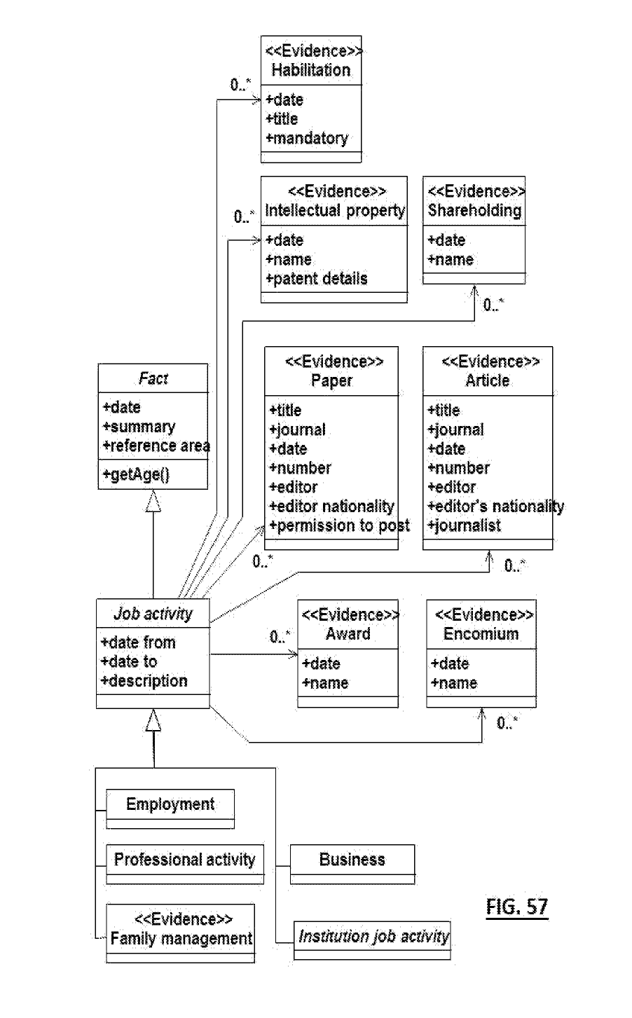

FIG. 57 shows a general overview of the job activities of individuals and legal persons.

Every job activity has a start date and optionally an end date and it is a fact that contributes to the reputation.

Habilitations, awards, encomiums, shareholdings, intellectual properties,... are evidences that may be related to every job activity; also, each experience may be associated to specific types of evidences (e.g. engagement letter for employment, financial statements for business, . . . ).

### 6.7. Job—Individual, Employment and Family Diagram

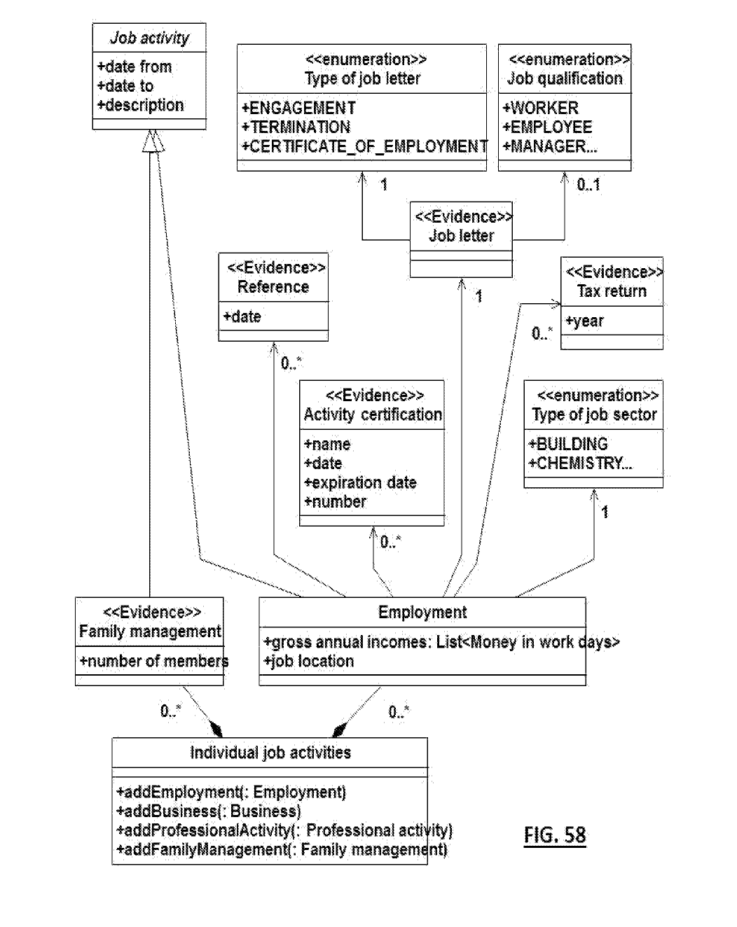

FIG. 58 shows the composition of the job experiences of individuals, focusing on the employments and family managements.

### 6.8. Job—Individual, Professional and Business Diagram

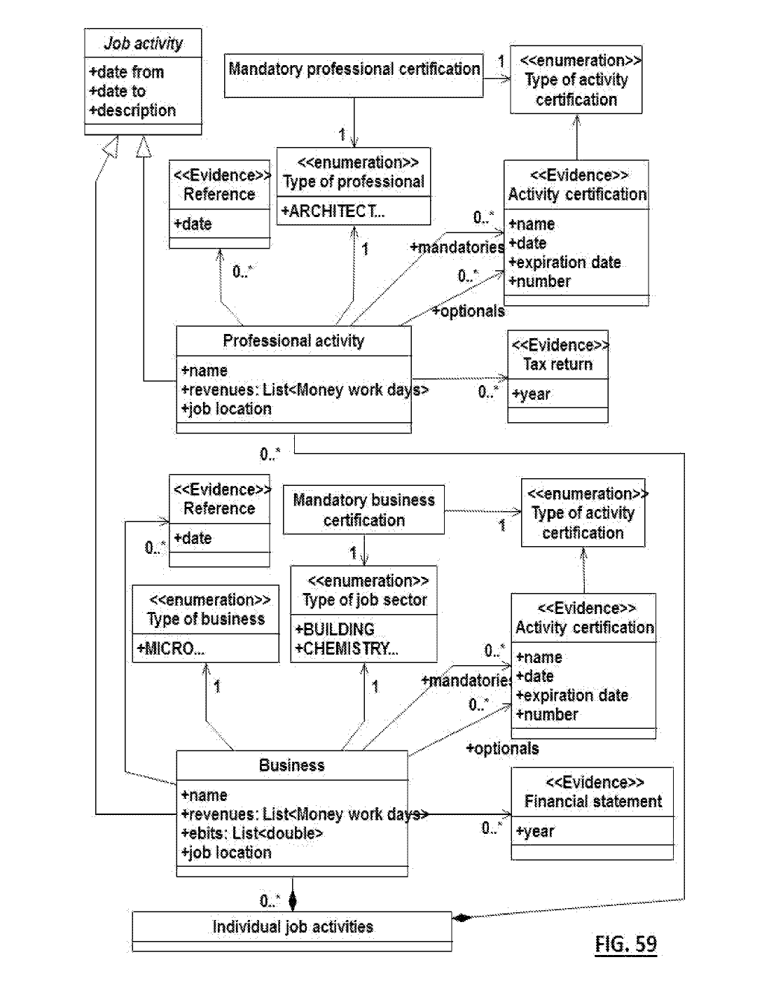

FIG. 59 shows the composition of the job experiences of individuals, focusing on the professional activities and businesses.

Some activity certifications are mandatories for certain types of professional activity or businesses in a job sector.

The names of these mandatory certifications are persisted in the system configuration.

### 6.9. Job—Company, Business Diagram

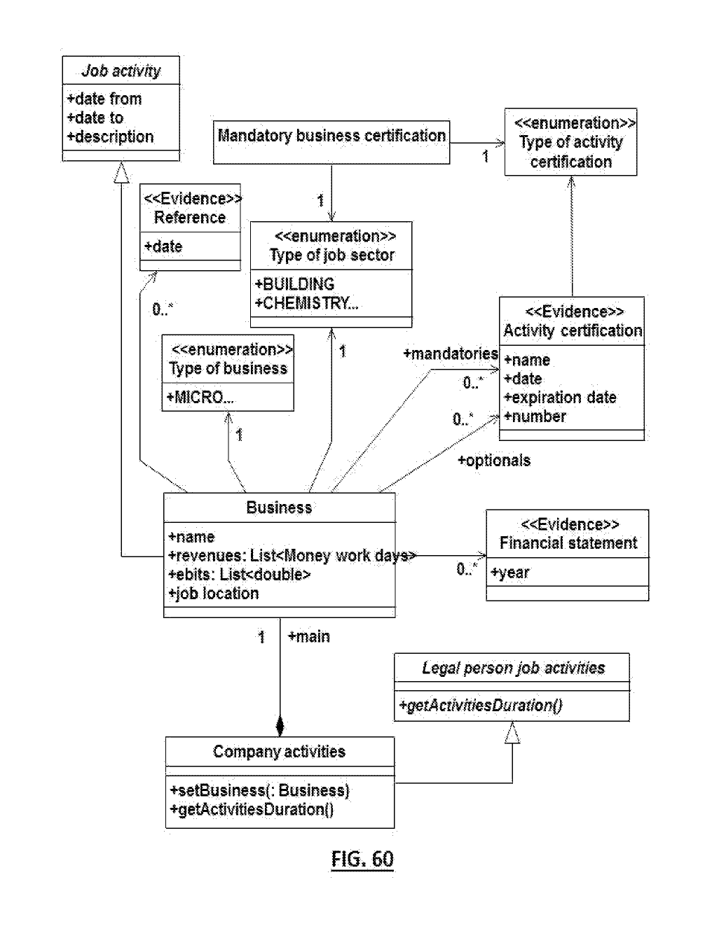

FIG. 60 shows the composition of the business activities of companies.

Some activity certifications are mandatories for businesses in a certain type of job sector.

The names of these mandatory certifications are persisted in the system configuration.

### 6.10. Job—Institutions, Activity Diagram

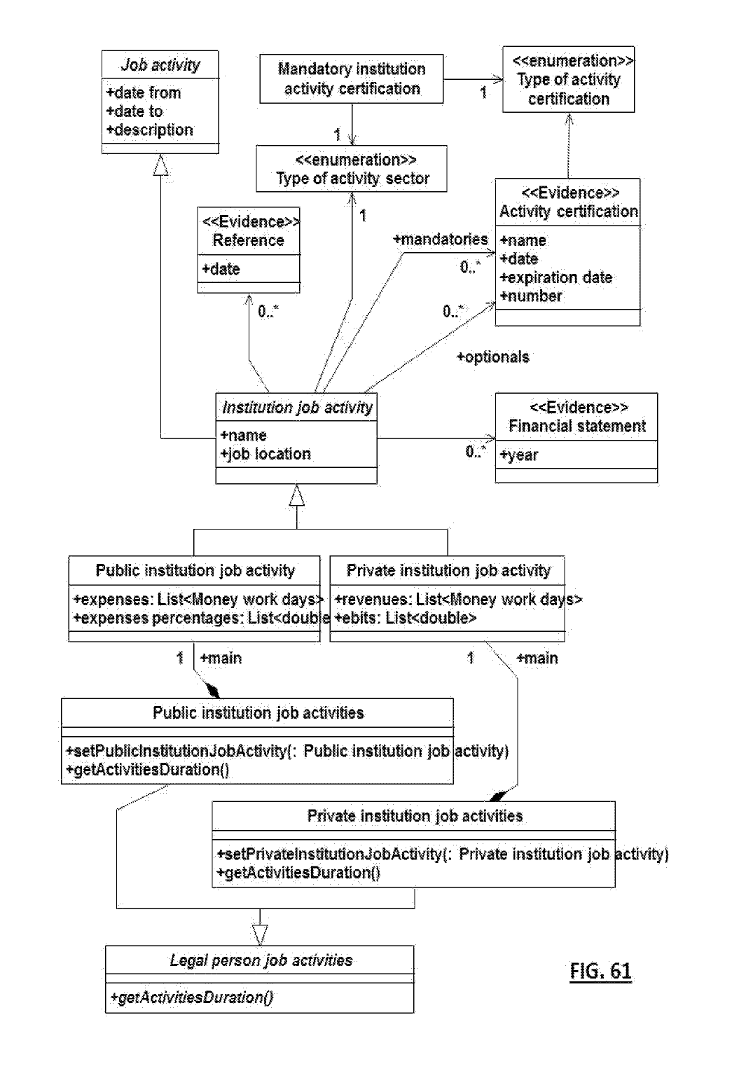

FIG. 61 shows the composition of the job activities of private and public institutions.

Some activity certifications are mandatories in a certain type of sector.

The names of these mandatory certifications are persisted in the system configuration.

### 6.11. Civil Commitment Diagram

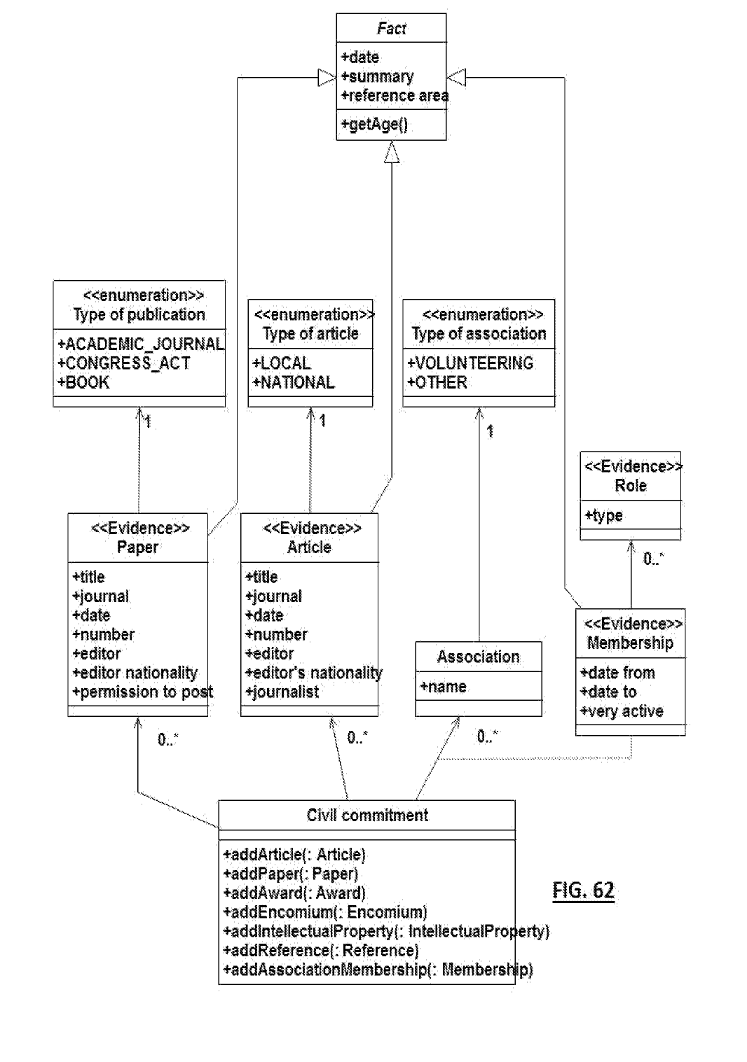

FIG. 62, 63 show the composition of the civil commitment information about an individual or a legal person.

The information comprises:
articles (about the person);
papers (written by the person);
awards and encomiums;
intellectual properties;
references;
memberships in associations (volunteering, . . . ).

### 6.12. Judicial Data Diagram

FIG. 64 shows the composition of the judiciary records of an individual or a legal person.

The judiciary records are data registered by judicial authorities about the judicial cases of a person.

They are distinct in four areas:

1. criminal judiciary records;

2. special preventive measure records (related to the criminal area);

3. fiscal judiciary records;

4. civil judiciary record.

Every single judiciary record refers to a Judicial process or an Accusation according to its type (ref. ‘Judicial cases’ class diagram, FIG. 65).

### 6.13. Judicial Cases Diagram

FIG. 65 shows a general overview of the judicial cases of individuals and legal persons.

Judicial cases are registered directly through the publication of a survey against.

Judicial cases are distinct in three different judiciary context: criminal, civil and fiscal.

Every types of judicial case are associated to specific Disputes (one for each stage of the case).

Only criminal and civil judicial case are associated to specific Accusations that start the case.

Criminal judicial cases are also associated to Preventive judicial processes.

### 6.14. Judicial Cases—Criminal Diagram

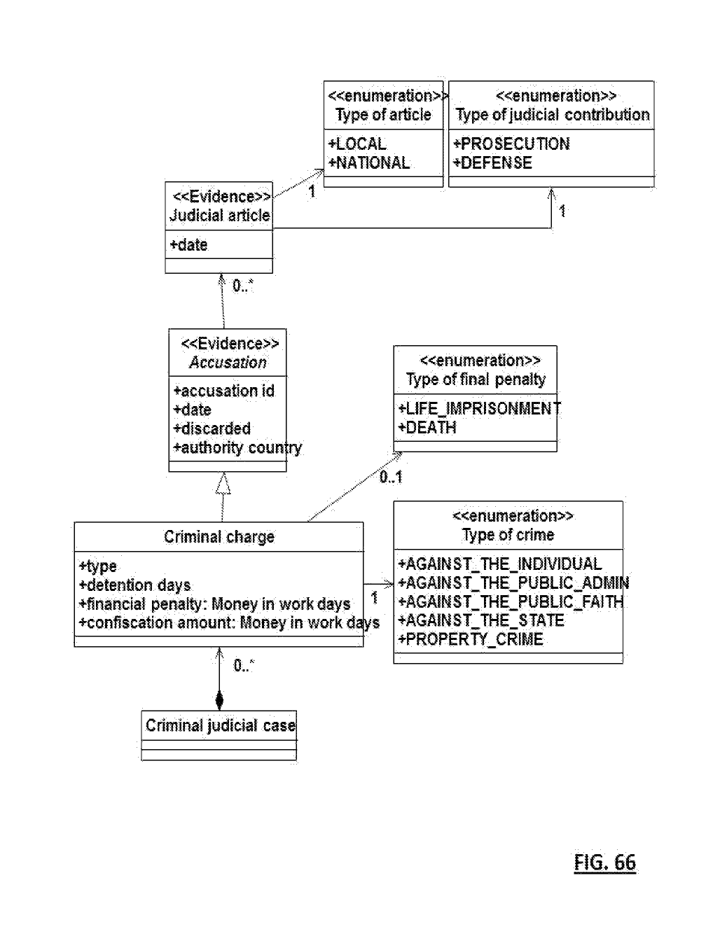

FIG. 66, 67, 68 show the composition of the criminal judicial cases of individuals and legal persons.

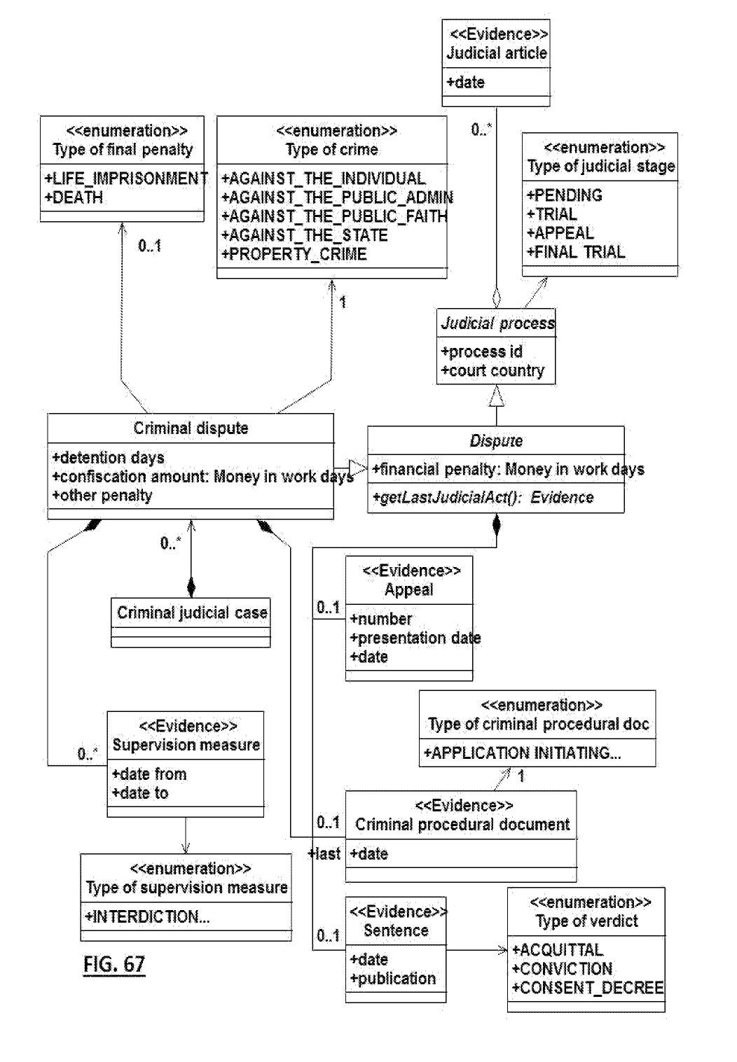

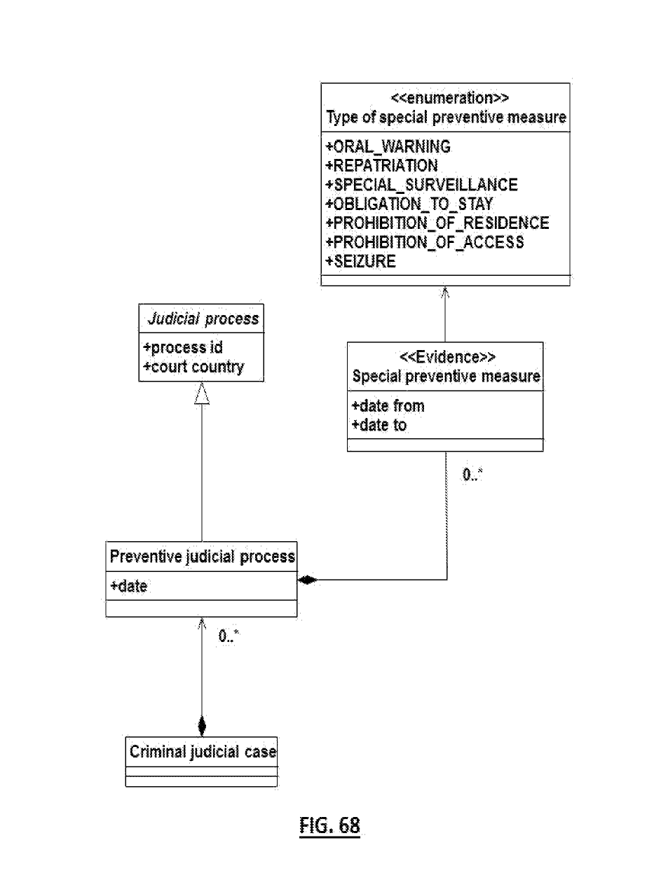

There are three main classes:
Criminal Charge, that is the accusation for a crime (FIG. 66);
Criminal dispute, that defines the context and the process during which the crime is examined (FIG. 67);
Special preventive measure, based on the presumption of a danger (FIG. 68).

If the judgment is not yet given, penalties are set to the maximum values as possible.

This rule occurs in criminal charges and in the disputes if the sentence doesn't exist.

Criminal disputes have three types of Evidences:

1—Appeal, presented by the defendant to start a new judicial stage;

2—Procedural document;

3—Sentence, that ends the judicial stage.

### 6.15. Judicial Cases—Civil Diagram

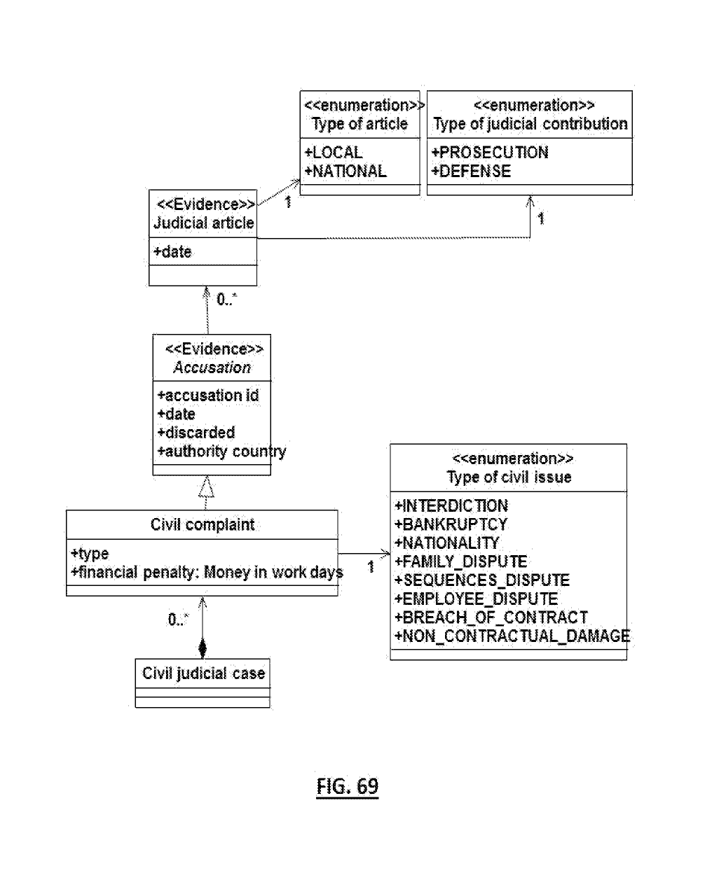

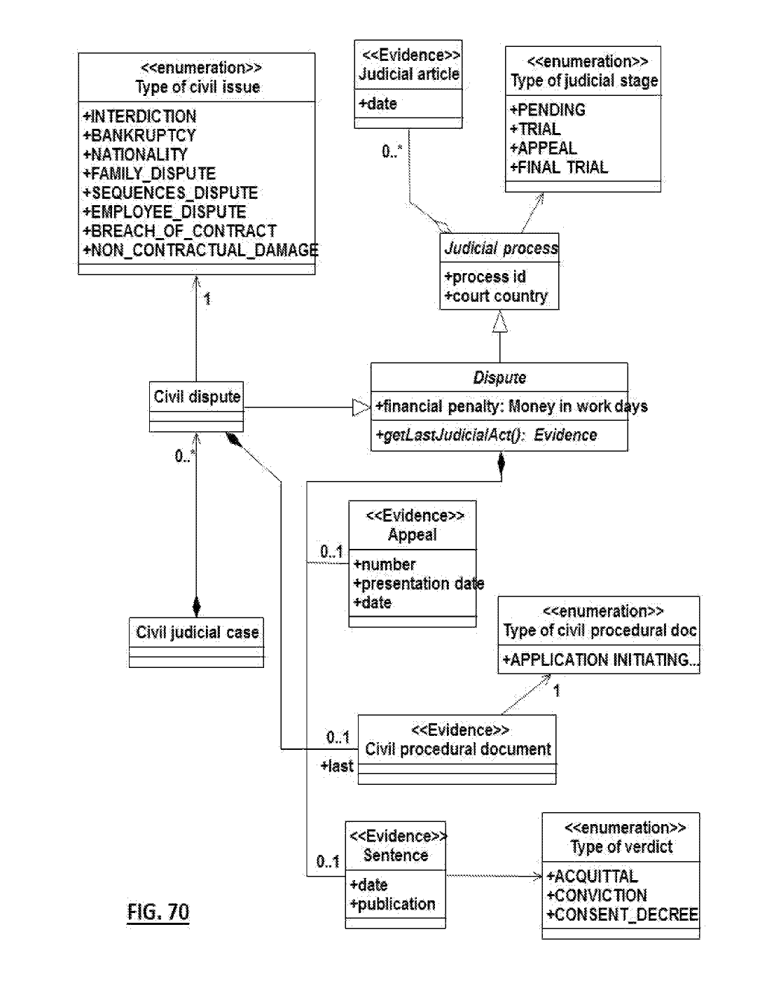

FIG. 69, 70 show the composition of the civil judicial cases of individuals and legal persons. There are two main classes:
Civil complaint, that is the accusation for a damage (FIG. 69);
Civil dispute, that defines the context and the process during which the damage is examined (FIG. 70).

If the judgment is not yet given, penalties are set to the maximum values as possible.

This rule occurs in civil complaints and in the disputes if the sentence doesn't exist.

Civil disputes have three types of Evidences:

1—Appeal, presented by the defendant to start a new judicial stage;

2—Procedural document;

3—Sentence, that ends the judicial stage.

### 6.16. Judicial Cases—Fiscal Diagram

FIG. 71 shows the composition of the fiscal judicial cases of individuals and legal persons.

The main class is Fiscal dispute, that defines the context and the process during which the infringement is examined.

If the judgment is not yet given (sentence doesn't exist), penalties are set to the maximum values as possible.

Fiscal disputes have three types of Evidences:

1—Appeal, presented by the defendant to start a new judicial stage;

2—Procedural document;

3—Sentence, that ends the judicial stage.

Further Embodiments of the Invention

According to the present invention, the method for calculating parameters relating to the determination of the reputational rating of natural or legal persons, therefore comprises:
populating a database with data derived from pieces of information relating to said natural or legal persons, said data being adapted to prove evidence or facts object of the evaluation of said parameters of reputational rating,
assigning a positive or negative weighted value to each of said data, proportional to a suitability factor of said evidence or facts to contribute to said determination;
determining said parameter of reputational rating of any of said natural or legal persons by summing up all the contributions derived from the weighted values relating to said natural or legal persons.

For the implementation of said method and the relating system, for deriving said data and assigning a positive or negative weighted value to each of said data, a key point is to create a system based exclusively on documents, eliminating in one fell swoop the main unreliable sources typical of reputational systems already existing for example on internet, i.e. getting rid of “gossips” (both in good and bad faith), making the ever so present reputational engineering techniques impossible (to build made-to-order reputation).

Another key point is exactly to derive “easy-to-comprehend” and “easy-to-interpret” measures, scores, ratings, from documents that the present system provides. An important and reliable help during the decision-making process, either in our social and professional relationships or each time we have to deal with unknown individuals, companies or associations.

Therefore, following the examples of concepts expressed by the law, that's why the present invention provides a system for the determination of the parameters of reputational rating based on an algorithm for determining negative ratings and positive ratings.

The negative rating is divided into three different sub-ratings, corresponding to three different fields: “criminal” (offenses), “civil” (private litigations) and “fiscal” (tax arrears).

Instead, the positive rating is divided into sub-ratings of “work and social engagement” on one side, and “education and training” on the other. This way, it is obtained a rating providing five sub-ratings for natural persons and four sub-ratings for legal persons (companies and private/public institutions), the latter having no reference to education and training.

An example of calculation criteria is provided in the following by the main category “natural person's criminal sub-rating”. In order to obtain a “score” in this category, the following criteria are taken under consideration:
The first criterion is the “type of deed”. This is relatively obvious: indictment and final court judgment do not have the same specific weight, even if they're related to the same crime.
The second criterion is the gravity of the crime. We measure it in maximum expected jail sentence for certain crimes and/or sums to be paid in the event of fines.
The third criterion depends on the plaintiff. We value with the maximum negative score crimes against the person, then crimes against the state, crimes against public administration, crimes against patrimony, and lastly crimes against public trust, which presents the minimum negative score.

Also security measures are taken into consideration, divided into:

1. detention (for subjects who are chargeable, semi-chargeable, non-chargeable, minors);

2. non-detention (probation, restraining order, etc.);

3. patrimonial (bail, seizure).

Also various preventive measures are considered, such as verbal notice, prohibition to stay, mandatory residence and seizure. For every deed (resulting in previous cases from various types of certificates: definitive measures, pending charges, preventive measures), also the date has been taken into account, so that “rehabilitation” of subjects who don't reiterate the crime is valued, as well as the opposite, i.e. the “recurrence” of the crime is considered, which increases the negative rating.

A description of the algorithm has been developed that allows to get from documents—which describe facts or behaviors—numbers expressing the exact criminal profile of any person.

However the number obtained by adding the entries corresponding to individual documents could vary from 0 to almost infinity.

It is therefore provided a solid and easily understandable scoring method. In negative ratings, the measure is expressed by a single letter, from “A” (saints) to “Z” (monsters). In case of positive ratings, the measure is expressed by a number from “0” (no recognitions) to “100” (Nobel Prizes, etc. . . . ).

After many tests, relating to every negative ratings and positive ratings, it has been found the following parametric function:

$$y ( x ) = M ( 1 - {e}^{- \frac{x}{D}} )$$

The parameters M and D are integers depending on the type of rating and on the type of person.

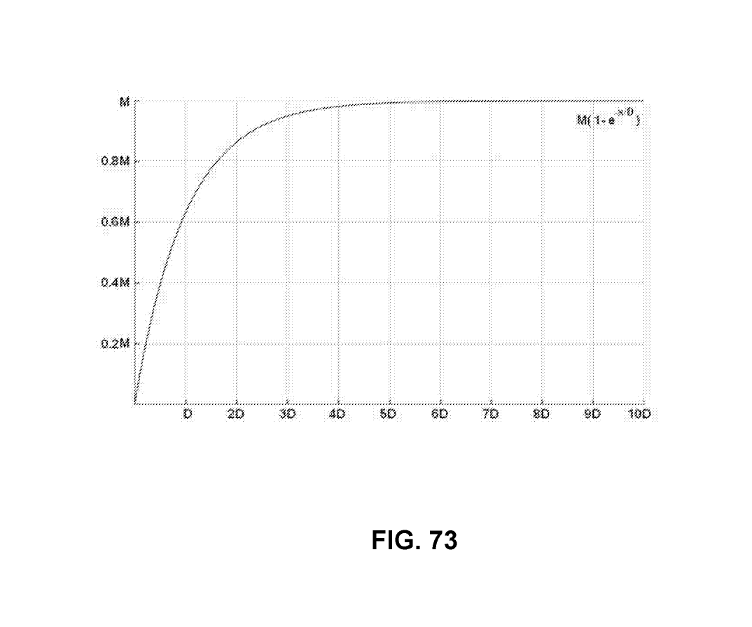

The function has the following characteristics, as shown in FIG. 73.

First of all, it is asymptotic to the “maximum score”, meaning it almost reaches “infinity” (“Z” in negative ratings and “100” in positive ratings). Thanks to the rounding to nearest whole number (there is no such a “99.67” score), “Z” or “100” are obviously reached before “infinity”.

During the decision-making process, there's not much difference if someone killed 100 or 1,000 people. He is always a “Z” person. This way we provide a rating that is immediately understandable. Instead, this conversion function has a different trend in the proximity of “0” or “A”. The curve starts more or less linearly; such a curve corresponds to normal, human judgment criteria. Let's consider education, for instance; it makes a significant difference whether a person only has primary or secondary school education. Therefore—at low levels—growth should be very swift.

In the case of “heavyweights”, instead, it is not important whether someone has won two Nobel Prizes and is featured on 1,000 World Press articles, or “just” a single Nobel Prize and “only” 500 articles. In both cases, he's a world-renowned scientist, and his rating is “100”.

Therefore starting from said sum of all the contributions derived from the weighted values relating to said natural or legal persons, the above asymptotic function is preferably used to get said parameter of reputational rating by multiplying the sum by that asymptotic function.

### Software Implementation of the System.

The above described flow charts, shown in FIGS. 1 to 71, and 73, can be implemented at the software level through a Java Enterprise application runnable on a JEE 6 Application Server.

The target application server can be a IBM Websphere 8.5.

The application design can be based on the classic pattern Model, View, Controller, where the controllers can be implemented through Spring MVC classes (Spring MVC 3.2.1), the views through jsp pages and the business classes of the model through ejb classes and pojo classes, according to the “session façade” pattern.

Persistence can be realized using JPA 2.0 entities with Hibernate 4.1.1 Final as provider.

The target database can be IBM DB2 9.1.

The component that implements the rating algorithm can be realized through pojo classes of the business layer.

### Hardware Implementation of the System.

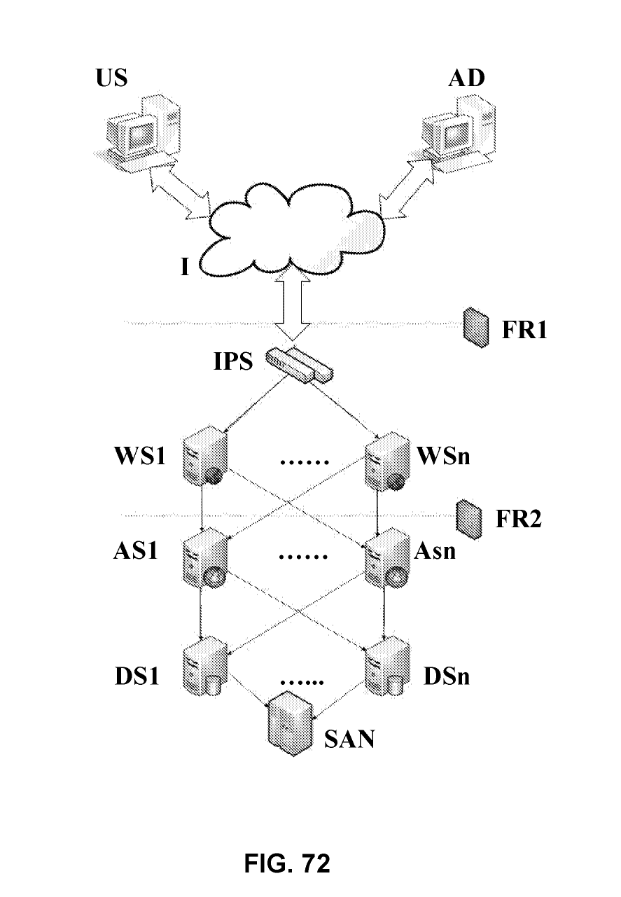

With reference to FIG. 72, an example of implementation of the Hardware level of the system of the invention is described.

A number of User electronic systems US and the Administrator electronic system AD access the system preferably through the Internet I.

Each of the users suitably registered in the system, has the right to input data relating to the documented information for contributing to build up the reputational rating of himself or other legal or natural persons.

The registration phase in the system can be accomplished in any of known procedures.

The Administrator function relates to the control of the whole procedure, and to the control of the correct behavior of the system.

The system comprises an Ip-sprayer module IPS, a Web Server layer (WS1 . . . WSn), an Application Server layer (AS1 . . . ASn), a database server layer (DS1 . . . DSn) and a storage area network SAN.

The Ip-sprayer module (Ip-sprayer active/passive) sends requests to the web layer. It gives an higher reliability to the Web Server layer. It controls and Distributes the incoming packets from the Internet network to the Web Servers, and avoids sending packets to unavailable or defective Web servers. It doesn't apply any logic to select to which web-server a request must be sent; it simply uses a round-robin strategy and it is aware of failing web-servers. It natively supports (i.e. no need of OS HA solutions) an active/passive configuration for High Availability.

The Web Servers of the web server layer receive http and https requests and route them to the app-server layer where the user session is maintained or, if the user session is not yet established, to a chosen app-server between the ready ones.

An alternative to the Web Server is to use On Demand Routers (ODR) . . . ; the ODR only can also act as an intelligent router, it can for example choose to route a new user session request to a particular performing app-server because the user asking it is classified as “gold-user”.

High Availability is granted by the ip-sprayer IPS.

The Application Servers of the Application Server layer are a full profile Java Enterprise Edition 6 standard application servers. The application of the invention runs on it. High Availability and Load Balancing is granted by the web server layer.

The DB server layer comprises a number of RDBMS servers. They can be configured as a share nothing cluster or as a shared disks cluster.

High Availability and Load Balancing is granted by internal native mechanisms or by OS HA solutions.

For the layers of Web Server, Application Server, DB Server, an example of implementation is the IBM WEBSPHERE Network Deployment, that is a standard configuration of an IBM system. The DB Server layer comprises for example IBM DB2 9.1 machines.

A Storage Area Network (S.A.N.) Provides the storage for the RDBMS servers, it's a hardware component.

Suitable Firewall equipment FR1, FR2 is inserted at certain levels of the structure, for example between the Internet and the Ip-sprayer module, and between the web server and the application server layers.

### The Essential Features of the Method Object of the Invention are the Following.

According to an aspect of the present invention it is provided a method for calculating parameters relating to the determination of the reputational rating of natural or legal persons, comprising the following steps:
populating a database with data derived from pieces of information relating to said natural or legal persons, said data being adapted to prove evidence or facts object of the evaluation of said parameters of reputational rating,
assigning a positive or negative weighted value to each of said data, proportional to a suitability factor of said evidence or facts to contribute to said determination;
determining said parameter of reputational rating of any of said natural or legal persons by summing up all the contributions derived from the weighted values relating to said natural or legal persons.

Preferably said step of assigning a positive or negative weighted value to each of said data comprises steps for:
building up a tree structure in said database comprising data relating to one or more of: type of person, namely natural, or private legal person or public legal person; categories of evidence or facts for each type of person, subcategory of evidence or facts for each category, eventually classes of evidence or facts for each subcategory;
assigning each type of said data to a given position in the tree structure;
assigning said positive or negative weighted value to each of said data on the basis of said position in the tree structure.

Preferably said step of determining said parameters of reputational rating of any of said natural or legal persons comprises calculating polynomial formulae with coefficients taken from configuration tables, said coefficients being said weighting values of the evidence or facts, and variables given by number of occurrences of the evidence or facts and time factor.

According to another aspect of the present invention it is provided a method for calculating parameters relating to the determination of the reputational rating of natural or legal persons, comprising the following steps:
populating a database with data derived from pieces of information relating to said natural or legal persons, said data being adapted to prove evidence or facts object of the evaluation of said parameters of reputational rating,
assigning a positive or negative weighted value to each of said data, proportional to a suitability factor of said evidence or facts to contribute to said determination, on the basis of respective positions of said data in a tree structure in said database;
determining said parameter of reputational rating of any of said natural or legal persons by summing up all the contributions derived from the weighted values relating to said natural or legal persons.

According to a further aspect of the present invention it is provided a method for calculating parameters relating to the determination of the reputational rating of natural or legal persons, comprising the following steps:
populating a database with data derived from pieces of information relating to said natural or legal persons, said data being adapted to prove evidence or facts object of the evaluation of said parameters of reputational rating,
assigning a positive or negative weighted value to each of said data, proportional to a suitability factor of said evidence or facts to contribute to said determination, on the basis of respective positions of said data in a tree structure in said database;
determining said parameter of reputational rating of any of said natural or legal persons by summing up all the contributions derived from the weighted values relating to said natural or legal persons, and depending on a number of occurrences of the evidence or facts in said database and on a time factor.

Preferably said step of assigning a positive or negative weighted value to each of said data comprises:
deriving metadata from said data, said metadata comprising data relating to the specific type of the instances and the values of enumerated attributes of each certain piece of information,
assigning numerical values to said metadata;
obtaining said positive or negative weighted value on the basis of said metadata.

The method of the present invention can be advantageously implemented through programs for computers comprising program coding means for the implementation of one or more steps of the method, when these programs are running on computers. Therefore, it is understood that the scope of protection is extended to such programs for computers and in addition to computer readable means having recorded messages therein, said computer readable means comprising program coding means for the implementation of one or more steps of the method, when these programs are running on computers.

Further implementation details will not be described, as the man skilled in the art is able to carry out the invention, both at the software and hardware levels, starting from the teaching of the above description. In particular the skilled in the art understands unambiguously how to implement the activity flow charts and the logic structures of the data model from the description given above and referring to the FIGS. 1 to 71. In addition the way how the blocks of the Figures are structured, interconnected and labelled is the best way how to let him to understand.

The elements and characteristics described in the various forms of preferred embodiments can be mutually combined without departing from the scope of the invention.

Many changes, modifications and variations of the subject invention will become apparent to those skilled in the art after considering the specification and the accompanying drawings which disclose preferred embodiments thereof. All such changes, modifications, variations and other uses and applications which do not depart from the scope of the invention are deemed to be covered by this invention.

1. A system configured for calculating at least a parameter relating to the determination of the reputational rating of a natural or legal person, the system comprising a number of electronic modules comprising:
means for populating a database with data derived from pieces of information relating to said natural or legal person, said data being adapted to prove evidence or facts object of the evaluation of said parameter of reputational rating;
means for assigning a positive or negative weighted value to each of said data, proportional to a suitability factor of said evidence or facts to contribute to said determination; and
means for determining said parameter of reputational rating of said natural or legal person on the basis of a sum of all the contributions derived from the weighted values relating to said natural or legal person.

2. The system as in claim 1, wherein said means for assigning a positive or negative weighted value to each of said data comprises means for:
building up a tree structure in said database comprising data relating to one or more of: type of person, namely natural, or private legal person or public legal person; categories of evidence or facts for each type of person, subcategory of evidence or facts for each category, classes of evidence or facts for each subcategory;
assigning each type of said data to a given position in the tree structure; and
assigning said positive or negative weighted value to each of said data on the basis of said position in the tree structure.

3. The system as in claim 2, wherein said means for assigning said positive or negative weighted value to each of said data comprises means for:
deriving metadata from said pieces of information, said metadata comprising data relating to the specific type of the instances and the values of enumerated attributes of each piece of information;
assigning numerical values to said metadata; and
obtaining said positive or negative weighted value on the basis of said metadata.

4. The system as in claim 3, wherein said means for determining said parameter of reputational rating of said natural or legal person comprises means for calculating polynomial formulae with coefficients taken from configuration tables, said coefficients being said weighting values of the evidence or facts, and variables given by number of occurrences of the evidence or facts and time factor.

5. The system as in claim 4, wherein said time factor is such that an evidence or fact is given a higher value if more recent and a lower value if older in the time.

6. The system as in claim 2, wherein, for said type of natural person, said types of data are assigned in said tree structure according to the following subdivision:
data on category of criminal reputation, subcategories of crimes, namely against the person, against the State, against the Public Administration, against property, against public faith;
data on category of fiscal reputation;
data on category of civil reputation, subcategories of civil reputation, namely family, working, breaches of contracts, extra-contractual damages, succession;
data on category of education reputation; and
data on category of job reputation, subcategories of job reputation, namely employment, professional work, entrepreneurial work, family Management, civil commitment.

7. The method as in claim 2, wherein, for said type of private or public legal person, said types of data are assigned in said tree structure according to the following subdivision:
data on category of criminal reputation, subcategories of crimes, namely offences against the public administration, offences against property;
data on category of fiscal reputation;
data on category of civil reputation, subcategories of civil reputation, namely working, breaches of contracts, extra-contractual damages; and
data on category of job reputation, subcategories of job reputation, namely working activity, civil commitment.

8. The system as in claim 1, wherein said parameter of reputational rating is obtained by means for multiplying said sum of all the contributions derived from the weighted values relating to said natural or legal person by the following asymptotic function:
$$y ( x ) = M ( 1 - {e}^{- \frac{x}{D}} )$$
wherein M and D are integer parameters depending on the type of rating and on the type of person.

9. The system as in claim 1, wherein said number of electronic modules comprises:
a number of User electronic systems (US) and at least one Administrator electronic system (AD) accessing the system preferably through the Internet network (I), each of said User electronic systems being adapted to input said data derived from pieces of information;
an Ip-sprayer module IPS;
a Web Server layer comprising one or more Web Servers (WS1 . . . WSn);
an Application Server layer comprising one or more Application Servers (AS1 . . . ASn);
a database server layer comprising one or more database server (DS1 . . . DSn) and
a storage area network SAN,
said Ip-sprayer module sending requests to the web server layer, controlling and distributing incoming packets from the Internet network to the Web Servers, and avoiding sending packets to unavailable or defective Web servers, using a round-robin strategy;
said Web Servers of the web server layer receiving http and https requests and routing them to the application server layer where the user session is maintained or, if the user session is not yet established, to a chosen application server between the ready ones.
